(19) United States
(12) Patent Application Publication
(10) Pub. No.: US 2005/0026145 A1
(43) Pub. Date: Feb. 3, 2005

(54) Computational method for predicting intramolecular and intermolecular biopolymer interactions

(76) Inventors: Phillip S. Pang, New York, NY (US); Anna Marie Pyle, New York, NY (US); Eckhard Jankowsky, Mountain View, CA (US)

Correspondence Address: BAKER & BOTTS, 30 ROCKEFELLER PLAZA, NEW YORK, NY, 10112, US

(21) Appl. No.: 09/911,821

(22) Filed: Jul. 24, 2001

(51) Int. Cl. G06F 19/00

(52) U.S. Cl. 435/6; 702/23

(57) ABSTRACT

Disclosed is a computational method for predicting intramolecular and intermolecular biopolymer interactions which provides an improved way of determining structure and function information, including intramolecular and intermolecular interactions using an ab initio-type approach, i.e. using only sequence information. The method is a widely applicable sequence-mining tool capable of detecting both intramolecular and intermolecular interactions for all biopolymers, including, but not limited to, DNA, RNA and protein. It possesses an adaptive screening process that allows for high accuracy. It can be an entirely rule-free, unbiased methodology, and thus can detect novel interactions for all biopolymers. Due to the incorporation of a misalignment process, it can be used iteratively and is capable of refining its own predictions and detecting and managing errors. Therefore, the disclosed method also provides a technique for more accurately determining (and refining) sequence alignments.

### SPECIFICATION

The appended source code, which is an integral part of the present disclosure, includes a listing of a computer program and its related data in one embodiment of this invention. This appended source code contains material which is subject to copyright protection. The copyright owner has no objection to the facsimile reproduction of the patent document or the present disclosure, as it appears in the Patent and Trademark Office patent files or records, but otherwise reserves all copyrights whatsoever.

### BACKGROUND OF INVENTION

Projects aimed at the sequencing of entire genomes of organisms can provide detailed information which could potentially lead to a better understanding of the mechanisms of cell function. The area of research often referred to as ‘functional genomics’ and also known as ‘structural genomics’ aims at deciphering the wealth of information contained in genome sequences and at using that information to discover the mechanisms of cell function and disease pathology.

At present, there are three known approaches for predicting intramolecular biopolymer interactions (including protein and RNA structures) which include (1) comparative modeling, (2) fold assignment or threading, and (3) ab initio protein structure prediction. See Sanchez et al., 2000, Nature Structural Biology November 2000, Suppl. 986-990. The most detailed and, thus far, the most accurate approach is comparative modeling which involves fold assignment, sequence-structure alignment, model building and model evaluation. See Sanchez et al., 2000, Nature Structural Biology Nov. 2000, Suppl. 986-990; U.S. Pat. No. 5,436,850 of Eisenberg et al.; and U.S. Pat. Nos. 5,557,535 and 5,884,230 of Srinivasan et al. The fold assignment or threading approach assigns a fold to a target sequence by aligning it with the most compatible known protein structure from a set of alternatives. See Jones, 2000, Current Opinion Structural Biol. 10:371-379; U.S. Pat. No. 6,125,331 of Toh; and U.S. Pat. No. 5,878,373 of Cohen et al. The ab initio approach attempts to predict the native structure from only the sequence of the protein. See Baker, 2000, Nature 405:39-42 and U.S. Pat. No. 5,958,784 of Benner. The ab initio approach disclosed in U.S. Pat. No. 5,958,784 is protein specific, biased, and rule-based and is discussed further below. The present invention is directed to the ab initio approach.

Both the comparative modeling approach and the fold assignment or threading approach are limited in that they require comparisons with folds of known protein structures to determine intramolecular interactions and to determine an overall three-dimensional structure of a molecule. Since it is likely that there are many undetermined folds in the sequences of genomes of various organisms, the comparative modeling approach and the fold assignment approach will fail in determining the structure and function of many biopolymers, especially those with completely novel folds. Therefore, the ab initio approach may be the only approach applicable for many newly determined sequences. However, the ab initio approach has also not heretofore been generally applicable since its results have been inaccurate and the presently available ab initio-type approaches are limited to particular types of biopolymers. The ab initio approaches generally focus on attempting to correctly assign tertiary structure for protein sequences. The target for meaningful accuracy is usually to achieve an RMSD (root mean standard deviation) of at least 6 Å, however the best RMSD achieved thus far is 8 Å. Jones, 2000, Current Opinions in Structural Biology 10:371-379. Based on the failure to achieve an RMSD of less than 6 Å, it has been argued that it is unlikely that the ab initio approach will be a practical tool with sufficient accuracy for routine genome analysis.

One ab initio approach involves using the variations in the sequence space of related biopolymers to predict interactions. The basic theory that underlies this approach is as follows: Constant mutational pressure acts at the DNA level, altering DNA, RNA and protein sequences. “Silent” mutational events account for the general variability found in sequences, and have no effect on function. Disadvantageous mutations, as the name implies, are deleterious to function. If this disadvantage is significant enough, it may have an effect on the organism at large and the organism may be selected against. However, a disadvantageous mutation may be countered by a compensating mutation. For example, if two regions of a protein must bind together for the protein to fold correctly, if one region is changed by mutation, the protein may still be able to fold if the other region is changed in such a way as to compensate for the first mutation—e.g. if the first mutation results in an increase in size, the second mutation might compensate by decreasing in size.

Given that many functions within a cell are necessary for survival, there is a great deal of evolutionary pressure to compensate for deleterious mutations. In a set of related biopolymers with similar function, for example, the protein myoglobin from different mammalian species, there exists variation between the sequences from a given species as well as between each of the different species. The majority of these variations are the result of silent mutations. However, some of these mutations may be deleterious, but are compensated for by another mutational event or events. Thus, some variation is the result of mutation-and-compensating-mutation, i.e. associated mutations.

Thus, the goal of methods that attempt to utilize these mutation-and-compensating-mutation variations can be defined as detecting non-random associated mutations from random silent mutations. Because associated mutations occur, by definition, when function needs to be conserved, when a real association is detected, ipso facto, the association is significant and important to function.

In order to best understand the previous methods and attempts in this field, it is helpful to first introduce some basic concepts and terminologies. First: a sequence alignment should be understood as a 2D matrix of related sequences, in which each column represents a different position and each row a different sequence. Second: characters (amino acids, nucleic acids, etc) that occur at each position represent the data for that position. Thus, the goal of this type of ab initio approach is to detect which positions, by using the data that appears at those positions, contain associated mutations. Third: It should be appreciated that the terms “correlation,” “covariation,” “correlated mutation,” “coevolution,” “association,” “associated mutation”, “interaction” are all descriptions of the same concept of mutation-and-compensating-mutation. Subtle differences in meaning do exist, however, and therefore the most generic terms “association” and “interaction” are preferred for use in connection with the method.

The actual detection of associated mutations can be conceptualized as occurring in three generic processes: First, a list of position combinations is generated. Such combinations denote possible interactions. Second, each possible interaction (i.e. combination of positions) is assigned a score based on a particular mathematical algorithm that analyzes the data at those positions. Third, these scores are then screened to select the actual interactions (which are the predictions of the method), from the original list of merely possible interactions.

Previous methodologies discussed further below have focused their attention primarily on devising different scoring algorithms, most of which are biased. Bias can be understood to signify any preconceptions about how biopolymers and their constituent molecules interact. For example, it is a preconception that negatively charged molecules interact with positively charged molecules. Such biases are often embodied as “rules” in the scoring process—thus, data which fits a “rule” is accorded a score different than data which does not. For this reason, such methods are biased, rule-based methods. Such biased, rule-based methods work by the assignment of numerical values to either each character (amino acid, nucleic acid, etc) or each character combination. Such methods, according to the terminology of statistics are “non-categorical” statistical methodologies.

In addition, all previous methods fail to recognize the importance of the screening process that follows a given scoring process; all utilize some form of a crude screen with inherent flaws.

Furthermore, the original sequence alignment that is used as input in all methodologies will have a critical effect on the ability of any method to make accurate predictions. Thus, the ability to evaluate the quality of such input, as well as to correct it, is of immense value. No previously described method possesses such an ability.

Finally, there are many previously described methods that are merely theoretical and that are applied to purely hypothetical, self-created data sets. These are not relevant to work that applies methodologies to actual genomic or proteomic sequences.

Keeping these considerations in mind, previously described methods in the field of interaction prediction may be divided into three groups: (1) protein-specific, biased, rule-based scoring methodologies; (2) biopolymer-general methodologies; and (3) miscellaneous methods.

The major protein-specific, biased, rule-based scoring methodologies are reviewed in Pollock et al., 1997, Protein Engineering 10:647-657, which reviews the methods found in Neher, 1994, Proc. Natl. Acad. Sci. USA 91:98-102; Gobel et al., 1994, Proteins: Struct. Funct. Genet. 18:309-317; Taylor et al., 1994, Protein Engineering. 7:341-348. It is concluded that, “None of the methods can identify truly correlated sites without including a large number of uncorrelated sites.” In addition to their non-functionality, these methods share the additional following characteristics: First, all require either physiochemical descriptors or similarity matrixes for amino acids, and thus are protein-specific, biased, rule-based approaches that preconceive the nature of molecular interactions. A possible deleterious consequence is that each position is allowed to interact with another position according to only a single type of relationship. Second, all contain crude screening processes. In Gobel et al. 1994, after possible interactions (position combinations) are scored, the actual interactions (the program's predictions) are selected by simply taking the highest L/5 scores, where L is the length of the sequence. This is similar to the method of Taylor et al. 1994, in which the N top scores are chosen, where N is an arbitrarily chosen number. It should be appreciated that such methodologies result in an arbitrary number of predictions always being made no matter what data is input, and regardless whether associations exist. In Neher, 1994, an arbitrary threshold value is used for screening: scores which fall above the value 1.7 are considered to be the result of real interactions, and all else, background noise. However, methodologies which apply such simple thresholds (also called cutoffs) fail to appreciate, among other things, the effects of phylogenetic relationships, sequence selection, or sequence number on the resulting scores, making such thresholds arbitrary, absolute, and therefore possibly ineffective. It should also be noted that such thresholds are sometimes based on the concept of “statistical significance”—however, the general failure of threshold-applying screening methods to result in accurate predictions illustrates the underlying flaw in assuming that statistical significance implies biological significance, when in fact statistical significance may result from any number of phenomena, both biological and methodological. Third and finally, none of methods evaluate the quality of the input data (i.e. none have a misalignment algorithm.)

The method of Gobel et al. 1994, has been applied to membrane proteins (Singer et al., 1995, Receptors and Channels, 3:89:95), to attempt protein-protein interaction predictions (Pazos et al., 1997, J. Mol. Biol. 271: 511-523), and as an aid in protein threading (Olmea et al., 1999, J. Mol. Biol. 293: 1221-1239). No matter the context in which this method is applied, its limitations remain as described above. Finally, despite self-contradictory claims of accuracy, it seems that the maximum accuracy is ˜13% for small proteins (Olmea et al. 1999); however, given that the accuracy due to pure chance in such a small protein can be as high as ˜27%, this method is questionably effective.

The next generation of such biased, rule-based methods attempted to account for the effect of phylogenetic relatedness on their predictions. The difficulty with all such methods is that phylogenetic relationships are merely hypotheses, calculated from sequence alignments based on sets of assumptions. Thus, it is unclear whether such information will merely serve to compound the bias problem rather than resolve accuracy issues. An example of such a method is Pollock et al., 1999, J. Mol. Biol. 287: 187-198. However, the authors conclude that despite being able to detect the presence of “coevolution” in general, this method is unable to detect actual, specific interactions. Note that the authors perform a “theoretical simulation”. In Chelvanayagam et al., 1997, Protein Engineering. 10:307-316, a method very similar in both scoring and screening to the Gobel et al. 1994 method is used. It is applied, however, to distinct sequences based on their supposed phylogenetic relatedness. The authors conclude that the methodology is able to detect only a “weak signal” and is highly inaccurate. One contributor to this method is Steven A. Benner, the named inventor of U.S. Pat. No. 5,958,784 (the “'784 patent”). The '784 patent makes note of the usefulness of covariation information in protein structure prediction. However, the '784 patent does not disclose how to detect such information. Chelvanayagam et al. 1997, does describe such a method. However, Chelvanayagam et al. conclude that while anecdotal examples exist of semi-manually detected covariation, rigorous application of such methods demonstrate that they are not widely applicable and are in fact inaccurate. Thus, the inclusion of phylogenetic information has not greatly altered the accuracy of protein-specific, biased, rule-based methods.

The second major group of previously described methodologies use biopolymer-general methodologies. Such methodologies are based on algorithms known in the field of statistics as “Categorical Data Analysis” methods. The predominant scoring method in most previously described methods uses the Mutual Information (MI) algorithm. Such a scoring method has been theorized to be useful for any type of biopolymer. One of the first attempts to use MI scoring is found in Chiu and Kolodziejczak, 1991, CABIOS, 7:347-352, who applied it to RNA; a later attempt to again apply it to RNA is found in Gutell et al., 1992, Nucleic Acids Research, 21:5785-5795; finally, an attempt to apply it to protein sequences is found in Korber et al., 1993, Proc. Natl. Acad. Sci. USA 90:7176-7180. In general, the use of MI scoring has met with more success in the RNA prediction field than the protein prediction field; although, this success has been limited to RNA secondary structure (possibly due to the relative simplicity which governs such structures).

Nominal categorical data analysis (for a review of this topic, see Agresti, 1996, An introduction to Categorical Data Analysis, Wiley, New York.) is by definition a method that treats data as discrete categories, which are not assigned values. Examples of categorical data are: the states of the United States of America, a person's gender, types of fruit, etc. These methods have been specifically designed given the understanding that, for example, an apple cannot be considered “higher” or “lower” than a pear, merely different. Thus, these methods, a priori, do not require the assignment of values to the different units of a biopolymer (e.g. assignment of values to amino acids based on some physiochemical characteristic or similarity matrix). It is for this reason that these methods can be applied to any type of biopolymer.

Categorical data approaches usually require the generation of frequency table(s), which is a simple tally of the number of simultaneous occurrences. Thus, one could generate a 2×2 frequency table where the rows denote the different fruits, apple and oranges, and the columns denote the different states, California and Florida. The number of oranges in each state, and the number of apples in each state is then tallied. Categorical data approaches would then be used to analyze if any relationship exists among apples, oranges, California, and Florida. One critical factor in the subsequent analysis of such tables is the number of rows and columns that occur in the table. For example, the assumption may be made that when comparing two positions in an alignment of RNA sequences, that a 4×4 table should always be generated (even if much of it is filled with zeros) given that there are four naturally occurring nucleic acids, A, C, T, and G; correspondingly, a table tabulating two positions in a protein alignment might be assumed to be a 20×20 table because there are 20 naturally occurring amino acids. Alternatively, a table could be generated whose rows and columns are equal to the number of different characters occurring at the positions being compared. For example, if position 1 and 3 are being compared, and only the characters A and G are found at position 1 and only the characters T and C are found at position 3, then the table would be a 2×2 table, with columns A and G, and rows T and C.

In addition, when a scoring algorithm is applied by categorical data approaches to sets of data, the resulting scores do not necessarily have consistent scales and ranges, i.e. there may or may not exist “scale uniformity”. However, scale uniformity B is preferred. Consider the following by way of example: Five judges, A, B, C, D, and E are critiquing ten Olympic skaters. It is essential for later interpretation that each judge use the same scale/range—for example, from 1 to 10, 10 being best. If however, judge “A” is using the scale 1-100, and judge “B” is using the scale 1-10, and more confusingly, judge “A” changes his scale depending on the skater, it would be very difficult based on the scores alone (i.e. not knowing the scale used each time by each judge for each skater) to determine the “best” skater. For this reason, the concept of scale uniformity is critical for later interpretation. Scores can either be intrinsically uniformly scaled (a probability score is one example: probability always ranges from 0-1), or scores may not be uniformly scaled and therefore require “standardization”—a process which takes into account the scale used for each score, and standardizes each score such that each standardized score shares the same scale (and range) with all other scores.

Categorical data approaches may further apply to the concept of “symmetry.” Symmetry is a well-known mathematical process wherein two input variables (A and B) are symmetric if the variables are interchangeable. i.e. given two data sets, it does not matter if the first or second set is considered variable A, or considered variable B. Symmetry is a desirable attribute for scoring methods because when scoring two positions, it is desirable that the score for position 1 by position 2 be equivalent to the score for position 2 by position 1—i.e. it does not matter which position is placed into rows/columns in the frequency table. This is considered desirable because it aids in the later “screening” of scores—consider: even scores which are scaled uniformly, but which are not symmetric (i.e. asymmetric), are somewhat problematic for later screening because two scores are given for each pair-wise combination, and it is difficult to determine which is the more biologically relevant. However, it should be noted that a symmetric scoring process is possibly desired, but not entirely critical.

In the method by Chiu et al. 1991, the MI algorithm, which is inherently symmetric, is used for RNA analysis. The biased assumption is made that all frequency tables are to be 4×4; (this is implicit in the MI algorithm that is subsequently used for scoring; a consequence of this is that their MI scores are scaled uniformly—however, this is not a general property of the MI scoring algorithm, but a consequence of their biased uniform tables.) Also, in this method, all conserved sequences will correlate, an undesirable consequence. Additionally, a “P-value” statistic is also calculated. Unlike the present invention, the P-value is not utilized as a score but rather as a test of statistical significance, which is apparent in their simplistic screening process: an arbitrary threshold for P of less than 0.001 is chosen—this is an absolute, arbitrary threshold screening process, based upon the questionable assumption that statistical significance denotes biological significance, as discussed previously. MI scores are then used to determine the best interacting partner for each position. While this method seems able to predict with some accuracy secondary structural elements, accuracy of tertiary structural predictions is not achieved, and overall accuracy is difficult to determine given the data presented.

Gutell et al. 1992 also use this same MI scoring on RNA. This method does not bias all frequency tables to 4×4; instead, table dimensions are determined by the characters that actually appear at the compared positions. A consequence is that the MI scores produced, as noted in the paper, are not uniformly scaled (see equation 3 of Gutell et al.), and no attempt is later made to standardize them. A P-score is only optionally calculated according to ambiguous criteria. Two other scoring methods, R1 and R2 are also introduced, but are asymmetric transformations of the MI statistic. A formal screening process is not provided. Instead, the user is instructed to choose an arbitrary, and absolute threshold for MI, or R1, R2, or select a user-specified N value, where N is the N best scores for a position. No disclosure is given on how to accurately make such choices, reflecting the fact that not only does this method lack a formal screening process, but that even if implemented, it would suffer the same considerations previously discussed with such crude screening methods. It should be noted that one of the predominant dilemmas in the RNA prediction field is that, generally speaking, a number of different scoring methods have been proposed, but formal, rigorous screening methods have not been proposed. Thus, the collective teaching is to use all scoring methods, or to use scoring methods sequentially, in a seemingly ad-hoc manner. Since the RNA secondary structure predicted is often already known, it appears that somewhat circular logic is applied in choosing among such scoring methods: i.e., the teaching is to use the scoring methods which predict the structure already known. For an overview of other scoring methods by Dr. Robin Gutell, see: www.rna.icmb.utexas.edu. Their primary approach has been embodied in a program written by James Brown for the Mac Operating System and is entitled “Covariation” (Department of Biology, Indiana University, Bloomington, Ind. 47405 USA.)

Finally, in Korber et al. 1993, the MI scoring method was applied to proteins. In this method, the dimensions of the frequency tables are determined as in Gutell et al. 1992. Thus, as in Gutell et al., 1992, the MI scores calculated are not uniformly scaled. A “P-value” statistic is also calculated. Unlike in the present invention, however, the P-value is not utilized as a score but rather as a test of statistical significance. As in Chiu et al. 1991, this is apparent in their -simple screening process: an arbitrary threshold for P of less than 0.0001 is chosen—this is an absolute, arbitrary threshold based upon the questionable assumption that statistical significance denotes biological significance, as discussed previously. The results of this method are ambiguous, so far as interaction predictions are concerned, as the primary purpose of the analysis was to determine interacting pairs for the purpose of vaccine development and no structure was available to determine accuracy.

Like the second generation of protein-specific, biased, rule-based methods, attempts have been made to incorporate phylogenetic information into these categorical data methods. In, Akmaev et al., 2000, Bioinformatics 16: 501-512, an attempt is made to incorporate phylogenetic information. Methodologically speaking, the method of Akmaev et al, 2000, has a number of striking similarities to Pollock et al., 1999 and thus shares with it many of the same limitations, biases, and considerations. Again, as is common to the RNA field, a number of scoring methods are proposed, without any rigorous instruction on their use. Finally, as seen previously, an arbitrary, absolute and simplistic screening process is applied: in this case, a P threshold of less than 0.05 is applied. None of these methods have the ability to evaluate the quality of the input data (i.e. none have a misalignment algorithm.)

The third group of previously describe methods are a diverse group of methods which further deviate from the present invention. In the method described in Altschuh et al., 1987, J. Mol. Biol. 193:693-707, a simplistic categorical approach is used, although not described as such, to analyze known protein structures. This method is often described as a method of interaction prediction; however, careful inspection suggests that it is more accurately a method to describe an already known structure (i.e. structure analysis)—as a prediction method it is circular, since interactions are chosen and then justified according to the structure, and thus are not actual predictions; it is therefore difficult to assess accuracy. The method described in Lockless and Ranganathan, 1999, Science 286:295-299, is another protein specific method which can only be used to analyze already known structures. Its widespread applicability is not known; furthermore, its methodology, requiring sequence inspection and subset selection, does not appear easily automated. Another method is described in Shindyalov et al., 1994, Protein Engineering, 7:349-358, which is a protein specific method that requires prior phylogenetic analysis of the data, and is thus biased by the methods used to create this phylogenetic information. In Shindyalov et al., the screen of a P value threshold, this time arbitrarily set to less then 0.05, is applied. The accuracy of this method is described as being 5-23%. Finally, it should be noted that in Jones, 2000, Current Opinions in Structural Biology 10:371-379, a method, termed PSIPRED is described. However, this method is applicable only for the prediction of protein secondary structure, an area of structure prediction that has been well studied, and does not provide a method for predicting any other type of biopolymer. It is noted once again that none of the methods described above, biased, categorical or otherwise, in addition to the differences and limitations noted, contain a method for evaluating the quality of the input data (i.e. a misalignment algorithm.)

In view of the foregoing problems, an object of the present invention is to provide an ab initio-type computational method that, in contrast to all previously describe methods, a) contains scores that are symmetric and uniformly scaled, and/or a process of standardization that results in scores that are uniformly scaled; b) contains a rigorous screening process that is intricately linked to its scoring algorithms and that allows high accuracy to be achieved; c) contains a screening process that is neither arbitrary nor absolute, and thus able to implicitly handle the effects of sequence selection, phylogenetic relationships, sequence number; d) does not require preconceived biochemical parameters, or any other type of empirical data such as physicochemical, energetic, similarity descriptors or matrixes and is thus unbiased and not rule-based; e) is able to predict novel types of interactions, as well as further describe existing ones; f) is biopolymer general, and thus can be applied to the sequences of, inter alia, DNA, RNA and proteins, for predicting not only intramolecular but also intermolecular biopolymer interactions and heterobiopolymer interactions, such as, but not limited to DNA-protein binding; g) is highly automated, and does not require enormous amounts of user input; h) contains a method for evaluating the quality of the input data and suggestion for how to improve it, and is thus a novel method by which to analyze sequence alignments for errors; and i) is iterative, because as the input data is refined via its misalignment algorithm, each successive pass allows for better predictions. The preferred embodiment satisfying all of the foregoing objectives is referred to hereinafter as “Shevek.”

The present invention does not focus on the proper assignment of tertiary structure as do other ab initio approaches to analyze genomic sequences. Instead, it focuses on the assignment of intramolecular and intermolecular associations between and within biopolymers, in order to analyze genomes and proteomes, and thus define functionally significant interactions and active sites.

### SUMMARY OF THE INVENTION

In accordance with the present invention there is provided a computational method for predicting intramolecular and intermolecular biopolymer interactions generally comprising the following steps:
(a) obtaining genomic/biopolymer sequence data; (b) performing an alignment process with the sequence data; (c) performing a combinatorial matching process; (d) performing a scoring process; (e) performing a screening process; (f) performing a misalignment process; (g) repeating steps b through f; and (h) obtaining association information wherein said association information predicts intramolecular and intermolecular biopolymer interactions.

The method of the present invention has improved efficacy over the previously described methods, i.e. it has been shown to provide remarkably reliable predictions (see FIG. 8 and Example 1, infra) and it is generally applicable to all biopolymers, including, inter alia, RNA, DNA and proteins (see FIGS. 8-11 and Examples 1-4, infra). In particular, the present invention demonstrates improved efficacy over the previously describe methods partly due to: 1) a scoring process that results in scores that are symmetric and uniformly scaled, and/or a process of standardization that results in scores that are uniformly scaled; 2) a rigorous screening process that is intricately linked to its scoring algorithms, such that high accuracy is achieved; 3) a screening process that is neither arbitrary nor absolute, and thus able to implicitly handle the effects of sequence selection, phylogenetic relationships, sequence number; 4) a methodology that does not require preconceived biochemical parameters, or any other type of empirical data such as physicochemical, energetic, similarity descriptors or matrixes and is thus unbiased and not rule-based; 5) a methodology that is highly automated, and does not require enormous amounts of user input; 6) a methodology for evaluating the quality of the input data and suggestion for how to improve it, and is thus a novel method by which to analyze sequence alignments for errors; and 7) a methodology that is iterative, because as the input data is refined via its misalignment algorithm, each successive pass allows for better predictions.

### BRIEF DESCRIPTION OF THE DRAWINGS

The present invention will now be described by way of the following detailed description of illustrative embodiments thereof in conjunction with the drawings in which

FIG. 1 is a flow diagram illustrating an overview of an exemplary embodiment of the computational method of the present invention, the dotted lines indicating data flow;

FIG. 2 shows a hypothetical sequence alignment;

FIG. 3(a) shows an exemplary Actual Frequency Table; and 3(b) shows the corresponding exemplary Expected Frequency Table;

FIG. 4 are graphical plots of chi-square (χ²) distributions and their dependence on DF, such distributions are utilized to uniformly scale a given χ² score;

FIG. 5 are graphical plots of score distributions and the parameters utilized to analyze such distributions;

FIG. 6(a) is an example of an Actual Frequency Table; and 6(b) is an example of the corresponding AR table, utilized to determine misaligned sequences;

FIG. 7(a) is a graphical plot of the V score distribution, 7(b) is a graphical plot of the −logP score distribution and 7(c) is a graphical plot of −logP versus V scores, for the AI5γ example;

FIG. 8(a) shows the structure for Domain V of the Group II catalytic RNA AI53 as predicted by the exemplary embodiment of the method of the present invention and 8(b) shows the interactions for Domain V of the Group II catalytic RNA AI53 according to the biochemically predicted structure;

FIG. 9(a) is a table listing the interacting positions in tRNA and the nucleic acids to which they correspond, as predicted by the exemplary embodiment of the present invention; and 9(b) depicts two three-dimensional views of the known tRNA crystal structure indicating that the exemplary embodiment of the present invention predicted the interacting nucleic acids;

FIG. 10(a) is a table listing the interacting positions in HIV protease and the amino acids to which they correspond, as predicted by the exemplary embodiment of the present invention; 10(b) depicts a three-dimensional view of the crystal structure of a monomer of the protease; and 10(c) depicts a three-dimensional view of a homodimer of the protease hemoglobin showing that the exemplary embodiment of the present invention correctly predicted interacting amino acids; and

FIG. 11(a) is a table listing the interacting positions in hemoglobin and the amino acid sequences to which they correspond, as predicted by the exemplary embodiment of the present invention; and 11(b) depicts a three-dimensional view of the crystal structure of hemoglobin showing that the exemplary embodiment of the present invention correctly predicted interacting amino acids.

### DETAILED DESCRIPTION

The following is a list of definitions and abbreviations for terms used herein:
Shevek: An exemplary embodiment of the method of the present invention described hereinbelow.
Sequence Alignment: a two dimensional matrix of data, where the columns in the matrix designate different positions and each row is comprised of a different sequence. The sequences are related to one another either by structure or function. Each position should contain characters (such as, but not limited to, the single-character designations for the different amino acids and nucleic acids) that occupy the same structural/functional role in each sequence.
Characters: any symbol, name, or other nonambiguous identifier; characters may be alphanumeric symbols, any other machine interpretable symbol, or made of any length or combination of symbols, such as a name. Examples include, but are not limited to: the letter “A,” the abbreviation, “Ala,” the word, “Alanine,” and the symbol combination “%$#$”.
Categorical Data: data that can be placed into categories. Nominal data is a type of categorical data, for which the concepts of order, rank, higher, lower, have no meaning. Examples of nominal data (data that is described by a name) are countries, fruits, sex-type, and species. The Shevek method may treat the characters that occur at a position in a sequence alignment as categorical, nominal data.
Association (Interaction): In general, denotes a relationship between or among data. More specifically, in the preferred embodiment, Shevek, this method attempts to detect associations between and among the different positions in a sequence alignment, which corresponds to associations between the characters found at those positions in the sequence alignment. An association may imply that the positions associated are located in spatial proximity, but may also imply other types of relationships, such as energetic connectivity, a relationship that occurs along a folding pathway, or a relationship based on the function of the biomolecule.
Combinatorial Matching Process: any process that generates a list of combinations of positions, and is thus a list of the possible associations to be later analyzed, for the purpose of ultimately detecting the actual associations that exist. In the current preferred embodiment of Shevek, a list of two-way, non-redundant combinations of positions may be generated; however any combinations of positions are possible, such as multi-way combinations.
Frequency Table: a table that enumerates the data found for any given combination of positions. For a pair-wise combination of positions (two), this may be described by a two-dimensional grid whose rows denote the characters at one positions and whose columns denote the characters at the other position. Preferably, the values in this table may be a simple tally of the character-character occurrences at those two positions; when this is the case, this table is called an actual frequency table; however, these values may also, if desired, be weighted according to preconceived or empirical data describing specific character-character combinations.
Expected Frequencies: the set of frequencies one would expect given the null-hypothesis that no association exists for any given combination of positions. Such frequencies may be calculated using any number of methods, including assumptions concerning phylogenetic relationships. In the present invention, these frequencies may be collated in a table, designated an expected frequency table, and determined simply according to marginal probabilities.
Scoring Process: Any method that results in a score being assigned to a particular combination of positions, sometimes by analysis of a frequency table. A non-exhaustive list of examples of scores, each resulting from a scoring process, are correlation coefficients (sometimes denoted by rᵢⱼ); maximum-likelihood ratios (sometimes denoted by ML, H,); likelihood-ratio chi-squared statistics, a specific version of a maximum-likelihood ratio (sometimes denoted by G²); mutual information (sometimes denoted by MI, I, M); uncertainty coefficients (sometimes denoted by U, R₁, R₂); Pearson's chi-squared statistics (sometimes denoted by χ²); Cramer's V statistics (sometimes denoted by V); probability or P-value or P scores (sometimes denoted by P); and degrees of freedom (sometimes denoted by DF). Preferably, the last four types of scores are used, χ², V, P, and DF; however, any suitable score and method known in the art may be used to perform the scoring process of the present invention.
Scale Uniformity: Scale uniformity exists when a set of scores have a scale and range in common. Thus, for all scores, the range and scale of the possible scores for each score, is the same. For example, scale uniformity does not exist for two scores in the following situation: a score of 1, on a scale of 1 to 10 and a score of 2 on a scale of 1 to 1000. It does exist in the following situation: a score of 1 on a scale of 1 to 10, and a score of 2 on a scale of 1 to 10. In the present invention, the scores preferably possess scale uniformity.
Standardization Process: A process that takes a set of scores that do not possess scale uniformity, and alters them such that the set of scores does possess scale uniformity. In order to accomplish such a process, it is necessary to know or determine the “scale and range” for each score. For example, χ² scores are not inherently scale uniform; the scale and range of each χ² score is its χ² distribution. Thus, each χ² distribution can be used to uniformly scale its corresponding χ² score; these uniformly scaled χ² scores are designated P scores. P scores possess scale uniformity. P scores may also be interpreted as a measure of statistical significance.
Symmetry: A score is symmetric if it is irrelevant how positions are compared—i.e. how A associates with B is the same with how B associates with A. Asymmetric scores do not have this property. In the present invention, symmetric scores are preferred.
Screening Process: A process that evaluates a set of scores. This process determines which scores are the result of an actual association (between the combination of positions a particular score represents) and which scores are not. It may consist of three parts: a standardization process, which uniformly scales any set of scores which are not uniformly scaled; a threshold determining process, which determines the value above which scores do represent actual associations; and a chain-elimination process, which eliminates scores that are the result of weak associations or combinations of associations, in favor of strong, actual associations.
Misalignment Process: A process that evaluates the quality of the input data, in this case the sequence alignments and may also provide suggestions for how to improve it; it is thus a method by which to analyze and correct sequence alignments for errors.
Sensitivity Process: The sensitivity process measures how robust a given score is, by determining how much a score is affected by alterations in the data set.
Exact Statistics (also known as Exact Treatment, Exact Inference): Exact statistics deals with frequency tables when the data in them is small, skewed or sparse. See Agresti, Statist. Sci. 7:131-153 1992. Determining whether a table requires exact statistical handling is not always possible; however, current conventions advocate the use of the set of parameters known as Cochran Conditions established by W. B. Cochran. See Cochran, 1954, Biometrics 10:417-451.

The present invention is a novel computational method for predicting intramolecular and intermolecular biopolymer interactions. An exemplary embodiment of the present invention is referred to herein as “Shevek.” The method of the present invention can predict both homo-biopolymer and hetero-biopolymer interactions, and thus is uniquely capable of mining all types of biopolymer sequence data (e.g. genomic and proteomic sequence data) for molecular interactions. Additionally, unlike other methods, the method of the present invention comprises a novel misalignment process that improves the efficacy of association prediction.

The present invention is unique in that, inter alia, it can recognize data as meaningless symbols. It may contain a screening process that adapts according to the nature of the input data, and may incorporate the concept of input data quality analysis and error detection:

Since data may be recognized as meaningless symbols (i.e., as categorical, nominal data) in the present invention, data can have no biological characteristics. The present invention does not need to recognize where a gene begins or ends; whether the data represents one or a thousand genes; or whether the data is a protein sequence, an RNA sequence, or a DNA sequence. The present invention may recognize, instead, only symbol identities. Thus, the symbol “A” can be recognized as identical to the symbol “A” and different from the symbol “B”; but neither “A” nor “B” may have any meaning in and of themselves. This is in contrast to the rule-based biased methods, as indicated above. Such methods are biased because they are programmed with “rules” usually according to physicochemical properties. For example, hydrophobic residues may be assumed to interact “better” with other hydrophobic residues; data which fits this “rule” would then be accorded a score different than data which does not. Typical biases in the previously described methods, as discussed, include the use of biochemical characteristics such as size, hydrophobicity, or other similarity matrixes.

As stated, the method of the present invention may recognize data in an unbiased manner, as nominal data. Instead of trying to “teach” all the rules (since all the rules are not known and the failure to have all the rules results in bias) the present invention can be aware of no rules and can therefore be completely unbiased. The method of the present invention can “see” only columns (positions) of “meaningless” symbolic data and can determine through statistical analysis (based on algorithms from the field of categorical statistical analysis) whether or not any positions are associated. Alternatively, the present method can incorporate “rules” used in other methods, or based upon the types of associations detected by this method.

Because the present invention need not recognize nor require biological characteristics, it can be used to analyze any number of biopolymer molecules and any combination of them, regardless of whether or not the polymer is protein, and RNA, or DNA. Thus, the present invention can detect intramolecular and intermolecular associations between and among protein, RNA and DNA.

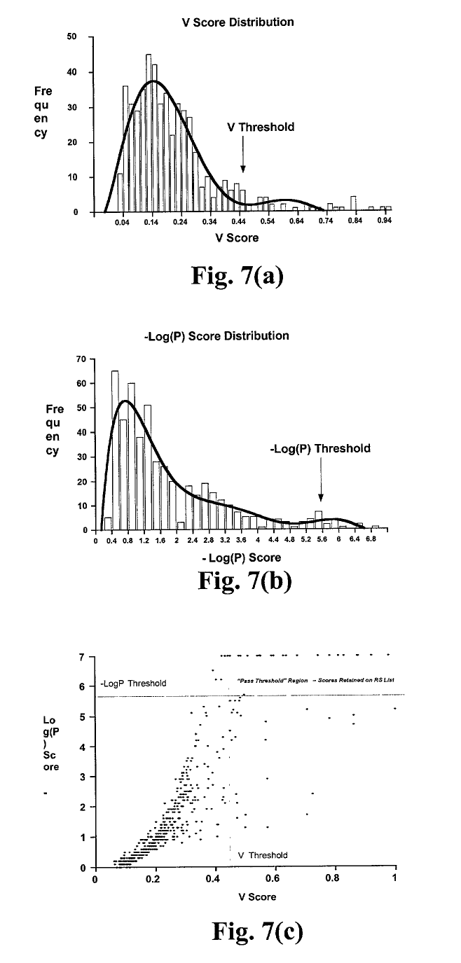

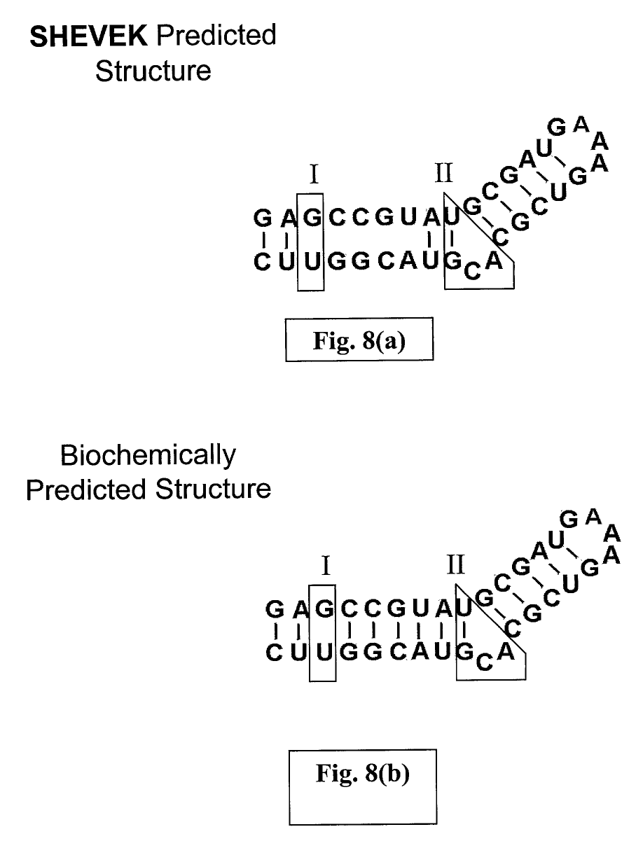

Examples 1-4 and FIGS. 7-11 show that the exemplary embodiment of the present invention can predict the structure of a variety of different biopolymers and different biopolymer types using a biochemically neutral approach—i.e. without being apprised of any of the conventional traditional base-pairing rules. Notably, the structure of domain V of the Group II catalytic RNA AI53 has not been determined by crystallographic methods but has rather been determined using difficult, biochemical techniques (e.g. solvent accessibility tests) which can take months to perform. The exemplary embodiment of the present invention calculated the biochemically determined structure within a short period of time (a matter of hours) and did so with an accuracy of approximately 100%. See FIGS. 7 and 8 and Example 1 herein.

Consider by way of example, a sequence alignment consists of 90 positions, wherein the first 30 positions are composed of sequences from proteins (each of these positions contains a column of one-letter characters representing the various amino acids) the second 30 positions are composed of RNA sequences (each of these positions contains a column of one-letter characters representing the various nucleic acids found in RNA) and the last 30 positions are composed of DNA sequences (each of these positions contains a column of one-letter characters representing the various nucleic acids found in DNA). While the user of the method may be aware of these distinctions, (as the user determines the input to the method), the present invention is not aware of these distinctions. The present invention can treat all columns as meaningless symbols, and does not need to recognize protein from RNA, or the end of one molecule from the beginning of another. The present invention can recognize the similarity or differences in identity of the symbols within a given column. Using statistical tests that rely only on such basic recognition the present invention then determines which of the 90 positions may be interacting.

In addition, the present method may incorporate an adaptive screening process, i.e. a process that does not rely on pre-defined, arbitrary or absolute thresholds. For example, but not by way of limitation: every position in an alignment has a certain amount of order—due to both trivial (i.e. sequence selection and number, alignment methods, etc) and non-trivial reasons (i.e. conservation due to function, evolutionary time and distance). When scoring a combination of positions, a comparison is made to determine how similar is the type of order at a position compared to the type of order at another, i.e., how ordered (with respect to each other) are the orders (at the compared positions) themselves (termed herein as “ordered order”). This can be interpreted as order due to the sequences appearing in an alignment, and order due to the characters appearing in a position. Thus, positions may each be highly conserved, (ordered) but not conserved in the same manner (thus, not in the same sequences, thus lacking ordered order). Sequence selection, sequence number, alignment methodology, and evolution, as well as other sources, can all be considered to have the potential to effect ordered order. Instead of attempting to deal with each of these sources of ordered order explicitly, the present method may deal with them implicitly, by choosing thresholds for a set of scores according to the distribution of such scores. Scores will cluster at some value due to the ordered order, regardless of source, experienced by all positions. Consequently, scores that do NOT congregate with all other scores, “outlier” scores, most likely possess ordered order above and beyond that of the ordered order experienced by all positions. Such additional ordered order is most likely due to association among positions. Thus, a threshold for a given score is chosen to exclude all scores that cluster together, thus keeping scores that contain ordered order due to association. It should be appreciated, therefore, that the actual threshold value chosen may vary for each data set. This methodology also serves to explain why symmetric, uniformly scaled scores are preferred. Ultimately, the clustering of scores and the subsequent selection of outlier scores has logical meaning only if all scores have been scored on the same scale. Thus, there exists the possible requirement for a standardization procedure prior to such distribution analysis when a set of scores is not uniformly scaled. Symmetry is a bonus, as only one score will exist for each combination of positions.

Chain elimination may also be important in the screening process of the present invention. A position may possess ordered order with respect to more than one position, and this ordered order may be of different strengths (i.e associate with more than one other position). Furthermore, the very presence of ordered order due to association among a combination of positions alters the landscape of order in general—making it more likely that these positions, in their interactions with all other positions, either through chance or actual association, will achieve scores that do not cluster with all other scores (e.g., if position A associates with position B, and with position C, it can be the case that the pair-wise combination B×C has score(s) suggesting association, even if B×C do not in fact associate.) For these reasons it is reasonable to suspect that propagations or chains of ordered order may exist. Since association information contains no causal information, it is not possible using such association information alone to tease apart such chains. It may be possible, however, to determine the “pinnacle” of ordered order in any given chain, given that randomness most likely may diminish the strength of such ordered order as it propagates. Thus, a step in the screening process may include the identification of chains of ordered order, as well as the selection of such a pinnacle association, that represents the best and strongest association for every given chain of ordered order.

The present invention also has the capacity to analyze the quality of the input sequence alignment and suggest corrections. Superior data mining of association information requires the ability to recognize and handle misclassified input data. Data is misclassified whenever a flaw exists in the input sequence alignment; and because sequence alignments are often flawed, there exists a tendency for data misclassification. Such inaccuracies can drastically affect the scoring and screening of data, and result in inaccurate predictions. Accordingly, the method of the present invention may contain a misalignment process, which addresses this misclassification problem. Therefore, the present invention can evaluate and suggest corrections for its input data. Furthermore, by coupling this misalignment process together with the data-mining prediction process, in an iterative manner, the present invention can refine its own predictions.

Additionally, superior data mining may also requires output error analysis. It is advantageous, for a method to be able to quantitatively “judge” its own accuracy, before requiring tedious experimentation, thereby tremendously reducing the amount of experimentation necessary. The method of the present invention may do so by quantifying the sensitivity of its output predictions to changes in the input data set. It may do so by altering the input data set repeatedly (e.g. by the addition or removal of sequences) and measuring how often the same predictions occur: this is known as robustness.

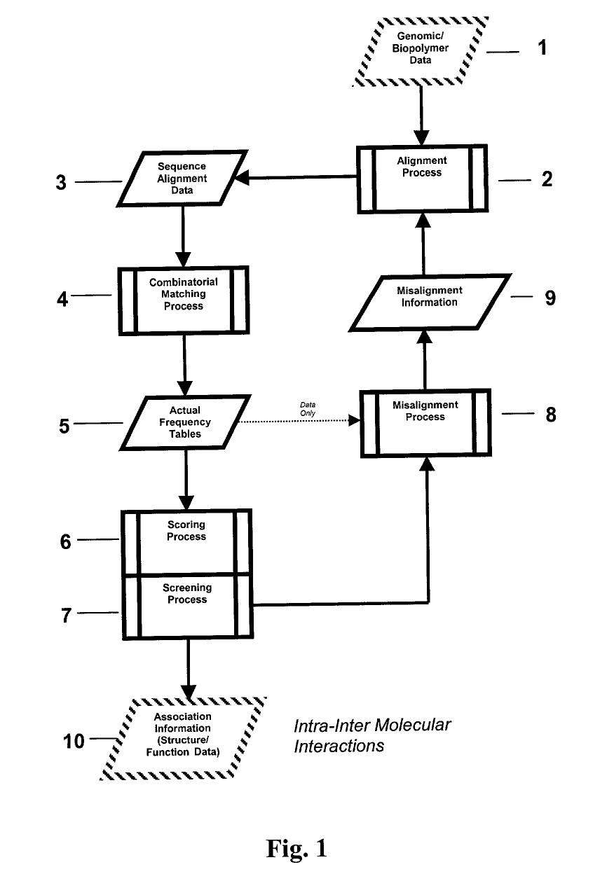

Generally, the computational method of the present invention for predicting intramolecular and intermolecular biopolymer interactions (Shevek) comprises the following steps as shown in FIG. 1:
a) obtaining genomic/biopolymer sequence data 1; (b) performing an alignment process with the sequence data 2 wherein said alignment process produces sequence alignment data 3; (c) subjecting said sequence alignment data from step 3 to a combinatorial matching process 4 wherein said combinatorial matching process generates a first list of possible association; (d) preparing an actual frequency table for each possible associations 5; (e) performing a scoring process 6 on the actual frequency tables from step 5; (f) performing a screening process 7; (g) performing a misalignment process 8 wherein said misalignment process generates a second set of sequence alignment data 9; (h) subjecting the second set of sequence alignment data to steps 2 through 7; and (i) obtaining an set of associations wherein said set of associations predicts intramolecular and intermolecular biopolymer interactions. Steps 8 and 9, the repetition of steps 2 through 7, may be eliminated. Alternatively, steps 8 and 9, the repetition of steps 2 through 7, may be repeated several times to further improve the accuracy of the final output data.

The biopolymer sequence data 1 may be obtained from any reliable source. For example, biopolymer sequence data may be obtained from the National Center for Biotechnology Information (NCBI) (see http://www.ncbi.nlm.nih.gov/COG). In addition, biopolymer sequence data may be obtained from individual sequencing efforts. Any reliable source of biopolymer sequence data known in the art is useful for the present invention.

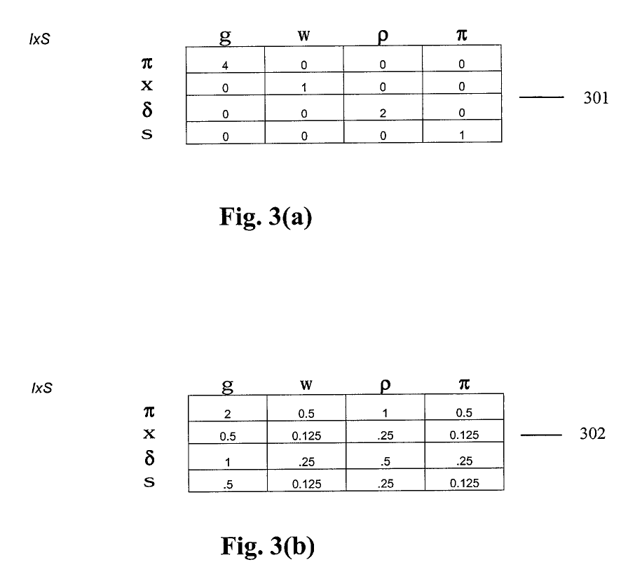

The alignment process of the present invention 2, for a hypothetical alignment see FIG. 3 herein, and for an example alignment see Table I herein, is well known to those skilled in the art and may be performed using one of many alignment algorithms known in the art. For a review of sequence alignment methodology, see Phillips et al., 2000, Mol Phylogenet Evol. 16: 317-330 which is incorporated herein by reference.

The combinatorial matching process of the present invention 4 (see Table herein for example) generates a comprehensive list of possible associations and then uses this list to generates a frequency table for each possible association according to well known methods for tabulating. For an introduction see Agresti, 1996, An introduction to Categorical Data Analysis, Wiley, New York.

The scoring process may comprise the following steps: (i) subjecting all actual frequency tables to an expected frequency generator; (ii) generating an expected frequency table for each actual frequency table; and (iii) using each expected frequency table and its corresponding expected frequency table to assign a score to each of the possible associations these tables represent. Additionally, the scoring process may further comprise the generation of other scores, such as, but not limited to, the V score, which may require first generating the score obtained in part (iii) above.

The screening process may comprise (i) classifying the scores from the actual frequency table as Normal or Sparse (further defined below); (ii) subjecting the scores obtained from the scoring process to a standardization procedure (which may include subjecting the scores from actual frequency tables classified as Normal to a standardization procedure specific to such tables and subjecting scores from actual frequency tables classified as Sparse to a standardization procedure specific to such tables or by subjecting the Normal and Sparse frequency tables to the same standardization procedure) to produce a set of standardized (i.e. uniformly scaled) scores; (iii) subjecting the set of standardized score(s) to a threshold determination process to obtain a score threshold for each set of score(s); (iv) filtering each set of scores using the thresholds, to obtain a set of filtered scores; (v) determining any chains of associations that may exist within the set of filtered scores; and (vi) determining the pinnacle association within each chain. These pinnacle associations are the initial predictions of the method of the present invention. For the process described in part (viii) a greater number of different, appropriate score types being screened may result in a greater possible discriminatory power of the present invention.

The collective predictions of association positions may then be used, inter alia, to: a) predict important energetic interactions; b) predict important structural interactions; c) analyze known structures for important motifs; d) analyze crystal structures for possible artifacts of crystallization; e) predict intermolecular interactions between and among RNA, DNA or proteins, depending upon the data input (therefore, this information may be useful for both the prediction of novel associations as well as the molecular docking of known associations); f) enhance protein stability to improve efficacy for macromolecules that are used in therapeutic or chemical processes; g) help determine phylogenetic relationships in evolutionary models; and h) better describe known molecular interaction types, identify new ones, and generate a database of such interactions. All such uses are of great importance for understanding metabolic, cellular, and pathological mechanisms.

In addition, a sensitivity analysis process may additionally be performed, which may consist of altering the input data set repeatedly (e.g. by the addition or removal of sequences), repeating steps 3-7 (FIG. 1), and counting how often the same predictions occur: this is known as robustness. See Efron, 1981, Biometrika, 68:589-599 incorporated herein by reference. Predictions that occur often are robust are most likely prevalent and not due to error.

Furthermore, a misalignment process may also be performed. This process may comprise the following steps: (i) identifying the actual frequency tables corresponding to the predicted associations (the results from the previous screening process); (ii) subjecting the actual frequency tables to a misalignment identifying process [8; FIG. 1] to determine misaligned sequence and misaligned sequence regions [9; FIG. 1]; and (iii) subjecting the misaligned sequence regions to the alignment process [2; FIG. 1] to obtain sequence alignment data. The misalignment process may identify misaligned sequences and regions within those sequences that exist in a given alignment. The number of sequences identified as misaligned (in relation to the total number of sequences) may be an indication of the quality of the initial alignment; the actual sequence regions within these sequences may identify areas in need of correction. In accordance with all other processes of the present invention, the misalignment process identifies misaligned sequences independent of the type of biopolymer sequences in the alignment.

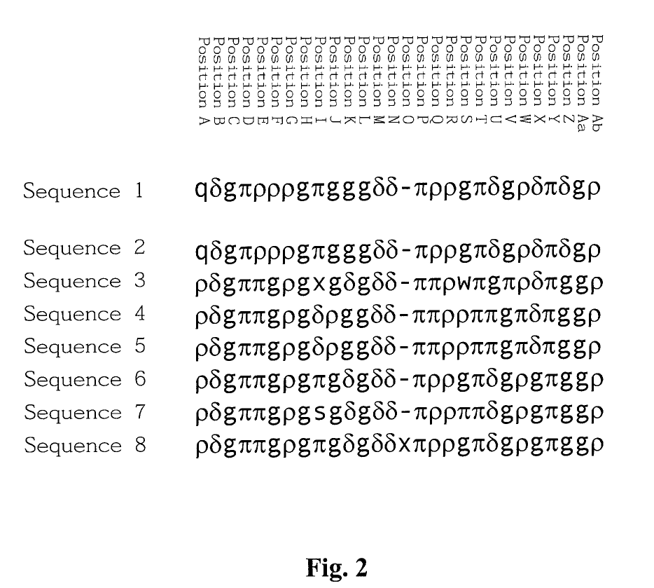

In a preferred embodiment, given a biopolymer sequence(s), sequence alignment data (1 in FIG. 1), e.g., a set of related sequences, are identified and obtained using a search program such as BLAST™ (Altschul et al., Nucleic Acids Res. 25:3389-4302 (1997), incorporated herein by reference). The number of related sequences that should be identified—and subsequently aligned—may be difficult to determine a priori, because the strategy underlying Shevek is one that seeks to determine signals from noise, a relative measure, rather than seeking some standard signal value. However, as a general rule, if subsequent calculation of the parameter −logP threshold is less than PMIN or if subsequent calculation of the parameter V threshold is less than VMIN, then the data set is insufficiently small and/or insufficiently diverse. PMIN and VMIN are empirical parameters whose default values are PMIN=2 (range: .5-5); VMIN=0.4 (range: .1-.7). It is generally useful to identify as many sequences as possible, with an upper limit being simply the computational power/time available to analyze those sequences. Preferably the largest, most diverse set of homologous sequences to the sequence of interest is used. However, the more diverse the sequences, the more difficult it may be to align them. Alignment methods and the theory underlying them are reviewed in detail by Phillips et al., 2000, Mol Phylogenet Evol 16: 317-330, incorporated herein by reference. The following may be considered general guidelines: a) sequences greater than 25 characters in length are preferred; b) sequences with >30% pair-wise sequence identity are most “i. likely to have similar structures and functions and are thus preferred; c) alignments composed of >10% gaps are preferably avoided. See Rost, 1999, Protein Engineering, 12:85-94 and Rost et al, 1996, Curr. Opin. Biotechnol. 7:457-461 for more details on sequence alignment.) These sequences are then aligned using an alignment program such as CLUSTAL X™ (Thompson et al., European Molecular Biology Organization, vs. 1.63 (1997), incorporated herein by reference), resulting in a sequence alignment. In this alignment, a different sequence is placed in each row; each column represents a different position. A hypothetical sequence alignment (step 3 in FIG. 1) is shown in FIG. 2. In the hypothetical sequence alignment of FIG. 2, the numbers designate different sequences and capital letters designate the different positions in a sequence. As shown in FIG. 2, Sequence 1 represents the sequence of interest; Sequences 2-8 represent related sequences that have been aligned with one another. Again referring to FIG. 2, nonsense random characters have been used in the sequences to emphasize the universality of the present invention, denoting its ability to be used for any biopolymer, including, but not limited to, protein, RNA, and DNA sequences, and any combinations thereof.

The alignment is read into memory by Shevek. Then, the combinatorial matching process (step 4 in FIG. 1) is performed as follows: A list of possible interactions may then be generated, by pairing all positions with all other positions (non-redundantly), resulting in an exhaustive list of all possible 2-way combinations of positions. Thus, by way of example only, in an alignment that has only the 4 positions, A, B, C, and D, an exhaustive list would be the combinations A×B, A×C, A×D, B×C, B×D, and C×D. Note that for even the small alignment in FIG. 2, there are 378 possible combinations.

Frequency tables (step 5 in FIG. 1) are then created as follows: An actual-frequency table created for each and every pair-wise combination on this list, according to the following methodology: First, a given table's dimensions are determined solely by the diversity of characters that appear at the two positions found in the pair-wise combination. Each different character in the first position is given its own row; each different character in the second position is given its own column. In this manner, no characters are ever assumed to exist at a position. To be included on the actual-frequency table, such characters must actually appear in that position. In this regard, the present invention is different from other methods (e.g., Chiu and Kolodziejczak, 1991, CABIOS, 7:347-352) that pre-determine what characters should appear as a row or column. Such predetermination biases the shape of the table. Second, the numbers (also known as counts) that fill the cells in a frequency table are then determined by a simple tally of the occurrence of each character-combination for those two positions. For the above sequence alignment in FIG. 2, the actual frequency table for position I×S is shown in FIG. 3a.

By inspection, for example, but not by way of limitation, this pair-wise combination has the following possible character combinations: π-g, π-w, π-ρ, π-π, x-g, x-w, x-ρ, x-π, δ-g, δ-w, δ-ρ, δ-π, s-g, s-w, s-ρ, s-π. The present invention differs from other methods in this regard because it can handle and may use unweighted data (in contrast to methods that require physicochemical descriptors or matrixes of similarity, as reviewed in Pollock, 1997, Protein Engineering 10:647-657, where the resultant table is not explicitly rendered, but instead only the sum of the weighted numbers is calculated.) In one embodiment, this represents a point at which the present invention may depart from previous known methods that are based on using biases and/or rules.

Frequency tables may then be evaluated in the following manner: any row or column in the AF table for the character denoting a gap (conventionally the symbol ‘−’), is eliminated, which may be followed by eliminating any rows or columns that have a sum of zero. Then, any table containing either a row or column dimension of 1 or less may be eliminated and not scored or analyzed further. Finally, if the number of counts in the actual frequency table is less than GCUT percent of the total number of sequences, the actual frequency table may be eliminated and not scored or analyzed further. This may occur it a position has many gap characters. GCUT is an empirical parameter whose default value is 50 and whose range may be (0-99). These alterations may be necessary for logical computational or logical scoring.

The scoring process is then performed as follows: each of the actual frequency tables is used to create an expected frequency table by applying equation I:

$${u}_{ij} \approx {\hat{u}}_{ij} = \frac{{n}_{i +} {n}_{+ j}}{n} , \qquad ( I )$$

where ûᵢⱼ, (which is an approximation of uᵢⱼ) is an expected frequency of cells in row i and column j of the expected frequency table; n=sum of all counts; n_{iπ+}=total of cells in row i, n₊ⱼ=total of cells in column j. (See Agresti, 1996, An introduction to Categorical Data Analysis, Wiley, New York., p 16-34, incorporated herein by reference)

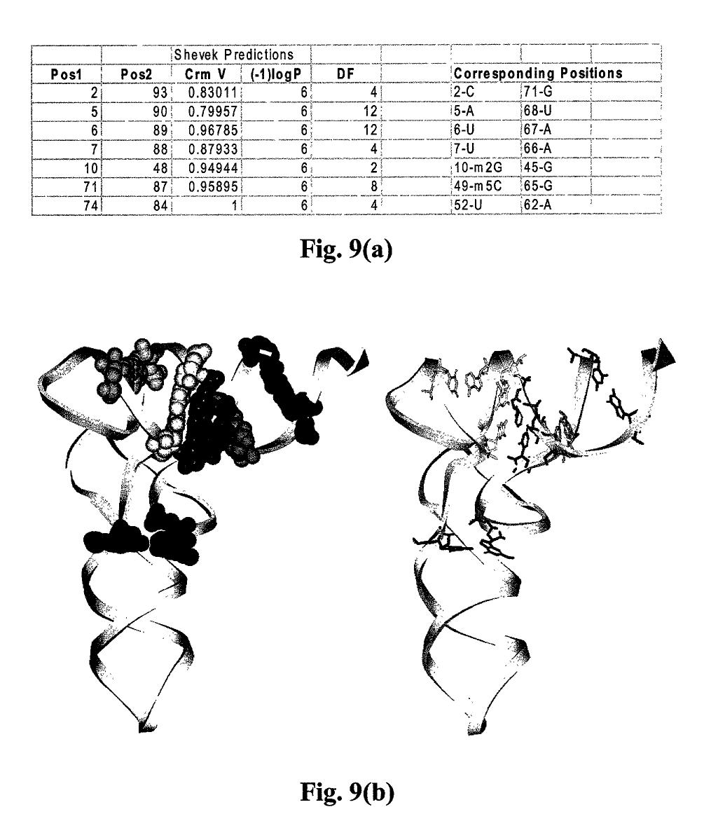

The cells in the expected-frequency table of the preferred embodiment of Shevek contain the values expected purely by random chance (i.e. without constraints), given the characters found in the corresponding actual frequency table. For our example, the expected frequency table for position I×S is shown in FIG. 9b and Example 1 herein.

Every actual frequency table is then compared to its corresponding expected frequency table by applying equation II:

$${χ}^{2} = {\sum }_{i , j} \frac{{( {n}_{ij} - {u}_{ij} )}^{2}}{{u}_{ij}} , \qquad ( II )$$

given a table composed of I×J cells, nᵢⱼ is the value of the cell in row i, column j; and uᵢⱼ is the expected frequency of the cell in row i, column j. The expected frequency uᵢⱼ is estimated according to eq. (I) above. (Agresti, 1996, An Introduction to Categorical Data Analysis, Wiley, New York., pg. 16-34,incorporated herein by reference).

A χ² score for each frequency table is the result of equation II. By mathematical formulation, χ² scores are symmetric but not uniformly scaled. The χ² score is a measure of the amount of deviation between an actual and expected frequency table. This score will therefore later be used to determine whether or not this interaction actually exists. For the example actual-frequency table 301 in FIG. 3a, the possible interaction between positions I×S has a χ² score of 24. As noted earlier, a multitude of scoring methods are available (χ², G², MI, ML, etc, see definitions of “Scoring Process,” and the Background of the Invention) which have been attempted previously and may be also applied in accordance with the present invention.

According to the preferred embodiment of the present invention, a Cramer's V score may also be calculated for every possible pair-wise combination, according to equation III:

$$V = \sqrt{\frac{{χ}^{2} / n}{min ( I - 1 , J - 1 )}} , \qquad ( III )$$

given an actual frequency table, composed of I×J cells: χ² is the statistic defined by equation II; n is as previously defined in equation I; I is the number of rows; J is the number of columns; and min (X, Y) is a function which returns the lower of the two values being compared, X and Y. (Cramer, 1946, Mathematical Methods of Statistics, Princeton University Press, Princeton p416-452, incorporated herein by reference).

By mathematical formulation, these V scores are symmetric and uniformly scaled (between 0 and 1), and thus unlike the χ² score, may not require subsequent standardization. These V scores will later be used, along with the P scores, to compare all possible pair-wise interactions. No other known methods make use of this scoring statistic.

The following describes the screening process of the preferred embodiment of the present invention. This process begins with a standardization procedure, which standardizes all scores which are not uniformly scaled. First, each and every actual frequency table is used as input to calculate its degrees of freedom (DF), according to equation IV:
DF=(I−1)(J−1), (IV)
where I and J represent the dimensions of the table. (Agresti, 1996, An introduction to Categorical Data Analysis, Wiley, New York p16-34, incorporated herein by reference).

DF is a measure of the variability in a table. This parameter will be used subsequently to make further calculations; it is also another score for this actual frequency table (and thus, technically another score for the pair-wise combination of positions that the AF table represents).

To summarize, at this point, for every possible pair-wise combination of positions, an actual frequency (AF) table, an expected frequency (EF) table, χ² score, a V score, and DF, have been generated. These data are linked to each other (as will all subsequently generated information); thus, it should be understood that categorizing one piece of data results in the categorization of all other linked data. For example, but not by way of limitation, when the characteristics of EF tables are used to categorize these EF tables, this will result in a categorization of all the other linked data—i.e. if EF table A×B is placed in category 1, then the pairwise combination A×B, the AF table for A×B, the χ² score for A×B, and the DF for A×B, are all placed in category 1.

All possible pair-wise combinations are then classified into two categories, Normal and Sparse, according to the characteristics of their corresponding EF tables. Each and every EF table is analyzed to determined if:
(a) more than PCT percent of cells in the EF table have values greater than EXT; and
(b) no cell in the EF table has a value less than MIN.

The parameters PCT, EXT, and MIN, (known collectively as the Cochran Conditions) are empirically determined numbers, which are alterable by experimentation. See Cochran, 1954, Biometrics 1:417-451. In the preferred embodiment, their default values are: EXT=5.0 (Range: 0-20); PCT=80 (Range: 50-100); MIN=1.0 (Range: 0-5). If both of the and (b) above are met, then the pair-wise combination to which that EF table corresponds is classified as category Normal. If either (a) or (b) is false, then the pair-wise combination to which that EF table corresponds is classified as category Sparse.

Next, to continue on with the standardization portion of the screening process, for every possible pair-wise combination of positions, a χ²-distribution is calculated. These distributions may be calculated differently depending on the category to which the pair-wise combination belongs. These χ² frequency distributions describe the “scale” of each χ² score, and are necessary for uniform scaling.

For each and every pair-wise combination in category Normal: The χ²-distribution is modeled using equation V:

$${P}_{DF} = f ( Q ) = \frac{{Q}^{\frac{DF}{2} - 1} {ⅇ}^{\frac{- Q}{2}}}{{2}^{\frac{DF}{2}} Γ ( \frac{DF}{2} )} , \qquad ( V )$$

where P represents the probability density, given DF, as a function of Q; where Q=χ² is evident from the equation, the only information specific to the pair-wise combination is DF. (Cramer, 1946, Mathematical Methods of Statistics, Princeton University Press, Princeton, p416-452, incorporated herein by reference).

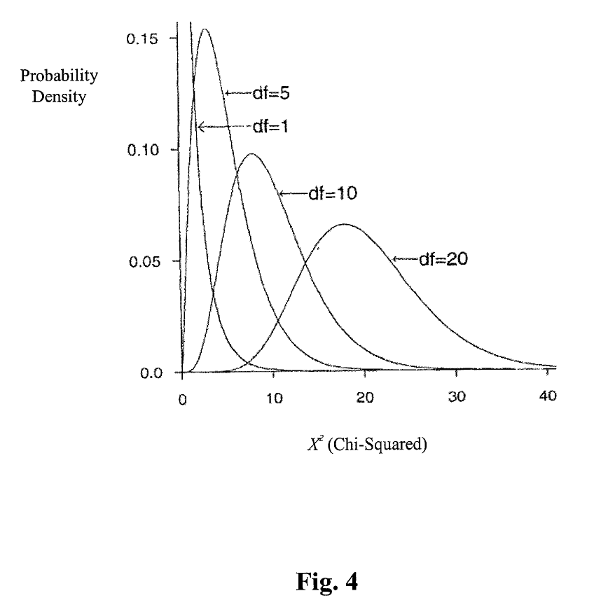

Solving P for a range of different Q. results in a probability based χ²-distribution. Examples of such modeled distributions, and how they vary with DF, are shown in FIG. 4. Referring to FIG. 4, the χ² distribution is modeled according to equation V. See Agresti, 1996, An Introduction to Categorical Data Analysis, Wiley, New York, page 29.

For each and every pair-wise combination in category Sparse: The χ² distribution is modeled according to methods as reviewed in Agresti, Statistical Science 7:131-153 (1992), and further described in Patefield, Applied Statistics 30:91-97 (1981) and Mehta and Patel, J. Am. Stat. Assoc. 78:427-434 (1993), all incorporated herein by reference. Generally, the row and column totals of each actual frequency (AF) table are used to generate a numerous set of tables. (Thus, every AF table has its own numerous set of tables; these tables are generated such that the counts found in them are randomly assigned, but that the row and column totals found in them are identical to the row and column totals found in the AF table under consideration.) A χ² value for each of these random tables is then calculated, in the same manner as described before (equation II). The end result is a set of χ² numbers—this set is a frequency based χ²-distribution. It should be noted that for implementation purposes, two factors are worthy of note: first, the pseudo-random number generator used to generate the random numbers for these tables must be sufficiently effective such that its cycle does not repeat; second, this step represents a computational bottleneck for the preferred embodiment. Methods for such implementation with consideration of these factors are readily and commonly known to those skilled in the art of computer programming.

The transformation from χ² scores to P scores is carried out for pair-wise combinations in category Normal according to the method described in Cramer, 1946, Mathematical Methods of Statistics, Princeton University Press, Princeton p416-452, incorporated herein by reference. One form of the computational code for this method is described in Press et al., 1988-1997, Numerical Recipes in C. The art of Scientific Computing Cambridge University Press, (www.nr.com) Section 14.4 p14.4 p628-636; sections 6.0-6.2 p212-222, incorporated herein by reference. Generally, the area under the χ²-distribution, to the right of the line denoted by the observed χ² score, is equal to the P score for that pair-wise combination.

This transformation is carried out as follows for pair-wise combinations in category Sparse according to the methods described in Agresti, Statistical Science 7:131-153 (1992) and Patefield, Applied Statistics 30:91-97 (1981), incorporated herein by reference. P scores may be calculated, for example, but not by way of limitation, using Exact Statistical methods, Estimated-exact Statistical methods, such as monte carlo simulation of a distribution. Generally, the number of times χ² values equal to or higher than the observed χ² score occur in the corresponding χ²-distribution are tallied. That tally is then divided by the total number of χ² values found in the χ²-distribution—which corresponds to the number of random tables originally generated. The result of this division is the P score for that pair-wise combination. (The total number of tables originally generated determines the precision of the P score, as described in Agresti, 1992. The user may alter this precision parameter; however, as will be obvious to a user skilled in the art, if the precision chosen is not greater than the later calculated −logP threshold value, then no predictions will be made and the user must rerun the program at a greater precision. A default precision of 8 decimal places is preferred). This concludes the standardization part of the screening process.

To review, χ² frequency distributions have been utilized to uniformly scale χ² scores; these uniformly scaled scores are called P scores. By mathematical formulation, (i.e. obvious and apparent to those skilled in the art) P scores are uniformly scaled and symmetric. These P scores, along with the previously calculated V scores, will later be used to compare all the possible pair-wise combinations. As indicated above, the present invention differs greatly from other known methods because of its use of uniformly scaled, symmetric scores. The present invention accordingly transforms all χ² scores into P scores that will allow these numbers to be subsequently compared to one another. Other known methods do not describe the use of uniformly scaled, symmetric scores (e.g. the Mutual Information, often denoted as MI, M, or I, statistic is not inherently uniformly scaled, and shares many properties with the χ² statistic); they also do not provide any additional analysis of the data after this point (limiting themselves to simple screens, as discussed above) e.g., Gutell et al, 1992, Nucleic Acids Research, 21:5785-5795. The use of symmetric, uniformly scaled scores and their subsequent analysis, is thus unique to the present invention, allowing adaptation to the deleterious effects of such error sources as sequence selection and evolutionary relationships. In addition, the present invention does not require or impose arbitrary, absolute thresholds.

To summarize, in the preferred embodiment of the present invention, for every possible pair-wise combination of positions, an actual frequency (AF) table, an estimated frequency (EF) table, χ² score, a DF, a χ²-distribution, P score, and a V score have thus far been generated.

The threshold determining part of the screening process may then be performed, which simultaneously compares the P and V scores that have been calculated. No other known methods include such an analysis. In the preferred embodiment of the present invention, this analysis may be accomplished as follows (and is described in detail in any introductory statistics book such as Koopmans, 1987, Introduction to Contemporary Statistical Methods, Duxbury Press, Boston Chapter 2, p35-69, incorporated herein by reference.): first, the −log of all P values is taken, denoted −logP. Second, the median of the −logP scores and the median of the V scores are determined, where the median value is a number such that 50% of the scores are less than or equal to this number and 50% of the scores are equal to or greater than this number. Quartile (i.e. 4 sections) values are then determined for both −logP and V scores; the 1st quartile value (1QV) is the number such that 25% of the scores are less than or equal to this number, and 75% of the scores are equal to or greater than this number; the 3rd quartile value (3QV) is the number such that 75% of the scores are less than or equal to this number, and 25% of the scores are equal to or greater than this number. The difference of the 3rd and 1st quartile values is known as the interquartile range (IQR), and is a measure of dispersion: 50% of all scores fall within the IQR, by definition. Thus, the distance a given score falls outside the cluster of scores (to higher values) can be measured by the number of IQR ranges the score is away from the 3rd quartile value. A multiple of the IQR is chosen for both the −logP and V scores, denoted P-MULT and V-MULT. The default values for P-MULT is 2.0 (Range: 0-5); the default value for V-MULT is 1.0 (Range: 0-5). The thresholds for −logP and V scores are then chosen as:
−logP−Threshold=3QV(p)+IQR(p)*P-MULT, and (VI)
V-Threshold=3QV(v)+IQR(v)*V-MULT (VII)
where 3QV(p) denotes the 3rd quartile value for the −logP set of scores; IQR(p) denotes the IQR for the −logP set of scores; 3QV(v) denotes the 3rd quartile value for the V scores; IQR(v) denotes the IQR for the V scores. Scores which are equal to or greater than these thresholds (and all linked data) denote a subset that is entitled RS, for Real/Strong associations.

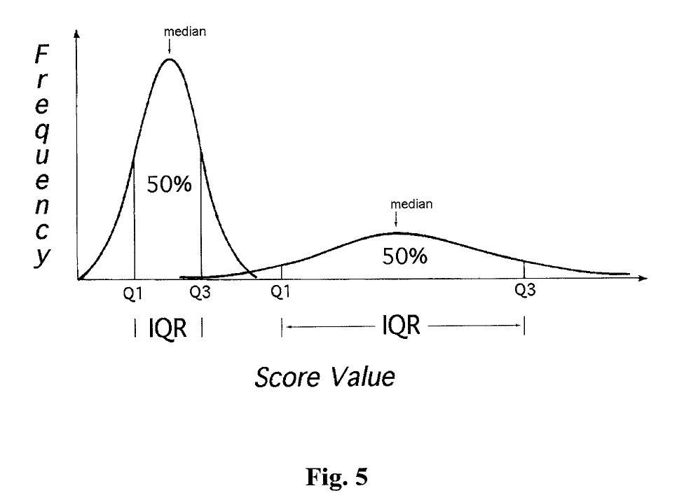

FIG. 5 shows two example score distributions. Referring to FIG. 5, two sets of scores are illustrated with the location of the median, quartile 1 (Q1, referred to herein as 1QV), quartile 3 (Q3, referred to herein as 3QV) indicated. The 1 QR, the distance between Q3 and Q1 is also indicated, and as illustrated, it encompasses 50% of the scores in a set. Again referring to FIG. 5, scores which are multiple of IQRs past Q3 have values very different from the majority of scores. FIG. 5 also illustrates the adaptability that the threshold determination of the present invention possesses by showing that the median location of a set of scores, as well as their distribution, can affect threshold determination. See Koopmans, 1987, Introduction to Contemporary Statistical Methods, Duxbury Press, Boston, p46.

It should be noted there is no a priori reason that these thresholds must be simplistically described by a limit. However, a limit may be set. The essential mechanistic step is to compare the scores from all possible interactions, in order to determine threshold values that act as a boundaries between scores that cluster together (denoting false, weak, background associations) and higher outlier scores (denoting real, strong associations). The degree of error in this boundary assignment may determine the amount of false-positive and false-negative predictions that may be made later in Shevek. Finally, visual distribution analysis may be useful to supplement this process, or further mathematical analysis (density analysis, such as the use of Barlett Window functions).

Having completed this preliminary signal/noise analysis, resulting in a preliminary list of pair-wise combinations that designates real, strong interactions (RS), this list (RS) may be further refined to eliminate scores resulting from chain effects, as follows: all scores that have at least one position in common are placed in a common group; because each score is for a pair-wise combination, it follows that within each group there may be scores without a position in common to another score, but are linked indirectly through other scores. Consider the following hypotherical RS list, where the two positions being scored are designated Pos1 and Pos2, V is the V score, −log is the −log of the P score, and DF is the DF score.

| Pos1 | Pos2 | V | −logP | DF |
|---|---|---|---|---|
| 1 | 5 | .52 | 6.2 | 24 |
| 3 | 10 | .54 | 5.1 | 120 |
| 5 | 10 | .60 | 6.1 | 64 |
| 7 | 9 | .65 | 6.2 | 90 |

In this case, two groups are present: the first consisting of pair-wise combinations 1-5, 3-10, and 5-10 (because 1-5 and 5-10, share the position 5 in common, and 3-10 and 5-10 share the position 10 in common); the second group consists of only the pair-wise combination 7-9.

For each group, the “pinnacle” member of each group is chosen in the following manner: −logP scores within each group are compared; the highest −logP score (and its linked data) are retained, all other pair-wise combinations are eliminated from the group. If more than one pair-wise combination remains, then DF scores for the remaining pair-wise combinations are compared; the lowest DF is retained, all other pair-wise combinations are eliminated from the group. If more than one pair-wise combination remains, then V scores for the remaining pair-wise combinations are compared; the highest V score is retained, all other pair-wise combinations are eliminated from the group. If more than one pair-wise combination remains in the group at this juncture, then all are retained because calculations may have error, it may be useful when selecting the highest −log, the lowest DF, and highest V score, to allow for some error in these scores. A suggested error range for the best −log P score is −[0-1.5], with a default value of 0; for the lowest DF, an error range of +[0-2] for each dimension (I,J), with a default value of +1 for each dimension; for highest V, an error range of −[0-1], with a default value of 0. In this manner, the pinnacle member of each group is chosen. It may be reasonable at this point to eliminate pair-wise combinations whose DF score is greater than DFMAX. DFMAX is an empirical parameter whose default value is 150, and whose range may be (2-361). This concludes the screening process. The pair-wise combinations that remain on the RS list comprise the initial output predictions of the preferred embodiment of the present invention.

The application of these predicted interaction results are beyond the scope of the present invention, but are obvious to the skilled artisan. The uses of these results are numerous, including but not limited to, structure prediction, analysis of existing structures for important motifs or regions, and the prediction of biochemical and biophysical interactions between macromolecules.

At this juncture, or previously in parallel with steps 3-7 in FIG. 1, sensitivity measurements of all scores may be performed. This may be performed according to the methods for bootstrapping described in Efron, 1981, Biometrika, 68:589-599, incorporated herein by reference. Generally, a random subset of the initial sequence alignment (i.e. a subset of sequences) is repeatedly taken, and the above processes (steps 3-7 in FIG. 1) performed. A count of how often the same predictions occur is made. Predictions which repeatedly occur are robust—signifying predictions to be taken most seriously; predictions which occur infrequently are sensitive—signifying predictions with less value.

The preferred embodiment of the present invention also comprises a prediction methodology comprising a process for reviewing the initial alignment and identifying possibly misaligned sequences (the “misalignment process”). These sequences can then be eliminated or re-aligned, resulting in a new sequence alignment. This allows for the present invention to be iterative, successively analyzing sequence data, making predictions, and then refining the sequence data, and so on, ultimately preferably resulting in more accurate predictions. It should be noted however that because this misalignment process requires the predictions made in the previous iteration, it may be dependent upon the previous predictions.

The misalignment process is as follows: for each of the real, strong associations identified at the conclusion of the above screening processes (the refined RS list), there exists the corresponding actual frequency table that was created at the beginning of the process.

Using each of these actual frequency tables as input, a corresponding set of adjusted residual (AR) tables are created. Each AR table is created using equations VIII, IX and X:

$${AR}_{ij} = \frac{{n}_{ij} - {\hat{u}}_{ij}}{\sqrt{{\hat{u}}_{ij} ( 1 - {p}_{i +} ) ( 1 - {p}_{+ j} )}} , \qquad ( VIII )$$

where nᵢⱼ, uᵢⱼ are as defined previously in equation II; and pᵢ₊ and p₊ⱼ are defined as:
pᵢ₊=nᵢ₊/n, (IX)
p₊ⱼ=n₊ⱼ/n (X)
where nᵢ₊, n₊ⱼ, and n are as defined previously in equation I. (Agresti, 1996, An introduction to Categorical Data Analysis, Wiley, New York, p16-34, incorporated herein by reference).

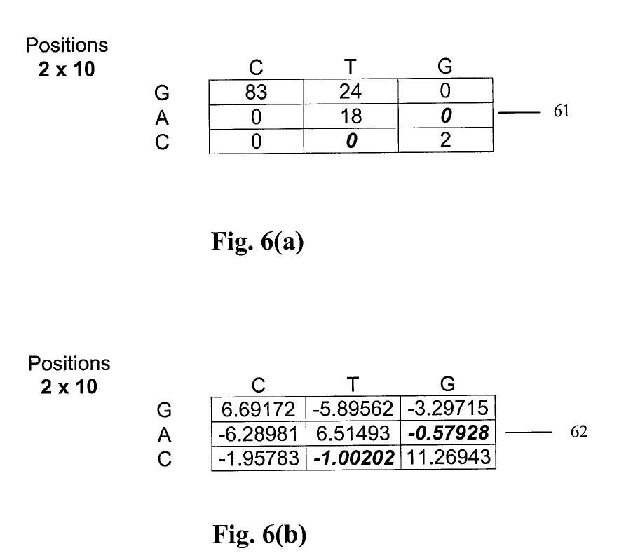

A nonlimiting example of an AR table 62 created from an actual frequency table 61 is shown in FIG. 6 (note that in FIG. 6, the sequence positions are designated by numbers rather than capital letters). The value found in each cell of an AR table 62 is a measure of how much that particular cell contributed to the scores received by the corresponding actual frequency table 61.

In the preferred embodiment, the cells in each AR table are (i.e., “less than or equal to”) then classified into two categories (each AR table having its own two categories): all cells whose |value|≦ARTHRESH are placed into category GOOD and all cells whose |value|≦ARTHRESH are placed into category MISALIGNED. The default value ARTHRESH is 1.0, with a range of (.1-3), and is a suggested, alterable empirical parameter based upon statements made in Agresti, 1996, An introduction to Categorical Data Analysis, Wiley, New York, p16-34, incorporated herein by reference.

Cells in category GOOD identify character combinations that actually occur for the given interaction—these combinations will be used later as suggested alternatives for sequences that are determined to be misaligned. They also describe molecular interactions that exist in nature and can be used to analyze known structures and to create an unbiased database of molecular interactions, in a manner obvious to the skilled artisan. Cells in category MISALIGNED identify character combinations that are the possible result of misalignment.

For every character combination in each category MISALIGNED (for each AR table), a search of the sequence alignment is then performed to identify the names of every sequence containing those particular characters at those particular positions. The end result of all such searches is one combined table comprised of sequence names, the MISALIGNED character combinations appearing in those sequences, and the positions where those characters appear.

This table is then used in the following manner in the preferred embodiment of the invention: (A) All sequence names that occur at least REPEAT number of times may be identified as misaligned. (REPEAT is an empirically adjustable parameter with a default value of 2, and a range of 1-10) Correspondingly, the table data associated with these misaligned sequences are now designated as misaligned characters at specific position-pairs. (B) The position-pairs at which these sequences are misaligned are then used to identify the corresponding previously calculated AR table. As was stated before, category GOOD character combinations denote suggested alternative combinations for that region of the misaligned sequence. For each such identified AR table these category GOOD character combinations are rank ordered from positive to negative, denoting better to worse alternatives.

Thus finally, for each identified misaligned sequence, the following may be output: a) Misaligned Sequence Name; b) The misaligned character combinations; c) The position-pairs of those character combinations; and d) suggested alternative character combinations.

Commonly known alignment tools or visual inspection are two possible methods that can utilize this data to adjust the sequence alignment. Sequence Alignment Editor, Se—Al, for Macintosh OS, by Andrew Rambaut, Department of Zoology, University of Oxford, Oxford, UK, evolve.zoo.ox.ac.uk, Andrew.rambaut.zoo.ox.ac.uk, is one such editing software. Realignment may be accomplished in the following manner: for each misaligned region in each misaligned sequence, neighboring characters that match the suggested alternative characters may be identified. Through the use of gap insertion or gap deletion, in a manner obvious to the skilled artisan, the suggested character may be placed into the proper column, and the character designated as misaligned from that column may be displaced. However, it should be understood that if an inordinate number of sequences (a good rule of thumb is >10%) are misaligned, or an inordinate number of sequence regions, it may be concluded that the entire initial sequence alignment is flawed; consequently, since the calculations made by Shevek were based on a largely flawed set of input data they too are most-likely flawed. In this circumstance, the predictions should be discarded, and an a new initial sequence alignment created, with due consideration being given to the essential methodological points raised in Phillips et al., 2000, Mol Phylogenet Evol 16: 317-330.

Once a new alignment is created, another iteration of Shevek can be performed. In this manner the method of the present invention can be iterated, until no more sequences are found to be misaligned or can be realized—the predictions made by Shevek with that final sequence alignment may designate the final interaction predictions.

It will be appreciated by the skilled artisan that the above-enumerated steps of the present invention may be practiced in differing order. Generally, actual frequency tables are generated prior to the expected frequency tables. The calculation of DF or its equivalent, need only be preceded by the creation of the actual frequency tables. The calculation of χ² or its equivalent, need only be preceded by the creation of the actual and expected frequency tables. The calculation of V or its equivalent, need only be preceded by the calculation of χ² and its dependent requirements. The classification of pair-wise combinations into categories Normal and Sparse, need only be preceded by the generation of expected frequency tables. The creation of the χ² distribution for normal tables need only be preceded by the calculation of DF and its dependent requirements. The creation of the χ² distribution for Sparse tables need only be preceded by the creation of the actual frequency table. The calculation of P scores need only be preceded by the calculation of χ² scores and χ² distributions, and their dependent requirements. The threshold determining process need only be preceded by calculation of P and V scores, or their equivalents. Any sensitivity process may proceed in parallel with the above calculations or following the conclusion of the screening process.

It will be appreciated by the skilled artisan that certain steps of the method of the present invention may be omitted without departing from the spirit of the present invention. First, the misaligmnent and sensitivity processes may be omitted, although error may be enhanced; Second, only a minimum of one score need be calculated, although error may be enhanced—consequently, steps required for the generation of other scores may be omitted. Third, χ² distributions may all be calculated according to the method for Sparse tables; thus, the calculation of χ² distributions for Normal tables may be omitted; in this case, error may not be enhanced, although computational time may be increased. Correspondingly, when the distributions are calculated only according to one method, the classification of tables into categories Normal and Sparse may be omitted.

The steps of the above-described method are preferably performed by a computer. In one preferred embodiment, the computer is a Dell Precision 430 dual processor Pentium III™, 933 Mz Workstation. Use of the sequence alignment editor software, Se—Al, may be performed on a Power Macintosh 8600/300 Power PC. When the method is performed by a computer, the above-described method steps are embodied in a program storage device readable by a machine, such program storage device including a computer readable medium. Computer readable media include magnetic diskettes, magnetic tapes, optical disks, Read Only Memory, RAM, Direct Access Storage Devices, gate arrays, electrostatic memory, and any other like medium.

The source code of Shevek is appended hereto as Appendix A.

Although only preferred embodiments of the invention are specifically described above, it will be appreciated that modifications and variations of the invention are possible without departing from the spirit and intended scope of the invention.

The following examples are provided to more clearly illustrate the aspects of the invention and are not intended to limit the scope of the invention.

### EXAMPLES

### Example 1

### Prediction of Secondary Structure of Domain Five of the Group II Catalytic RNA AI5γ Ribozyme Using the Shevek Method

Ribozymes are a novel class of RNA and are useful in understanding genomic change. The region of the group II A15γ ribozyme responsible for its catalytic reaction is domain 5; however, there does not presently exist a known structure of the domain five (V) region, either through crystallographic or spectroscopic methods (i.e. NMR). What is known concerning the structure of this region has therefore been determined only by difficult, biochemical techniques (e.g. solvent accessibility tests, etc.), which took months to perform. See Konforti et al., 1998, Mol. Cell 1:433-441. The exemplary embodiment of the present invention, in a matter of hours, calculated many of the important biochemically determined structural features of this region, with a specificity of 100%—notably, without being aware that the sequence was RNA and without an understanding of the traditional Watson-Crick base-pairing rules that often govern folding. Consequently, the ability of the exemplary embodiment of the present invention to perform this structural determination, using methodologies that treated the sequence data as sets of “meaningless symbols” indicates that the present invention can be applied to biopolymers in general, for the reasons previously described.

Biopolymer data of 126 sequences related to the AI5γ D5 region were obtained by searching the NCBI database (http:/www.ncbi.nlm.nih.gov/) for similar sequences or sequences already identified as being to Group II ribozymes. See step 1 in FIG. 1. These sequences were then aligned using the CLUSTAL X™ software, obtained from ftp://ftp-igbmc.u-strasbg.fr/pub/ClustalX/. See step 2 in FIG. 1. This resulted in the sequence alignment shown in Table I below. See step 3 in FIG. 1.

A file containing this data set was then read into memory and analyzed by Shevek algorithms. The primary purpose of the following description is to illustrate further the preferred method.

The set of non-redundant two-way combinations of positions (possible interactions) produced by the Combinatorial Matching Process of the present invention is shown below in Table II. See steps 4-5 in FIG. 1. Numbering corresponds to the position number from the alignment in Table I.

For each of the interactions, an actual frequency table was produced, a few examples of which are shown in Table III (step 5 in FIG. 1). 1225 actual frequency tables were generated by the AI5γ data set.

The Shevek method then performed the calculation of scores and their standardization according to the methods described above (Equations I-V). See steps 6-7 in FIG. 1. Note that the precision of the P scores was set to 7 decimal places (Thus, no P score has an value less than 0.0000001.) Examples of scores and standardized scores, are shown in Table IV below. This table is not comprehensive but is instead illustrative. For each of the interactions (Table II) scores were calculated.

The Shevek method then performed its threshold determining process, and calculated the following values: −logP Threshold=5.6; V Threshold=0.45. See FIG. 7 for illustrative graphics of the −logP score distribution, the V score distribution, and a −logP versus V plot. These plots have been generated for the purpose of reader comprehension and are not necessary or produced by the Shevek method itself. Using the above thresholds, the Shevek method then eliminated all pair-wise combinations with scores below these thresholds, resulting in an RS list. The RS list for this example can be seen in Table V.

A chain elimination process was then performed, resulting in the grouping of the pair-wise combinations where scores having a common position were grouped, as shown in Table VI. After the scores are grouped, a pinnacle association is determined in any chain of associations. The pinnacle association may be chosen first according to the highest P, then the lowest DF and then the highest V. When the pinnacle association of each group was chosen as described above, this resulted in the list of predictions shown in Table VII.

The Shevek method, upon output of the above list of predictions, then began the misalignment process. For each of the actual frequency tables associated with the previously predicted associations, an AR table was calculated (equations VIII, IX and X), each cell in each table corresponding to one in the related actual frequency table. See Table VIII for these AR tables. Cells having an |AR| value <=ARTHRESH, where the default value of 1.0 was used, were identified. These cells correspond to character-character combinations that belong to possibly misaligned sequences were designated category MISALIGNED. The 3 highest AR values in each table were assigned in order to category GOOD. Using the methods previously described, the sequences responsible for the counts in MISALIGNED cells were identified. Sequences identified a minimum of REPEAT number of times, where the default value of 2 was used, are considered the most-likely to be misaligned. Table IX is the misalignment output (step 9 in FIG. 1) of the preferred method.

Four sequences were identified as misaligned. These sequences were inspected and edited using the sequence alignment editor program Se—Al, as described previously. [Sequences #43 (_ZPU16993_cox2) and sequence #52 (_BVSCOXIII_cox2_{—}1) were noted to be misaligned and realigned (see Table X). Sequence #16(DRP130746_Dp_nad5) and sequence #73(petB_{—}45_) were noted to be unusual, but not in need of realignment.] The entire Shevek process was then repeated on the altered sequence alignment data set i.e. the process was iterated.

The results of iteration are apparent in Table XI (compare to Table V), the new RS list, and Table XII (compare to Table VII), the new list of predictions. It is notable that the inclusion of a misalignment process not only results in better scores for previously known predictions (e.g. the V score for 15×33 went from 0.55 to 0.59); but more importantly, two previous missed interactions are detected: 5×45 and 13×35. Thus, the predictions of the Shevek method have been enhanced via iteration.

This 2^{nd} set of predictions was then applied by the user in the following manner: the distances between all positions predicted to associate were minimized, allowing the biopolymer to collapse. This resulted in the structure shown in FIG. 8(a). FIG. 8(b) is a diagram of the biochemically determined structure of this same region (Konforti et al., 1998, Mol. Cell 1:433-441). An overall comparison reveals striking similarity. However, even more important are the following observations: classic RNA folding is often done according to base-pairing rules; However, in region II, it is ambiguous according to such rules whether or not the U pairs with the G across from it (in what is known as a wobble pair) or instead pairs with the A across from it (in a more classic Watson-Crick manner). As this interaction occurs at the “kink” in the molecule, any attempt to model this region requires this ambiguity to be resolved. Biochemically, this was resolved by testing the accessibility of these units to chemical modification. For Shevek, this ambiguity, which required lengthy biochemical analysis to resolve by previous methods (Konforti et al., 1998, Mol. Cell 1:433-441), was quickly and easily solved. Shevek determined the correct interaction, the U-G interaction, over the U-A interaction.

In addition, the “G” in region I (see FIGS. 8(a) and 8(b)) has previously been identified thorough biochemical analysis to be involved in the catalytic reaction of this ribozyme. See Konforti et al., 1998, Mol. Cell 1:433-441. It is therefore an unusual unit. Further studies suggest that it may be “flipped out” and not undergoing an interaction with the opposite “U”. Classic analysis using base-pairing “rules” suggest an interaction between this G and U. Shevek, in accordance with known studies, correctly does not predict an interaction between the G and the U units. Thus Shevek has predicted not only correct associations, but also has correctly highlighted units of particular functional interest.

The specificity (accuracy) of Shevek, defined as the number of predictions that are true over the total number of predictions, for this molecule is 100%. The sensitivity (coverage) of its predictions, however, can only be estimated based on what is known about the structure, and is ˜76%.

Taken together, these date show that the exemplary embodiment of the present invention is able to predict interactions in an accurate, more time efficient and easier manner than previously described methods. The inclusion of an adaptive screening process and a misalignment process are central to such abilities. In addition, the present invention is capable of accurate and efficient interaction determination using a biochemically-neutral, non-biased, “no-rules” approach, indicating that the present invention is useful for predicting interactions for biopolymers generally and for predicting heterobiopolymer interactions.

TABLE I
Sequence Alignment Data

POSITION

```
                      1 1 1 1 1 2 2 2 2 2 3 3 3 3 3 4 4 4 4 4
  0 2 4 6 8 0 2 4 6 8 0 2 4 6 8 0 2 4 6 8 0 2 4 6 8
```

Sequence of Interest:

| | |
|---|---|
| ai5gamma | ----GAGCCGTATGCGAT-----GAAA----GTCGCACGTACGGTTC--T |

Functionally Related Sequences:

| | |
|---|---|
| MICLURF1_ndh1_{——}01_ | ----GAGCCACATGCAGG-----GAAA----CTTGCACGTGTGGTTC--T |
| _MIZMCO_cox2_1_{——}02_ | ----GAGCTTTTTGCGGG-----GAAA----CTTGCAAGTCAAGTTT--G |
| _DCCOXII_cox2_1 | ----GAGCTTTTTGCGGG-----GAAA----CTTGCAAGTACAGTTT--G |
| _MITACOII_cox2_1 | ----GAGCTTTTTGCGGG-----GAAA----CTTGCAAGTCAAGTTT--G |
| MIPHCO21_cox2_1 | ----GAGCTTTTTGCGGG-----GAAA----CTTGCAAGTACAGTTT--G |
| _MIOSO1_Os_cox2 | ----GAGCTTTTTGCGGG-----GAAA----CTTGCAAGTAAAGTTT--G |
| _MIHACOXII_cox2 | ----GAGCTTTTTGCGGG-----GAAA----CTTGCAAGTACAGTTT--G |
| _MIDBG2IA_{——}nad5_1_03_ | ----GAGCCGTGTGATGG-----GAAA----CCTTCCCGCACGGTTC--G |
| _MTVFNAD5_nad5_1 | ----GAGCCGTGTGATGG-----GAAA----CCTTCCCGCACGGTTC--G |
| MIATNAD5A_nad5_1 | ----GAGCCGTGTGATGG-----GAAA----CCTTCCCGCACGGTTC--G |
| TSP131146_nad5 | ----GAGCCGTATGCGAG-----GAAA----CTTGCACGTGCGGTTC--T |
| TRA131145_nad5 | ----GAGCCGTATGCGAG-----GAAA----CTTGCACGTGCGGTTC--T |
| ASP130735_Sc_nad5 | ----GAGCCGTATGCGAG-----GAAA----CTTGCACGTGCGGTTC--T |
| SAU131147_nad5 | ----GAGCCGTATGCGAG-----GAAA----CTTGCACGTGCGGTTC--T |
| AEV130737_Ap_nad5 | ----GAGCCGTATGCGGG-----GAAA----CTTGCACGTGCGGTTC--T |
| DPR130746_Dp_nad5 | ----GAGCCGTATGCGAA----GGAAA----CTTGCACGTGCGGTTC--T |
| ANNAD5_An_nad5 | ----GAGCCGTATGCGAG-----GAAA----CTTGCACGTGCGGTTC--T |
| DSP130747_Dd_nad5 | ----GAGCCGTATGCGAG-----GAAA----CTTGCACGTGCGGTTC--T |
| SWI131144_nad5 | ----GAGCCGTATGCGAG-----GAAA----CTTGCACGTGCGGTTC--T |
| AF143422_Tc_nad5 | ----GAGCCGTGTGATGG-----GAAA----CCTCCCCGCACGGTTC--G |
| AF143423_Pa_nad5 | ----GAGCCGTGTGATGG-----GAAA----CCTCCCCGCACGGTTC--G |
| AF143424_Ca_nad5 | ----GAGCCGTGTGATGG-----GAAA----CCTCCCCGCACGGTTC--G |
| AF143425_Cp_nad5 | ----GAGCCGTGTGATGG-----GAAA----CCTCCCCGCACGGTTC--G |
| MTPACG_nad5_4_{——}08_ | ----GAGCCGTATGATGG-----GAAA----CTATCACGTACGGTTC--G |
| MIATGENA_nad7_1 | ----TGAGCGCATGCGGG-----GAGA----CCCGCACGTACGGTTT--T |
| MIATGENA_nad7_3 | ----GAGCCGTATGAAGG-----GAAA----CTCTCACGTACAGTTT--G |
| _MPOMTCG_nad3 | ----GAGCCGTGTAATGG-----GCAA----CTATTTCGCACGGTTC--G |
| MIATGENA_nad4_3 | ----GAGCCTAGTGATAG-----GAGA----CTATCTAGCTTGGTTC--G |
| _MPOMTCG_nad4 | ----GAGCCGTATGCGAG-----GAGA----CTTGCACGTACGGTTC--G |
| MISC13_cox1_1_{——}04_ | ----AAGCCGTATGATGG-----GAAA----CTATCACGTACGGTTT--G |
| MTPACG_cox1_1_{——}07_ | ----GAGCCGTATGCGGT-----GAAA----GTCGCACGTACGGTTC--G |
| MTPCCOX1_cox1_1 | ----GAGCCGTATGCGGT-----GAAA----GTCGCACGTACGGTTC--G |
| SPO251292_cox1_1 | ----GAGCCGTATGCATT-----GAAA----GATGCACGTACGGTTC--T |
| MIKLCOX1_cox1_1 | ----GAGCCGTATGATAT-----GAAA----GTATCACGTACGGTTC--G |
| MISC13_{——}cox1_2_05_ | ----GAGCCGTATGATAT-----GAAA----GTATCACGTACGGTTC--G |
| MTPACG_cox1_4_{——}06_ | ----GAGCCGTATGCAGG-----GAAA----CTTGCACGTACGGTTC--G |
| AMU41288_Am_cox1_3 | ----GAGCCGTATGCGGT-----GAAA----GTTGCACGTACGGTTC--G |
| MISPCG_cob_{——}09_ | ----GAGCCGTATAATTA----CGAAA----GTATCCCGTACGGTTC--G |
| CHNTXX_rps12_10_ | ----AAGCCGTATTCGAT-----GAAA----GTCGTATGTACGGCTT--G |
| CHSORPS_rps12_2_11_ | ----AAGCCGTATTCGAT-----GAAA----GTCGTATGTACGGCTT--G |
| CHZMXX_{——}rps12_2_12_ | ----AAGCCGTATTCGAT-----GAAA----GTCGTATGTACGGCTT--G |
| CHMPXX_rps12_2_13_{——} | ----AAGCCGTATTCGTT-----GAAA----ATCGGATGTACGGTTT--G |
| _ZPU16993_cox2 | -----GAGCTTTTTGCGGG----GAAA----CTTGCAAGTCAAGTTT--G |
| AFO80087_Ot_rps3 | ----GAGCCGTGTGATGG-----GTGA----CTATCCAGCACGGTTC--G |
| CHNTXX_{——}trnI_14_ | ----GAGCGCAGTACAAC----GGAGA----GTTGTATGCTGCGTTC--G |
| CHZMXX_trnI_15_ | ----GAGCGCAGTACAAC----GGGGA----GTTGTATGCTGCGTTC--G |
| CHMPXX_{——}trnI_16_ | ----GAGCGCAGTACAAC----GGAAA----GTTGTATGCTGCGTTC--G |
| WHTCPTRNI_trnI | ----GAGCGCAGTACAAC----GGGGA----GTTGTATGCTGCGTTC--G |
| CHNTXX_{——}trnA_17_ | ----GAGCACAGTACGAT-----GAAA----GTTGTAAGCTGTGTTC--G |
| CHZMXX_trnA_18_ | ----GAGCACAGTACGAT-----GAAA----GTTGTAAGCTGTGTTC--G |
| CHMPXX_trnA_{——}19_ | ----GAGCACAGTACGAT-----GAAA----GTTGTAAGCTGTGTTT--G |
| _BVSCOXII1_cox2_1 | -----GAGCTTTTTGCGGG----GAAA----CTTGCAAGTACAGTTT--G |
| CHNTXX_trnK_26_ | ----AAGCCGTGTGCAAT-----GAAA----AATGCAAGCACGGCTT--G |
| CHSATRNK_trnK_27_ | ----AAGCTGTGTGCAAT-----GAAA----AATGCAAGCACGGTTT--G |
| CHMPXX_{——}trnK_28_ | ----AAGCCGTATGCAGT-----AAAA----ATTGCAAGTACGGTTT--G |
| CHNTXX_{——}atpF_29_ | ----GAGCCAAATGAATC-----GAAA----GATTCATGTTTGGTTC--G |
| CHPSATPC_atpF_30_ | ----GAGCCAAATGAATT-----GAAA----GATTCATGTTTGGTTC--G |
| SOL400848_atpF_31_ | ----GAGCCAAATGAATT-----GAAA----AATTCACGTTTGGTTC--G |
| CHTAATP1_atpF_32_ | ----GAGCCAAATGAATC-----GAAA----GATTCATGTTTGGTTC--G |
| CHMPXX_atpF_{——}33_ | ----AAGCCGAATGAATT-----GAAA----AGTTCATGTTCGGTTT--G |
| HVUO10573_atp9 | ----GAGCCAAATGAATC-----GAAA----GATTCATGTTTGGTTC--G |
| CHNTXX_{——}rp12_34_ | ----AAGAAGTATGCTTT-----GGAA----GAAGCTTGTACAGTTT--G |
| CHMPXX_{——}Cp_rp12 | ----AAGCTGTATGCTT------GAAA----AAAGCTTGTACAGTTT--G |
| MIATGENA_rp12_1 | ----GAGCCGTACGAG-------GCAG------CTCACGTACGGTTC--G |
| SCEO11856_cytB_{——}37_ | ----GAGCTGTATACTAT-----GAAA----GTAGTACGTACAGTTC--T |
| CHNTXX_{——}rps16_38_ | ----GAGCCGTACGAGGA-----GAAA----GCTTCCTATACGTTTC--T |
| CHNTXX__rpoC1_39_ | ----GAGCCGGATGAAAG-----GAAA----CTTTCACGTCCGATTT--T |
| SOL400848_rpoC1_40_ | ----GAGCCGGGCGAGGG-----GAAA----CTTTCACGTCCGGCTT--T |
| CHMPXX_rpoC1_{——}41_ | ----GAGCCGGATGACGG-----AAAA----CTTTCATGTCCGATTC--T |
| CHMPXX_orf135_42_ | ----AAGCCATACAGAGTT----GAAA----ATATCATATATGGTTT--T |
| CHNTXX_{——}petB_43_ | ----GAGCTGTACGAGAT-----GAAA----GTCTCATATACGGTTC--T |
| SOL400848_petB_44_ | ----GAGCTGTACGAGAT-----GAAA----GTCTCATATACAGTTC--T |
| CHZMXX_petB_45_ | ----GAGCCGTACGAGAT-----GAAA----TTTTCATATACGGTTC--- |
| CHMPXX_{——}petB_46_ | ----AAGCTGTAAGATTA-----TAAA----TAATCATTTACGGTTT--T |
| CHNTXX_{——}petD_47_ | ----GAGCTGGATGATTA-----AAAA----TTATCATGTCCAGTTC--C |
| SOL400848_petD_48_ | ----GAGCCGGATGATGA-----AAAA----TTATCATGTCCGGTTC--T |
| CHZMXX_petD_49_ | ----GAGCCGGATGATGAA-----AAA----TTCTCATGTCCGGTTC--C |
| CHMPXX_{——}petD_50_ | ----GAGCCGGATGATAT-----TAAA----TTATCATGTCCGATTC--T |
| CHNTXX_{——}clpP_1_51_ | ----GAACCGTATGCATC-----AAAA----GGCGCATGTACGGTTC--C |
| CHMPXX_{——}clpP_1_52_ | ----AAGCTGTATGCGCTT----AAAA----AGTGCTTGTACAGTTT--T |
| CHNTXX_{——}ycf3_2_53_ | ----GAGCCGTATGAGGT---AAGAAA----TTCTCAAGTACGGTTC--T |
| CHNTXX_{——}rp116_54_ | ----GAGCTGGATGAGAA-----GAAA----CTCTCACGTCCGGTTC--T |
| CHZMXX_rp116_55_ | ----GAGCTGGATGAGAA-----GAAA----CTCTCATGTCCAGTTT--T |
| CHSOL16_rp116_56_ | ----GAGCCGGATGAGAA-----GAAA----CTCTCATGTCCGGTTC--T |
| CHMPXX_{——}rp116_57_ | ----GAGCCGGATGAAT-----CAAAA-----TTTCATGTCCGGTTT--T |
| CHNTXX_{——}ndh1_58_ | ----GAGCCGTATGAGAT-----GAAA----ATCTCACGTACGGTTC--T |
| CHMPXX_ndh1_{——}59_ | ----GAGCCGTATGAAAT-----GAAA----ATTTCATGTACGGTTT--T |
| CHNTXX_{——}ndh2_60_ | ----GAGCCGTGTGAGAT-----GAAA----GTCTCATGCACGGTTT--T |
| CHMPXX_{——}ndh2_61_ | ----GAGCCGTGTGAATT-----GAAA----ATCTCATGCACGGTTT--T |
| OBENAD202_nad2_4 | ----GAGCCGTATGATGG-----GCAA----CTATCTCCTGCGGTTC--G |
| CHNTXX_ycf3_1_62_ | ----GAGCCGTATGAGGT-----GAAA----ATCTCACGTACGGTTC--T |
| CHMPXX_{——}ycf3_1_63_ | ----GAGCCGTATGAAGT----TTAA----ACTTCATGTACGGTTT--T |
| _{——}CHNTXX__trnG_64_ | ----GAGCCGAATGAAAC-----CAAA----GTTTCATGTTCGGTTT--T |
| _{——}CHTATRN1_trnG_65_ | ----GAGCCGAATGAAAT-----CAAA----ATTTCATGTTCGGTTT--T |
| _{——}CHMPXX_trnG__66_ | ----GAGCCGAATGAAAG-----AAAA----CTTTCACGTTCGGTTT--T |
| _{——}MPOMTCG_trnG | ----GAGCCGGATGAGGGA----GAAA---TTTCTCACGTCCGGATC--T |
| CHNTXX_{——}rps12_1_67_ | ----GAGCCGTATGAGGT-----GAAA----ATCTCATGTACGGTTC--T |
| CHMPXX_{——}rps12_1_68_ | ----AAGCCGTATGAAAT-----GAAA----ATATCAAGTACGGTTT--T |
| CHZMXX_rps12_1_69_ | ----GAGCCGTATGAGGT-----GAAA----ATCTCATGTACGGTTC--T |
| AMU41288_Am_rn1 | ----GAGCCGTATGCGAT-----GAAA----GTTGCACGTACGGTTC--T |
| AFO29891_Cp_srRNA1 | ----GAGCCGTATGCGAT-----GAAA----GTCGCACGTACGGTTC--T |
| TPSSRRA_ssurRNA | ----GAGCCGTATGCGAT-----GAAA----GTTGCACGTACGGTTC--T |
| AFO87656_Aa_srRNA | ----GAGCTGTATGCGAT-----GAAA----GTCGCACGTACAGTTC--T |
| AFO29891Cp_srRNA2 | ----GAGCCGTATGCCAT-----GAAA----GTGGCACGTACGGTTC--T |
| PLRRNA23_1rn_1 | ----CAGCCGTGTGCGGT-----GAAA----GTCGCACGCACGGTTG--T |
| PLRRNA23_1rn_2 | ----GAGCCGTGTGCGAT-----GAAA----GTCGCAAGCACGGTTC--T |
| PLRRNA23_1rn_3 | ----GAGCCGTGTGCGTT-----GAAA----GATGCATGCACGGTTC--T |
| PLRRNA23_1rn_4 | ----GAGCCGTATGAATG-----GAGA----CATTCACGTACGGTTT--T |
| MISOLSUR_rns2 | ----GAGCCGTGTGCGGT-----GAAA----GTCGCATGCACGGTTC--T |
| MPOMTCG_trnS | ----GAGCCGTATGCGG------GAAAA---CTCGCACGTACGGTTC--T |
| Azotobacter_Av_groEL | ----GAGCCGTATGCGGG-----GAAA----CTCGCACGTACGGTTC--T |
| AFO65404_Ba_pX01 | ----GAGCCGTATGTGCT-----GAAA----GGTACAAGTACGGTTC--- |
| ABO11549_Ec_IntE | ----GAGCCGTATGCCGG-----GAAA----CTGGCACGTACGGTTC--T |
| PSY18999_Pp_Int5041C | ----GAGCCGGATGAGGG-----GCGA----CTCTCATGTCCGGTTC--T |
| ECHREP_Ec_IntB | ----GAGCGGTATGAGCC-----GAGA----GGTTCACGTACCGTTC--T |
| RMREVTM_Rm_Int1 | ----GAGCGGTGTGAATC-----GAGA----GGTTCACGCACCGTTC--T |
| ASU13767_An_hlyA | ----GAGCCGTGTGCAGC-----GAAA----GTTGCACGCACGGATC--T |
| p | ----GAGCCGTATGAGGT-----GAAA----GTCTCAAGTACGGTTT--T |
| LLU50902_L1_1trB | ----GAGCCGTATACTCC-----GAGA----GGGGTACGTACGGTTC--C |
| PAU77945_Pa_Xin6 | ----CCGCCGTGTACG-------GAAC------CGTACGCACGGTGG--T |
| CDIIORF_Cd_orf14 | ----ACGCCGTGTGAGGG-----GAAA----CTCTCATGCACGGTGT--G |
| ABO22308_Bm_TnpR | ----ACGCCGTATGCTG------GAAA----CTCGCCTGTACGGTCT--G |
| MTPLCOX1_cox1_1 | ----AAGCCGTATGAGGG-----GAAA----CTTTCACGTACGGTTT--G |
| MTPLCOX1_cox1_2 | ----GAGCCGTATGATGG-----GAAA----CTATCACGTACGGTTC--T |
| MTPLCOX1_cox1_3 | ----GAGCCCGGTGCGGT-----GAAA----GTCGCACGCCGGGTTC--G |
| SFU97489_Sf_IntA | ----GAGCCGGATGCGCT-----GAAA----GGTGCACGTCCGGTTC--G |

TABLE II
Interaction List for D5 Sequence Alignment:

| | | | | | | |
|---|---|---|---|---|---|---|
| 0 × 1 | 0 × 45 | 1 × 41 | 2 × 38 | 3 × 36 | 4 × 35 | 5 × 35 |
| 0 × 2 | 0 × 46 | 1 × 42 | 2 × 39 | 3 × 37 | 4 × 36 | 5 × 36 |
| 0 × 3 | 0 × 47 | 1 × 43 | 2 × 40 | 3 × 38 | 4 × 37 | 5 × 37 |
| 0 × 4 | 0 × 48 | 1 × 44 | 2 × 41 | 3 × 39 | 4 × 38 | 5 × 38 |
| 0 × 5 | 0 × 49 | 1 × 45 | 2 × 42 | 3 × 40 | 4 × 39 | 5 × 39 |
| 0 × 6 | 1 × 2 | 1 × 46 | 2 × 43 | 3 × 41 | 4 × 40 | 5 × 40 |
| 0 × 7 | 1 × 3 | 1 × 47 | 2 × 44 | 3 × 42 | 4 × 41 | 5 × 41 |
| 0 × 8 | 1 × 4 | 1 × 48 | 2 × 45 | 3 × 43 | 4 × 42 | 5 × 42 |
| 0 × 9 | 1 × 5 | 1 × 49 | 2 × 46 | 3 × 44 | 4 × 43 | 5 × 43 |
| 0 × 10 | 1 × 6 | 2 × 3 | 2 × 47 | 3 × 45 | 4 × 44 | 5 × 44 |
| 0 × 11 | 1 × 7 | 2 × 4 | 2 × 48 | 3 × 46 | 4 × 45 | 5 × 45 |
| 0 × 12 | 1 × 8 | 2 × 5 | 2 × 49 | 3 × 47 | 4 × 46 | 5 × 46 |
| 0 × 13 | 1 × 9 | 2 × 6 | 3 × 4 | 3 × 48 | 4 × 47 | 5 × 47 |
| 0 × 14 | 1 × 10 | 2 × 7 | 3 × 5 | 3 × 49 | 4 × 48 | 5 × 48 |
| 0 × 15 | 1 × 11 | 2 × 8 | 3 × 6 | 4 × 5 | 4 × 49 | 5 × 49 |
| 0 × 16 | 1 × 12 | 2 × 9 | 3 × 7 | 4 × 6 | 5 × 6 | 6 × 7 |
| 0 × 17 | 1 × 13 | 2 × 10 | 3 × 8 | 4 × 7 | 5 × 7 | 6 × 8 |
| 0 × 18 | 1 × 14 | 2 × 11 | 3 × 9 | 4 × 8 | 5 × 8 | 6 × 9 |
| 0 × 19 | 1 × 15 | 2 × 12 | 3 × 10 | 4 × 9 | 5 × 9 | 6 × 10 |
| 0 × 20 | 1 × 16 | 2 × 13 | 3 × 11 | 4 × 10 | 5 × 10 | 6 × 11 |
| 0 × 21 | 1 × 17 | 2 × 14 | 3 × 12 | 4 × 11 | 5 × 11 | 6 × 12 |
| 0 × 22 | 1 × 18 | 2 × 15 | 3 × 13 | 4 × 12 | 5 × 12 | 6 × 13 |
| 0 × 23 | 1 × 19 | 2 × 16 | 3 × 14 | 4 × 13 | 5 × 13 | 6 × 14 |
| 0 × 24 | 1 × 20 | 2 × 17 | 3 × 15 | 4 × 14 | 5 × 14 | 6 × 15 |
| 0 × 25 | 1 × 21 | 2 × 18 | 3 × 16 | 4 × 15 | 5 × 15 | 6 × 16 |
| 0 × 26 | 1 × 22 | 2 × 19 | 3 × 17 | 4 × 16 | 5 × 16 | 6 × 17 |
| 0 × 27 | 1 × 23 | 2 × 20 | 3 × 18 | 4 × 17 | 5 × 17 | 6 × 18 |
| 0 × 28 | 1 × 24 | 2 × 21 | 3 × 19 | 4 × 18 | 5 × 18 | 6 × 19 |
| 0 × 29 | 1 × 25 | 2 × 22 | 3 × 20 | 4 × 19 | 5 × 19 | 6 × 20 |
| 0 × 30 | 1 × 26 | 2 × 23 | 3 × 21 | 4 × 20 | 5 × 20 | 6 × 21 |
| 0 × 31 | 1 × 27 | 2 × 24 | 3 × 22 | 4 × 21 | 5 × 21 | 6 × 22 |
| 0 × 32 | 1 × 28 | 2 × 25 | 3 × 23 | 4 × 22 | 5 × 22 | 6 × 23 |
| 0 × 33 | 1 × 29 | 2 × 26 | 3 × 24 | 4 × 23 | 5 × 23 | 6 × 24 |
| 0 × 34 | 1 × 30 | 2 × 27 | 3 × 25 | 4 × 24 | 5 × 24 | 6 × 25 |
| 0 × 35 | 1 × 31 | 2 × 28 | 3 × 26 | 4 × 25 | 5 × 25 | 6 × 26 |
| 0 × 36 | 1 × 32 | 2 × 29 | 3 × 27 | 4 × 26 | 5 × 26 | 6 × 27 |
| 0 × 37 | 1 × 33 | 2 × 30 | 3 × 28 | 4 × 27 | 5 × 27 | 6 × 28 |
| 0 × 38 | 1 × 34 | 2 × 31 | 3 × 29 | 4 × 28 | 5 × 28 | 6 × 29 |
| 0 × 39 | 1 × 35 | 2 × 32 | 3 × 30 | 4 × 29 | 5 × 29 | 6 × 30 |
| 0 × 40 | 1 × 36 | 2 × 33 | 3 × 31 | 4 × 30 | 5 × 30 | 6 × 31 |
| 0 × 41 | 1 × 37 | 2 × 34 | 3 × 32 | 4 × 31 | 5 × 31 | 6 × 32 |
| 0 × 42 | 1 × 38 | 2 × 35 | 3 × 33 | 4 × 32 | 5 × 32 | 6 × 33 |
| 0 × 43 | 1 × 39 | 2 × 36 | 3 × 34 | 4 × 33 | 5 × 33 | 6 × 34 |
| 0 × 44 | 1 × 40 | 2 × 37 | 3 × 35 | 4 × 34 | 5 × 34 | 6 × 35 |
| 6 × 36 | 7 × 40 | 8 × 45 | 10 × 12 | 11 × 20 | 12 × 29 | 13 × 39 |
| 6 × 37 | 7 × 41 | 8 × 46 | 10 × 13 | 11 × 21 | 12 × 30 | 13 × 40 |
| 6 × 38 | 7 × 42 | 8 × 47 | 10 × 14 | 11 × 22 | 12 × 31 | 13 × 41 |
| 6 × 39 | 7 × 43 | 8 × 48 | 10 × 15 | 11 × 23 | 12 × 32 | 13 × 42 |
| 6 × 40 | 7 × 44 | 8 × 49 | 10 × 16 | 11 × 24 | 12 × 33 | 13 × 43 |
| 6 × 41 | 7 × 45 | 9 × 10 | 10 × 17 | 11 × 25 | 12 × 34 | 13 × 44 |
| 6 × 42 | 7 × 46 | 9 × 11 | 10 × 18 | 11 × 26 | 12 × 35 | 13 × 45 |
| 6 × 43 | 7 × 47 | 9 × 12 | 10 × 19 | 11 × 27 | 12 × 36 | 13 × 46 |
| 6 × 44 | 7 × 48 | 9 × 13 | 10 × 20 | 11 × 28 | 12 × 37 | 13 × 47 |
| 6 × 45 | 7 × 49 | 9 × 14 | 10 × 21 | 11 × 29 | 12 × 38 | 13 × 48 |
| 6 × 46 | 8 × 9 | 9 × 15 | 10 × 22 | 11 × 30 | 12 × 39 | 13 × 49 |
| 6 × 47 | 8 × 10 | 9 × 16 | 10 × 23 | 11 × 31 | 12 × 40 | 14 × 15 |
| 6 × 48 | 8 × 11 | 9 × 17 | 10 × 24 | 11 × 32 | 12 × 41 | 14 × 16 |
| 6 × 49 | 8 × 12 | 9 × 18 | 10 × 25 | 11 × 33 | 12 × 42 | 14 × 17 |
| 7 × 8 | 8 × 13 | 9 × 19 | 10 × 26 | 11 × 34 | 12 × 43 | 14 × 18 |
| 7 × 9 | 8 × 14 | 9 × 20 | 10 × 27 | 11 × 35 | 12 × 44 | 14 × 19 |
| 7 × 10 | 8 × 15 | 9 × 21 | 10 × 28 | 11 × 36 | 12 × 45 | 14 × 20 |
| 7 × 11 | 8 × 16 | 9 × 22 | 10 × 29 | 11 × 37 | 12 × 46 | 14 × 21 |
| 7 × 12 | 8 × 17 | 9 × 23 | 10 × 30 | 11 × 38 | 12 × 47 | 14 × 22 |
| 7 × 13 | 8 × 18 | 9 × 24 | 10 × 31 | 11 × 39 | 12 × 48 | 14 × 23 |
| 7 × 14 | 8 × 19 | 9 × 25 | 10 × 32 | 11 × 40 | 12 × 49 | 14 × 24 |
| 7 × 15 | 8 × 20 | 9 × 26 | 10 × 33 | 11 × 41 | 13 × 14 | 14 × 25 |
| 7 × 16 | 8 × 21 | 9 × 27 | 10 × 34 | 11 × 42 | 13 × 15 | 14 × 26 |
| 7 × 17 | 8 × 22 | 9 × 28 | 10 × 35 | 11 × 43 | 13 × 16 | 14 × 27 |
| 7 × 18 | 8 × 23 | 9 × 29 | 10 × 36 | 11 × 44 | 13 × 17 | 14 × 28 |
| 7 × 19 | 8 × 24 | 9 × 30 | 10 × 37 | 11 × 45 | 13 × 18 | 14 × 29 |
| 7 × 20 | 8 × 25 | 9 × 31 | 10 × 38 | 11 × 46 | 13 × 19 | 14 × 30 |
| 7 × 21 | 8 × 26 | 9 × 32 | 10 × 39 | 11 × 47 | 13 × 20 | 14 × 31 |
| 7 × 22 | 8 × 27 | 9 × 33 | 10 × 40 | 11 × 48 | 13 × 21 | 14 × 32 |
| 7 × 23 | 8 × 28 | 9 × 34 | 10 × 41 | 11 × 49 | 13 × 22 | 14 × 33 |
| 7 × 24 | 8 × 29 | 9 × 35 | 10 × 42 | 12 × 13 | 13 × 23 | 14 × 34 |
| 7 × 25 | 8 × 30 | 9 × 36 | 10 × 43 | 12 × 14 | 13 × 24 | 14 × 35 |
| 7 × 26 | 8 × 31 | 9 × 37 | 10 × 44 | 12 × 15 | 13 × 25 | 14 × 36 |
| 7 × 27 | 8 × 32 | 9 × 38 | 10 × 45 | 12 × 16 | 13 × 26 | 14 × 37 |
| 7 × 28 | 8 × 33 | 9 × 39 | 10 × 46 | 12 × 17 | 13 × 27 | 14 × 38 |
| 7 × 29 | 8 × 34 | 9 × 40 | 10 × 47 | 12 × 18 | 13 × 28 | 14 × 39 |
| 7 × 30 | 8 × 35 | 9 × 41 | 10 × 48 | 12 × 19 | 13 × 29 | 14 × 40 |
| 7 × 31 | 8 × 36 | 9 × 42 | 10 × 49 | 12 × 20 | 13 × 30 | 14 × 41 |
| 7 × 32 | 8 × 37 | 9 × 43 | 11 × 12 | 12 × 21 | 13 × 31 | 14 × 42 |
| 7 × 33 | 8 × 38 | 9 × 44 | 11 × 13 | 12 × 22 | 13 × 32 | 14 × 43 |
| 7 × 34 | 8 × 39 | 9 × 45 | 11 × 14 | 12 × 23 | 13 × 33 | 14 × 44 |
| 7 × 35 | 8 × 40 | 9 × 46 | 11 × 15 | 12 × 24 | 13 × 34 | 14 × 45 |
| 7 × 36 | 8 × 41 | 9 × 47 | 11 × 16 | 12 × 25 | 13 × 35 | 14 × 46 |
| 7 × 37 | 8 × 42 | 9 × 48 | 11 × 17 | 12 × 26 | 13 × 36 | 14 × 47 |
| 7 × 38 | 8 × 43 | 9 × 49 | 11 × 18 | 12 × 27 | 13 × 37 | 14 × 48 |
| 7 × 39 | 8 × 44 | 10 × 11 | 11 × 19 | 12 × 28 | 13 × 38 | 14 × 49 |
| 15 × 16 | 16 × 29 | 17 × 43 | 19 × 28 | 20 × 45 | 22 × 36 | 24 × 31 |
| 15 × 17 | 16 × 30 | 17 × 44 | 19 × 29 | 20 × 46 | 22 × 37 | 24 × 32 |
| 15 × 18 | 16 × 31 | 17 × 45 | 19 × 30 | 20 × 47 | 22 × 38 | 24 × 33 |
| 15 × 19 | 16 × 32 | 17 × 46 | 19 × 31 | 20 × 48 | 22 × 39 | 24 × 34 |
| 15 × 20 | 16 × 33 | 17 × 47 | 19 × 32 | 20 × 49 | 22 × 40 | 24 × 35 |
| 15 × 21 | 16 × 34 | 17 × 48 | 19 × 33 | 21 × 22 | 22 × 41 | 24 × 36 |
| 15 × 22 | 16 × 35 | 17 × 49 | 19 × 34 | 21 × 23 | 22 × 42 | 24 × 37 |
| 15 × 23 | 16 × 36 | 18 × 19 | 19 × 35 | 21 × 24 | 22 × 43 | 24 × 38 |
| 15 × 24 | 16 × 37 | 18 × 20 | 19 × 36 | 21 × 25 | 22 × 44 | 24 × 39 |
| 15 × 25 | 16 × 38 | 18 × 21 | 19 × 37 | 21 × 26 | 22 × 45 | 24 × 40 |
| 15 × 26 | 16 × 39 | 18 × 22 | 19 × 38 | 21 × 27 | 22 × 46 | 24 × 41 |
| 15 × 27 | 16 × 40 | 18 × 23 | 19 × 39 | 21 × 28 | 22 × 47 | 24 × 42 |
| 15 × 28 | 16 × 41 | 18 × 24 | 19 × 40 | 21 × 29 | 22 × 48 | 24 × 43 |
| 15 × 29 | 16 × 42 | 18 × 25 | 19 × 41 | 21 × 30 | 22 × 49 | 24 × 44 |
| 15 × 30 | 16 × 43 | 18 × 26 | 19 × 42 | 21 × 31 | 23 × 24 | 24 × 45 |
| 15 × 31 | 16 × 44 | 18 × 27 | 19 × 43 | 21 × 32 | 23 × 25 | 24 × 46 |
| 15 × 32 | 16 × 45 | 18 × 28 | 19 × 44 | 21 × 33 | 23 × 26 | 24 × 47 |
| 15 × 33 | 16 × 46 | 18 × 29 | 19 × 45 | 21 × 34 | 23 × 27 | 24 × 48 |
| 15 × 34 | 16 × 47 | 18 × 30 | 19 × 46 | 21 × 35 | 23 × 28 | 24 × 49 |
| 15 × 35 | 16 × 48 | 18 × 31 | 19 × 47 | 21 × 36 | 23 × 29 | 25 × 26 |
| 15 × 36 | 16 × 49 | 18 × 32 | 19 × 48 | 21 × 37 | 23 × 30 | 25 × 27 |
| 15 × 37 | 17 × 18 | 18 × 33 | 19 × 49 | 21 × 38 | 23 × 31 | 25 × 28 |
| 15 × 38 | 17 × 19 | 18 × 34 | 20 × 21 | 21 × 39 | 23 × 32 | 25 × 29 |
| 15 × 39 | 17 × 20 | 18 × 35 | 20 × 22 | 21 × 40 | 23 × 33 | 25 × 30 |
| 15 × 40 | 17 × 21 | 18 × 36 | 20 × 23 | 21 × 41 | 23 × 34 | 25 × 31 |
| 15 × 41 | 17 × 22 | 18 × 37 | 20 × 24 | 21 × 42 | 23 × 35 | 25 × 32 |
| 15 × 42 | 17 × 23 | 18 × 38 | 20 × 25 | 21 × 43 | 23 × 36 | 25 × 33 |
| 15 × 43 | 17 × 24 | 18 × 39 | 20 × 26 | 21 × 44 | 23 × 37 | 25 × 34 |
| 15 × 44 | 17 × 25 | 18 × 40 | 20 × 27 | 21 × 45 | 23 × 38 | 25 × 35 |
| 15 × 45 | 17 × 26 | 18 × 41 | 20 × 28 | 21 × 46 | 23 × 39 | 25 × 36 |
| 15 × 46 | 17 × 27 | 18 × 42 | 20 × 29 | 21 × 47 | 23 × 40 | 25 × 37 |
| 15 × 47 | 17 × 28 | 18 × 43 | 20 × 30 | 21 × 48 | 23 × 41 | 25 × 38 |
| 15 × 48 | 17 × 29 | 18 × 44 | 20 × 31 | 21 × 49 | 23 × 42 | 25 × 39 |
| 15 × 49 | 17 × 30 | 18 × 45 | 20 × 32 | 22 × 23 | 23 × 43 | 25 × 40 |
| 16 × 17 | 17 × 31 | 18 × 46 | 20 × 33 | 22 × 24 | 23 × 44 | 25 × 41 |
| 16 × 18 | 17 × 32 | 18 × 47 | 20 × 34 | 22 × 25 | 23 × 45 | 25 × 42 |
| 16 × 19 | 17 × 33 | 18 × 48 | 20 × 35 | 22 × 26 | 23 × 46 | 25 × 43 |
| 16 × 20 | 17 × 34 | 18 × 49 | 20 × 36 | 22 × 27 | 23 × 47 | 25 × 44 |
| 16 × 21 | 17 × 35 | 19 × 20 | 20 × 37 | 22 × 28 | 23 × 48 | 25 × 45 |
| 16 × 22 | 17 × 36 | 19 × 21 | 20 × 38 | 22 × 29 | 23 × 49 | 25 × 46 |
| 16 × 23 | 17 × 37 | 19 × 22 | 20 × 39 | 22 × 30 | 24 × 25 | 25 × 47 |
| 16 × 24 | 17 × 38 | 19 × 23 | 20 × 40 | 22 × 31 | 24 × 26 | 25 × 45 |
| 16 × 25 | 17 × 39 | 19 × 24 | 20 × 41 | 22 × 32 | 24 × 27 | 25 × 49 |
| 16 × 26 | 17 × 40 | 19 × 25 | 20 × 42 | 22 × 33 | 24 × 28 | 26 × 27 |
| 16 × 27 | 17 × 41 | 19 × 26 | 20 × 43 | 22 × 34 | 24 × 29 | 26 × 28 |
| 16 × 28 | 17 × 42 | 19 × 27 | 20 × 44 | 22 × 35 | 24 × 30 | 26 × 29 |
| 26 × 30 | 28 × 33 | 30 × 40 | 33 × 35 | 36 × 39 | 40 × 43 | |
| 26 × 31 | 28 × 34 | 30 × 41 | 33 × 36 | 36 × 40 | 40 × 44 | |
| 26 × 32 | 28 × 35 | 30 × 42 | 33 × 37 | 36 × 41 | 40 × 45 | |
| 26 × 33 | 28 × 36 | 30 × 43 | 33 × 38 | 36 × 42 | 40 × 46 | |
| 26 × 34 | 28 × 37 | 30 × 44 | 33 × 39 | 36 × 43 | 40 × 47 | |
| 26 × 35 | 28 × 38 | 30 × 45 | 33 × 40 | 36 × 44 | 40 × 48 | |
| 26 × 36 | 28 × 39 | 30 × 46 | 33 × 41 | 36 × 45 | 40 × 49 | |
| 26 × 37 | 28 × 40 | 30 × 47 | 33 × 42 | 36 × 46 | 41 × 42 | |
| 26 × 38 | 28 × 41 | 30 × 48 | 33 × 43 | 36 × 47 | 41 × 43 | |
| 26 × 39 | 28 × 42 | 30 × 49 | 33 × 44 | 36 × 48 | 41 × 44 | |
| 26 × 40 | 28 × 43 | 31 × 32 | 33 × 45 | 36 × 49 | 41 × 45 | |
| 26 × 41 | 28 × 44 | 31 × 33 | 33 × 46 | 37 × 38 | 41 × 46 | |
| 26 × 42 | 28 × 45 | 31 × 34 | 33 × 47 | 37 × 39 | 41 × 47 | |
| 26 × 43 | 28 × 46 | 31 × 35 | 33 × 48 | 37 × 40 | 41 × 48 | |
| 26 × 44 | 28 × 47 | 31 × 36 | 33 × 49 | 37 × 41 | 41 × 49 | |
| 26 × 45 | 28 × 48 | 31 × 37 | 34 × 35 | 37 × 42 | 42 × 43 | |
| 26 × 46 | 28 × 49 | 31 × 38 | 34 × 36 | 37 × 43 | 42 × 44 | |
| 26 × 47 | 29 × 30 | 31 × 39 | 34 × 37 | 37 × 44 | 42 × 45 | |
| 26 × 48 | 29 × 31 | 31 × 40 | 34 × 38 | 37 × 45 | 42 × 46 | |
| 26 × 49 | 29 × 32 | 31 × 41 | 34 × 39 | 37 × 46 | 42 × 47 | |
| 27 × 28 | 29 × 33 | 31 × 42 | 34 × 40 | 37 × 47 | 42 × 48 | |
| 27 × 29 | 29 × 34 | 31 × 43 | 34 × 41 | 37 × 48 | 42 × 49 | |
| 27 × 30 | 29 × 35 | 31 × 44 | 34 × 42 | 37 × 49 | 43 × 44 | |
| 27 × 31 | 29 × 36 | 31 × 45 | 34 × 43 | 38 × 39 | 43 × 45 | |
| 27 × 32 | 29 × 37 | 31 × 46 | 34 × 44 | 38 × 40 | 43 × 46 | |
| 27 × 33 | 29 × 38 | 31 × 47 | 34 × 45 | 38 × 41 | 43 × 47 | |
| 27 × 34 | 29 × 39 | 31 × 48 | 34 × 46 | 38 × 42 | 43 × 48 | |
| 27 × 35 | 29 × 40 | 31 × 49 | 34 × 47 | 38 × 43 | 43 × 49 | |
| 27 × 36 | 29 × 41 | 32 × 33 | 34 × 48 | 38 × 44 | 44 × 45 | |
| 27 × 37 | 29 × 42 | 32 × 34 | 34 × 49 | 38 × 45 | 44 × 46 | |
| 27 × 38 | 29 × 43 | 32 × 35 | 35 × 36 | 38 × 46 | 44 × 47 | |
| 27 × 39 | 29 × 44 | 32 × 36 | 35 × 37 | 38 × 47 | 44 × 48 | |
| 27 × 40 | 29 × 45 | 32 × 37 | 35 × 38 | 38 × 48 | 44 × 49 | |
| 27 × 41 | 29 × 46 | 32 × 38 | 35 × 39 | 38 × 49 | 45 × 46 | |
| 27 × 42 | 29 × 47 | 32 × 39 | 35 × 40 | 39 × 40 | 45 × 47 | |
| 27 × 43 | 29 × 48 | 32 × 40 | 35 × 41 | 39 × 41 | 45 × 48 | |
| 27 × 44 | 29 × 49 | 32 × 41 | 35 × 42 | 39 × 42 | 45 × 49 | |
| 27 × 45 | 30 × 31 | 32 × 42 | 35 × 43 | 39 × 43 | 46 × 47 | |
| 27 × 46 | 30 × 32 | 32 × 43 | 35 × 44 | 39 × 44 | 46 × 48 | |
| 27 × 47 | 30 × 33 | 32 × 44 | 35 × 45 | 39 × 45 | 46 × 49 | |
| 27 × 48 | 30 × 34 | 32 × 45 | 35 × 46 | 39 × 46 | 47 × 48 | |
| 27 × 49 | 30 × 35 | 32 × 46 | 35 × 47 | 39 × 47 | 47 × 49 | |
| 28 × 29 | 30 × 36 | 32 × 47 | 35 × 48 | 39 × 48 | 48 × 49 | |
| 28 × 30 | 30 × 37 | 32 × 48 | 35 × 49 | 39 × 49 | | |
| 28 × 31 | 30 × 38 | 32 × 49 | 36 × 37 | 40 × 41 | | |
| 28 × 32 | 30 × 39 | 33 × 34 | 36 × 38 | 40 × 42 | | |

TABLE III
6 Sample Actual Frequency Tables (of 1225):

| Actual Frequency Table: 4 × 46 | | | | | Actual Frequency Table: 14 × 34 | | | | |
|---|---|---|---|---|---|---|---|---|---|
| | C | T | G | | | G | T | C | A |
| G | 83 | 21 | 0 | | C | 61 | 0 | 0 | 0 |
| T | 0 | 1 | 0 | | A | 0 | 58 | 4 | 0 |
| A | 0 | 18 | 0 | | G | 2 | 1 | 0 | 0 |
| C | 0 | 0 | 2 | | T | 0 | 0 | 0 | 1 |
| Actual Frequency Table: 11 × 39 | | | | | Actual Frequency Table: 12 × 38 | | | | |
| | T | C | | | | G | A | T | C |
| A | 88 | 0 | | | T | 118 | 0 | 0 | 1 |
| T | 8 | 0 | | | C | 2 | 5 | 0 | 0 |
| G | 1 | 30 | | | A | 0 | 0 | 1 | 0 |
| Actual Frequency Table: 15 × 33 | | | | | Actual Frequency Table: 17 × 31 | | | | |
| | T | A | C | G | | C | G | A | T |
| A | 26 | 2 | 3 | 0 | G | 45 | 0 | 0 | 1 |
| G | 31 | 0 | 33 | 0 | A | 4 | 2 | 0 | 4 |
| T | 7 | 17 | 2 | 1 | T | 0 | 32 | 17 | 3 |
| C | 3 | 0 | 0 | 2 | C | 0 | 13 | 0 | 0 |

TABLE IV
Sample Scores

| Pos1 | Pos2 | Chi-Sq. | P | V | DF | (−1) * logP |
|---|---|---|---|---|---|---|
| 4 | 5 | 152.74 | 1.32E−05 | 0.78164 | 6 | 4.9 |
| 4 | 6 | 62.094 | 0.018 | 0.70481 | 3 | 1.7 |
| 4 | 7 | 130.985 | 0.0042 | 0.72384 | 6 | 2.4 |
| 4 | 8 | 3.405 | 0.7139 | 0.09529 | 9 | 0.1 |
| 4 | 9 | 3.717 | 0.6532 | 0.09956 | 9 | 0.2 |
| 4 | 10 | 67.909 | 0.0046 | 0.42555 | 9 | 2.3 |
| 4 | 11 | 8.482 | 0.2067 | 0.1842 | 6 | 0.7 |
| 4 | 12 | 6.178 | 0.3007 | 0.1572 | 6 | 0.5 |
| 4 | 13 | 28.164 | 0.0349 | 0.33564 | 6 | 1.5 |
| 4 | 14 | 11.421 | 0.0906 | 0.17451 | 9 | 1 |
| 4 | 15 | 4.817 | 0.7687 | 0.11334 | 9 | 0.1 |
| 4 | 16 | 5.365 | 0.7046 | 0.12057 | 9 | 0.2 |
| 4 | 17 | 11.022 | 0.333 | 0.17571 | 9 | 0.5 |
| 4 | 23 | 2.292 | 0.7296 | 0.07849 | 9 | 0.1 |
| 4 | 24 | 2.154 | 0.6143 | 0.07578 | 9 | 0.2 |
| 4 | 25 | 11.655 | 0.0401 | 0.30535 | 3 | 1.4 |
| 4 | 26 | 62.187 | 0.047 | 0.49875 | 6 | 1.3 |
| 4 | 31 | 23.81 | 0.0137 | 0.25506 | 9 | 1.9 |
| 4 | 32 | 20.181 | 0.0719 | 0.23386 | 9 | 1.1 |
| 4 | 33 | 13.716 | 0.1208 | 0.19125 | 9 | 0.9 |
| 4 | 34 | 5.31 | 0.4421 | 0.11899 | 9 | 0.4 |
| 4 | 35 | 10.084 | 0.1062 | 0.20083 | 6 | 1 |
| 4 | 36 | 7.011 | 0.2906 | 0.16746 | 6 | 0.5 |
| 4 | 37 | 15.262 | 0.0136 | 0.24708 | 6 | 1.9 |
| 4 | 38 | 6.456 | 0.4007 | 0.13121 | 9 | 0.4 |
| 4 | 39 | 7.18 | 0.0635 | 0.23966 | 3 | 1.2 |
| 4 | 40 | 11.023 | 0.3258 | 0.17145 | 9 | 0.5 |
| 4 | 41 | 2.785 | 0.7841 | 0.08617 | 9 | 0.1 |
| 4 | 42 | 2.686 | 0.8166 | 0.08464 | 9 | 0.1 |
| 4 | 44 | 18.484 | 0.0949 | 0.27192 | 6 | 1 |
| 4 | 45 | 27.759 | 0.0264 | 0.47124 | 3 | 1.6 |
| 4 | 46 | 172.386 | 0.0000001 | 0.83039 | 6 | 7 |
| 4 | 49 | 11.344 | 0.1072 | 0.21474 | 6 | 1 |
| 5 | 6 | 94.488 | 2.18E−05 | 0.86256 | 2 | 4.7 |
| 5 | 7 | 127.026 | 5.66E−06 | 0.70718 | 4 | 5.2 |
| 5 | 9 | 17.257 | 0.0605 | 0.26065 | 6 | 1.2 |
| 5 | 10 | 21.594 | 0.0851 | 0.29157 | 6 | 1.1 |
| 5 | 11 | 22.002 | 0.0061 | 0.29431 | 4 | 2.2 |
| 5 | 13 | 28.009 | 0.0058 | 0.33207 | 4 | 2.2 |
| 5 | 14 | 55.871 | 0.0041 | 0.469 | 6 | 2.4 |
| 5 | 15 | 33.47 | 0.0056 | 0.36301 | 6 | 2.3 |
| 5 | 16 | 6.848 | 0.3056 | 0.16551 | 6 | 0.5 |
| 5 | 17 | 6.745 | 0.2608 | 0.16695 | 6 | 0.6 |
| 5 | 25 | 2.331 | 0.2831 | 0.13549 | 2 | 0.5 |
| 5 | 26 | 41.698 | 0.0917 | 0.40517 | 4 | 1 |
| 5 | 31 | 7.458 | 0.3177 | 0.17341 | 6 | 0.5 |
| 5 | 32 | 3.672 | 0.6637 | 0.1212 | 6 | 0.2 |
| 5 | 33 | 7.875 | 0.2446 | 0.17608 | 6 | 0.6 |
| 5 | 34 | 3.59 | 0.5532 | 0.11888 | 6 | 0.3 |
| 5 | 35 | 1.949 | 0.5392 | 0.0876 | 4 | 0.3 |
| 5 | 36 | 2.888 | 0.587 | 0.10663 | 4 | 0.2 |
| 5 | 37 | 7.343 | 0.1207 | 0.17003 | 4 | 0.9 |
| 5 | 39 | 4.024 | 0.1599 | 0.17801 | 2 | 0.8 |
| 5 | 40 | 3.231 | 0.91 | 0.11278 | 6 | 0 |
| 5 | 41 | 9.937 | 0.228 | 0.19779 | 6 | 0.6 |
| 5 | 42 | 8.268 | 0.2559 | 0.18042 | 6 | 0.6 |
| 5 | 45 | 127 | 6.20E−06 | 1 | 2 | 5.2 |
| 5 | 46 | 29.122 | 0.0018 | 0.3386 | 4 | 2.7 |
| 5 | 49 | 1.124 | 0.6381 | 0.06705 | 4 | 0.2 |
| 6 | 7 | 94.484 | 1.03E−05 | 0.86254 | 2 | 5 |
| 6 | 8 | 1.115 | 0.7295 | 0.0937 | 3 | 0.1 |
| 6 | 9 | 11.713 | 0.0574 | 0.30369 | 3 | 1.2 |
| 6 | 10 | 15.434 | 0.0656 | 0.3486 | 3 | 1.2 |
| 6 | 11 | 13.751 | 0.0121 | 0.32906 | 2 | 1.9 |
| 6 | 13 | 18.939 | 0.0129 | 0.38617 | 2 | 1.9 |
| 6 | 14 | 41.73 | 0.0013 | 0.57322 | 3 | 2.9 |
| 6 | 15 | 23.666 | 0.0074 | 0.43168 | 3 | 2.1 |
| 6 | 16 | 2.947 | 0.3782 | 0.15355 | 3 | 0.4 |
| 6 | 17 | 4.391 | 0.2109 | 0.19049 | 3 | 0.7 |
| 6 | 23 | 2.527 | 0.3541 | 0.14161 | 3 | 0.5 |
| 6 | 25 | 1.167 | 0.3279 | 0.09587 | 1 | 0.5 |
| 6 | 31 | 2.201 | 0.6313 | 0.13323 | 3 | 0.2 |
| 6 | 32 | 4.505 | 0.1498 | 0.18985 | 3 | 0.8 |
| 6 | 33 | 1.278 | 0.6662 | 0.10031 | 3 | 0.2 |
| 6 | 34 | 4.196 | 0.2561 | 0.18176 | 3 | 0.6 |
| 6 | 37 | 3.388 | 0.221 | 0.16333 | 2 | 0.7 |
| 6 | 39 | 1.277 | 0.5688 | 0.10029 | 1 | 0.2 |
| 6 | 40 | 1.334 | 0.9042 | 0.10248 | 3 | 0 |
| 6 | 41 | 6.823 | 0.1604 | 0.23178 | 3 | 0.8 |
| 6 | 42 | 4.882 | 0.1855 | 0.19606 | 3 | 0.7 |
| 6 | 46 | 3.29 | 0.1665 | 0.16094 | 2 | 0.8 |
| 6 | 49 | 6.677 | 0.0764 | 0.23113 | 2 | 1.1 |
| 7 | 8 | 31.781 | 0.034 | 0.35373 | 6 | 1.5 |
| 7 | 9 | 16.828 | 0.1326 | 0.25739 | 6 | 0.9 |
| 7 | 10 | 20.839 | 0.0656 | 0.28643 | 6 | 1.2 |
| 7 | 11 | 19.524 | 0.0167 | 0.27725 | 4 | 1.8 |
| 7 | 13 | 26.387 | 0.0149 | 0.32231 | 4 | 1.8 |
| 7 | 14 | 56.535 | 0.0081 | 0.47178 | 6 | 2.1 |
| 7 | 15 | 35.982 | 0.0014 | 0.37638 | 6 | 2.9 |
| 7 | 16 | 9.618 | 0.147 | 0.19614 | 6 | 0.8 |
| 7 | 17 | 6.304 | 0.3275 | 0.1614 | 6 | 0.5 |
| 7 | 24 | 41.855 | 0.0442 | 0.40594 | 6 | 1.4 |
| 7 | 25 | 2.141 | 0.3272 | 0.12985 | 2 | 0.5 |
| 7 | 31 | 6.003 | 0.4217 | 0.15559 | 6 | 0.4 |
| 7 | 32 | 11.65 | 0.2162 | 0.21587 | 6 | 0.7 |
| 7 | 33 | 6.339 | 0.2984 | 0.15797 | 6 | 0.5 |
| 7 | 34 | 4.196 | 0.354 | 0.12852 | 6 | 0.5 |
| 7 | 36 | 20.757 | 0.0536 | 0.28587 | 4 | 1.3 |
| 7 | 37 | 7.739 | 0.0857 | 0.17456 | 4 | 1.1 |
| 7 | 39 | 1.277 | 0.6795 | 0.10029 | 2 | 0.2 |
| 7 | 41 | 9.568 | 0.2562 | 0.19408 | 6 | 0.6 |
| 7 | 42 | 14.277 | 0.1173 | 0.23709 | 6 | 0.9 |
| 7 | 46 | 8.358 | 0.0693 | 0.1814 | 4 | 1.2 |
| 7 | 49 | 1.735 | 0.4839 | 0.0833 | 4 | 0.3 |
| 8 | 9 | 98.826 | 0.0000001 | 0.5093 | 9 | 7 |
| 8 | 10 | 32.288 | 0.0042 | 0.29111 | 9 | 2.4 |
| 8 | 11 | 46.058 | 5.14E−05 | 0.42583 | 6 | 4.3 |
| 8 | 12 | 8.569 | 0.1868 | 0.18368 | 6 | 0.7 |
| 8 | 13 | 43.6 | 0.0002308 | 0.41431 | 6 | 3.6 |
| 8 | 14 | 8.939 | 0.3665 | 0.15317 | 9 | 0.4 |
| 8 | 15 | 17.959 | 0.0501 | 0.21711 | 9 | 1.3 |
| 8 | 16 | 11.935 | 0.1999 | 0.1784 | 9 | 0.7 |
| 8 | 17 | 64.303 | 0.0000006 | 0.42088 | 9 | 6.2 |
| 8 | 23 | 3.367 | 0.8352 | 0.09438 | 9 | 0.1 |
| 8 | 24 | 38.113 | 0.0071 | 0.31628 | 9 | 2.1 |
| 8 | 25 | 41.173 | 1.59E−05 | 0.56939 | 3 | 4.8 |
| 8 | 31 | 19.012 | 0.0328 | 0.22607 | 9 | 1.5 |
| 8 | 32 | 12.582 | 0.1866 | 0.18317 | 9 | 0.7 |
| 8 | 33 | 9.346 | 0.3874 | 0.15662 | 9 | 0.4 |
| 8 | 34 | 8.146 | 0.417 | 0.14622 | 9 | 0.4 |
| 8 | 35 | 38.859 | 0.0021 | 0.39114 | 6 | 2.7 |
| 8 | 36 | 9.343 | 0.1476 | 0.19179 | 6 | 0.8 |
| 8 | 37 | 26.653 | 0.0002533 | 0.32393 | 6 | 3.6 |
| 8 | 38 | 10.324 | 0.257 | 0.16461 | 9 | 0.6 |
| 8 | 39 | 21.056 | 0.0001641 | 0.40718 | 3 | 3.8 |
| 8 | 40 | 36.487 | 0.0002374 | 0.30946 | 9 | 3.6 |
| 8 | 41 | 89.41 | 2.35E−06 | 0.48443 | 9 | 5.6 |
| 8 | 42 | 291.551 | 0.0000001 | 0.87477 | 9 | 7 |
| 8 | 44 | 2 | 0.8335 | 0.08874 | 6 | 0.1 |
| 8 | 46 | 12.317 | 0.129 | 0.22021 | 6 | 0.9 |
| 8 | 49 | 6.647 | 0.3534 | 0.16305 | 6 | 0.5 |
| 9 | 10 | 77.742 | 0.0000001 | 0.45172 | 9 | 7 |
| 9 | 11 | 140.401 | 0.0000001 | 0.74348 | 6 | 7 |
| 9 | 12 | 2.288 | 0.5416 | 0.09492 | 6 | 0.3 |
| 9 | 13 | 62.774 | 2.09E−06 | 0.49713 | 6 | 5.7 |
| 9 | 14 | 37.057 | 0.0033 | 0.31187 | 9 | 2.5 |
| 9 | 15 | 38.768 | 0.0003481 | 0.31899 | 9 | 3.5 |
| 9 | 16 | 34.539 | 0.0008098 | 0.30348 | 9 | 3.1 |
| 9 | 17 | 40.929 | 4.15E−05 | 0.33578 | 9 | 4.4 |
| 9 | 23 | 3.411 | 0.8013 | 0.09499 | 9 | 0.1 |
| 9 | 24 | 20.339 | 0.0644 | 0.23105 | 9 | 1.2 |
| 9 | 25 | 8.457 | 0.0561 | 0.25806 | 3 | 1.3 |
| 9 | 31 | 30.049 | 0.0017 | 0.28421 | 9 | 2.8 |
| 9 | 32 | 35.137 | 0.0014 | 0.3061 | 9 | 2.9 |
| 9 | 33 | 15.769 | 0.0802 | 0.20344 | 9 | 1.1 |
| 9 | 34 | 19.147 | 0.1324 | 0.22418 | 9 | 0.9 |
| 9 | 35 | 51.752 | 3.02E−06 | 0.45138 | 6 | 5.5 |
| 9 | 36 | 4.423 | 0.578 | 0.13196 | 6 | 0.2 |
| 9 | 37 | 60.051 | 0.0000001 | 0.48623 | 6 | 7 |
| 9 | 38 | 3.153 | 0.5868 | 0.09097 | 9 | 0.2 |
| 9 | 39 | 29.409 | 3.35E−06 | 0.48122 | 3 | 5.5 |
| 9 | 40 | 71.856 | 0.0000001 | 0.43428 | 9 | 7 |
| 9 | 41 | 293.696 | 0.0000001 | 0.87798 | 9 | 7 |
| 9 | 42 | 135.207 | 0.0000001 | 0.59571 | 9 | 7 |
| 9 | 46 | 15.979 | 0.0356 | 0.25082 | 6 | 1.4 |
| 9 | 49 | 26.172 | 0.0024 | 0.32356 | 6 | 2.6 |

. . . TO: combination 48×49 (data not shown)

Note: missing positions combinations denote non-scored combinations due to frequency table evaluation, as described in the preferred method. (e.g. frequency table that had a row or column length of less than 2).

TABLE V
RS List - After Threshold Application

| Pos1 | Pos2 | Chi-Sq. | P | V | DF | (−1) * logP |
|---|---|---|---|---|---|---|
| 4 | 46 | 172.386 | 0.0000001 | 0.83039 | 6 | 7 |
| 8 | 9 | 98.826 | 0.0000001 | 0.5093 | 9 | 7 |
| 8 | 42 | 291.551 | 0.0000001 | 0.87477 | 9 | 7 |
| 9 | 11 | 140.401 | 0.0000001 | 0.74348 | 6 | 7 |
| 9 | 13 | 62.774 | 2.092E−06 | 0.49713 | 6 | 5.7 |
| 9 | 37 | 60.051 | 0.0000001 | 0.48623 | 6 | 7 |
| 9 | 41 | 293.696 | 0.0000001 | 0.87798 | 9 | 7 |
| 9 | 42 | 135.207 | 0.0000001 | 0.59571 | 9 | 7 |
| 10 | 40 | 233.386 | 0.0000001 | 0.78266 | 9 | 7 |
| 11 | 39 | 121.636 | 0.0000001 | 0.97865 | 2 | 7 |
| 11 | 41 | 88.023 | 0.0000001 | 0.58868 | 6 | 7 |
| 11 | 42 | 77.633 | 0.0000001 | 0.55285 | 6 | 7 |
| 12 | 38 | 216.22 | 0.0000001 | 0.92264 | 6 | 7 |
| 13 | 35 | 115.777 | 0.0000001 | 0.67514 | 4 | 7 |
| 14 | 34 | 251.36 | 0.0000001 | 0.81224 | 9 | 7 |
| 15 | 33 | 115.825 | 0.0000001 | 0.55137 | 9 | 7 |
| 16 | 32 | 152.447 | 0.0000001 | 0.63759 | 9 | 7 |
| 17 | 31 | 143.557 | 0.0000001 | 0.62887 | 9 | 7 |
| 32 | 36 | 73.5 | 0.0000001 | 0.54222 | 6 | 7 |
| 40 | 41 | 87.446 | 0.0000001 | 0.47908 | 9 | 7 |
| 41 | 42 | 115.114 | 0.0000001 | 0.54967 | 9 | 7 |

TABLE VI
Goupings of RS Pairwise Combinations

| Pos1 | Pos2 | Group |
|---|---|---|
| 4 | 46 | 1 |
| 8 | 9 | 2 |
| 8 | 42 | 2 |
| 9 | 11 | 2 |
| 9 | 13 | 2 |
| 9 | 37 | 2 |
| 9 | 41 | 2 |
| 9 | 42 | 2 |
| 10 | 40 | 2 |
| 11 | 39 | 2 |
| 11 | 41 | 2 |
| 11 | 42 | 2 |
| 12 | 38 | 3 |
| 13 | 35 | 2 |
| 14 | 34 | 4 |
| 15 | 33 | 5 |
| 16 | 32 | 6 |
| 17 | 31 | 7 |
| 32 | 36 | 6 |
| 40 | 41 | 2 |
| 41 | 42 | 2 |

TABLE VII
1^{st} Pass Predictions - After Chain Elimination

Shevek Predictions

| Pos1 | Pos2 | V | −log(P) | DF |
|---|---|---|---|---|
| 4 | 46 | 0.83039 | 7.00000 | 6.0 |
| 11 | 39 | 0.97865 | 7.00000 | 2.0 |
| 12 | 38 | 0.92264 | 7.00000 | 6.0 |
| 14 | 34 | 0.81224 | 7.00000 | 9.0 |
| 15 | 33 | 0.55137 | 7.00000 | 9.0 |
| 16 | 32 | 0.63759 | 7.00000 | 9.0 |
| 17 | 31 | 0.62887 | 7.00000 | 9.0 |

TABLE VIII
AR Tables (7 of 7)

| AR Table for pair-wise combination 4 × 46: | | | | | AR Table for pair-wise combination 15 × 33: | | | | |
|---|---|---|---|---|---|---|---|---|---|
| | C | T | G | | | T | A | C | G |
| G | 7.06256 | −6.2979 | −3.1727 | | A | 3.99125 | −1.5277 | −2.8311 | −0.9961 |
| T | −1.4114 | 1.4636 | −0.128 | | G | −0.9825 | −4.7642 | 5.3681 | −1.7667 |
| A | −6.4464 | 6.68465 | −0.5847 | | T | −3.147 | 7.88063 | −2.8791 | 0.51726 |
| C | −2.0042 | −0.978 | 11.1803 | | C | 0.33104 | −0.9569 | −1.4908 | 5.6541 |
| AR Table for pair-wise combination 11 × 39: | | | | | AR Table for pair-wise combination 16 × 32: | | | | |
| | T | C | | | | T | C | A | G |
| A | 9.41425 | −9.4143 | | | G | 1.41824 | 3.78041 | −3.3219 | −2.5496 |
| T | 1.62498 | −1.625 | | | A | 4.12878 | −2.5592 | −1.747 | −2.2694 |
| G | −11.029 | 11.0289 | | | T | −5.3581 | −1.3958 | 7.36468 | 1.8159 |
| | | | | | C | −3.974 | −0.673 | −0.7775 | 8.72765 |
| AR Table for pair-wise combination 12 × 38: | | | | | AR Table for pair-wise combination 17 × 31: | | | | |
| | G | A | T | C | | C | G | A | T |
| T | 8.8971 | −8.799 | −3.8721 | 0.26031 | G | 10.0611 | −6.8655 | −3.483 | −1.5385 |
| C | −7.8618 | 9.44601 | −0.2425 | −0.2425 | A | −0.0334 | −1.2764 | −1.3349 | 4.43638 |
| A | −4.1568 | −0.2033 | 11.2694 | −0.0894 | T | −7.8777 | 4.44662 | 5.12299 | −0.3237 |
| | | | | | C | −3.1484 | 4.78872 | −1.543 | −1.0155 |

| AR Table for pair-wise combination 14 × 34: | | | | |
|---|---|---|---|---|
| | G | T | C | A |
| C | 10.9198 | −10.092 | −1.9538 | −0.9652 |
| A | −10.92 | 10.3922 | 2.08085 | −0.9805 |
| G | 0.59811 | −0.4612 | −0.3161 | −0.1562 |
| T | −0.9961 | −0.9352 | −0.1811 | 11.2694 |

TABLE IX
Misalignment Information (Output):
SEQUENCES IDENTIFIED AS POSSIBLY MISALIGNED:
(note: sequence numbering starts at 1)
(note: position numbering starts at 0)
(The character ‘#’denotes NO SUGGESTION POSSIBLE)
**********************************************
Sequence number 43 is possibly misaligned:

| | |
|---|---|
| Region/Positions: 14-34 | Units/Characters: G-G |

Suggested Alternatives (in order):
T-A
C-G
A-T

| | |
|---|---|
| Region/Positions: 15-33 | Units/Characters: C-T |

Suggested Alternatives (in order):
T-A
C-G
G-C
**********************************************
Sequence number 52 is possibly misaligned:

| | |
|---|---|
| Region/Positions: 14-34 | Units/Characters: G-G |

Suggested Alternatives (in order):
T-A
C-G
A-T

| | |
|---|---|
| Region/Positions: 15-33 | Units/Characters: C-T |

Suggested Alternatives (in order):
T-A
C-G
G-C
**********************************************
Sequence number 16 is possibly misaligned:

| | |
|---|---|
| Region/Positions: 15-33 | Units/Characters: G-T |

Suggested Alternatives (in order):
T-A
C-G
G-C

| | |
|---|---|
| Region/Positions: 17-31 | Units/Characters: A-C |

Suggested Alternatives (in order):
G-C
T-A
C-G
**********************************************
Sequence number 73 is possibly misaligned:

| | |
|---|---|
| Region/Positions: 15-33 | Units/Characters: G-T |

Suggested Alternatives (in order):
T-A
C-G
G-C

| | |
|---|---|
| Region/Positions: 17-31 | Units/Characters: T-T |

Suggested Alternatives (in order):
G-C
T-A
C-G

TABLE X
Corrected Sequence Information

| | |
|---|---|
| Reference: | |
| AI5gamma | ----GAGCCGTATGCGAT-----GAAA----GTCGCACGTACGGTTC--T |
| Sequence Number 43: | |
| Before: | |
| _ZPU16993_cox2 | -----GAGCTTTTTGCGGG----GAAA----CTTGCAAGTCAAGTTT--G |
| After: | |
| _ZPU16993_cox2 | ----GAGCTTTTTGCGGG-----GAAA----CTTGCAAGTCAAGTTT--G |
| Sequence Number 52: | |
| Before: | |
| _BVSCOXII1_cox2_1 | -----GAGCTTTTTGCGGG----GAAA----CTTGCAAGTACAGTTT--G |
| After: | |
| _BVSCOXII1_cox2_1 | ----GAGCTTTTTGCGGG-----GAAA----CTTGCAAGTACAGTTT--G |

TABLE XI
2^{nd} Pass RS List (Compare to Table V)

| Pos1 | Pos2 | Chi-Sq. | P | V | DF | (−1) * logP |
|---|---|---|---|---|---|---|
| 4 | 46 | 171.986 | 0.0000001 | 0.82287 | 6 | 7 |
| 5 | 45 | 127 | 0.0000001 | 1 | 2 | 7 |
| 8 | 9 | 116.604 | 0.0000001 | 0.55322 | 9 | 7 |
| 8 | 11 | 66.466 | 1.319E−06 | 0.51155 | 6 | 5.9 |
| 8 | 41 | 99.396 | 0.0000001 | 0.51077 | 9 | 7 |
| 8 | 42 | 307.446 | 0.0000001 | 0.8983 | 9 | 7 |
| 9 | 10 | 77.742 | 0.0000001 | 0.45172 | 9 | 7 |
| 9 | 11 | 140.401 | 0.0000001 | 0.74348 | 6 | 7 |
| 9 | 37 | 60.051 | 0.0000001 | 0.48623 | 6 | 7 |
| 9 | 41 | 293.696 | 0.0000001 | 0.87798 | 9 | 7 |
| 9 | 42 | 135.207 | 0.0000001 | 0.59571 | 9 | 7 |
| 10 | 40 | 233.386 | 0.0000001 | 0.78266 | 9 | 7 |
| 10 | 41 | 83.057 | 1.381E−06 | 0.4669 | 9 | 5.9 |
| 11 | 39 | 121.636 | 0.0000001 | 0.97865 | 2 | 7 |
| 11 | 41 | 88.023 | 0.0000001 | 0.58868 | 6 | 7 |
| 11 | 42 | 77.633 | 0.0000001 | 0.55285 | 6 | 7 |
| 12 | 38 | 216.22 | 0.0000001 | 0.92264 | 6 | 7 |
| 13 | 35 | 134.676 | 0.0000001 | 0.72816 | 4 | 7 |
| 14 | 34 | 254.139 | 0.0000001 | 0.81672 | 9 | 7 |
| 15 | 33 | 136.713 | 0.0000001 | 0.59902 | 9 | 7 |
| 16 | 32 | 152.447 | 0.0000001 | 0.63759 | 9 | 7 |
| 17 | 31 | 143.557 | 0.0000001 | 0.62887 | 9 | 7 |
| 32 | 36 | 73.5 | 0.0000001 | 0.54222 | 6 | 7 |
| 40 | 41 | 87.446 | 0.0000001 | 0.47908 | 9 | 7 |
| 41 | 42 | 115.114 | 0.0000001 | 0.54967 | 9 | 7 |

TABLE XII
2_{nd} Pass Predictions - After Chain Elimination
(Compare Table VII)

Shevek Predictions

| Pos1 | Pos2 | V | −log(P) | DF |
|---|---|---|---|---|
| 4 | 46 | 0.82287 | 7.00000 | 6.0 |
| 5 | 45 | 1.00000 | 7.00000 | 2.0 |
| 11 | 39 | 0.97865 | 7.00000 | 2.0 |
| 12 | 38 | 0.92264 | 7.00000 | 6.0 |
| 13 | 35 | 0.72816 | 7.00000 | 4.0 |
| 14 | 34 | 0.81672 | 7.00000 | 9.0 |
| 15 | 33 | 0.59902 | 7.00000 | 9.0 |
| 16 | 32 | 0.63759 | 7.00000 | 9.0 |
| 17 | 31 | 0.62887 | 7.00000 | 9.0 |

### Example b 2

### Prediction of Secondary and Tertiary Structure Elements of Phe-tRNA Using Shevek

tRNAs are critical RNA molecules necessary for the translation of mesenger RNA (mRNA) into protein sequences. The Shevek method, as described above for Example 1 (with the same default parameters) was applied to a sequence alignment of 41 Phe-tRNA sequences obtained from the tRNA sequence database (www.unibayreuth.de/deparments/biochemie/sprinzl/trna/index.html) (Sprinzl et al. Nucl. Acids Res. 1998, Vol.26,No.1., 148-153). The Shevek method resulted in seven predictions given this data set; these predictions further illustrate the great diversity and applicability of Shevek in two distinct ways. First: because Shevek treats data categorically, it is able to uniquely and critically handle the modified nucleotides that naturally occur in tRNA molecules. Shevek simply treats such modified nucleotides as merely another character in the alignment. Second: because Shevek is not a rule-based and biased method, it is not aware of the biochemical conventions that distinguish secondary structure and tertiary structure. Hence, as expected, it should be able to predict both structure types. Illustrated here is the accurate Shevek prediction of a tertiary contact (previously determined by crystallography and biochemistry) in tRNA.

It will be obvious to the skilled artisan that the position numbers (which identify positions in the alignment) correspond to specific units in the biopolymer of interest. In this case, the sequence of interest was chosen to be the Phe-tRNA from Saccharomyces cerevisiae, because its crystal structure has already been solved and thus provides for a ready check of the Shevek method. As shown in FIG. 9(a), the nucleotides (and modified nucleotides) to which the interacting positions correspond are listed next to the predictions.

Shevek predicts two interactions between modified nucleotides: first, between the N2-methylguanosine (m2G) at position 10 and the guanosine (G) at position 45; second, between the 5-methylcytidine (m5C) at position 49 and the guanosine (G) at position 65. In total, Shevek makes 7 predictions: 6 secondary structure interactions and one critically important tertiary interaction between the modified m2G at position 10 and the G at position 45. In order to fully appreciate the ability of Shevek to predict interactions, in FIG. 9(b) its predictions have been highlighted in colored pairs 9 (the tertiary interaction has been colored black; all other interactions are secondary structure interactions) in the crystal structure of Phe-tRNA (PDB ID: 1EHZ) by Shi et al. obtained from http://www.ncbi.nlm.nih.gov/Structure/). Note the close spatial proximity of each color pair.

Although Shevek makes only 7 predictions (having been designed to favor accuracy over coverage), and only 1 prediction subsequently categorized by convention as tertiary, its accuracy is 100%, with all interacting pairs coming within ˜3 Å of each other. These results can be compared to those obtained for tRNA using the method by Chiu and Kolodziejczak, 1991; here, although never explicitly stated, ˜23 tertiary predictions are made; however, the accuracy of this method is ˜13%. In the method of Gutell et al., 1992, as discussed previously, a consistent method of selecting/screening scores is not provided—and instead, these authors circularly use the known structure to screen their prediction scores. However, if one simply takes their best prediction for each nucleotide, an accuracy of ˜68% can be estimated. Neither of these prior art methods, however, works on biopolymers other than RNA.

### Example 3

### Prediction of Structural/Energetic Contacts and Protein-Protein Interactions in the HIV Protease Using Shevek

The Human Immunodeficiency Virus (HIV) is a well-known human pathogen with high morbidity and mortality. A prime target of drug intervention is the protein HIV protease. The Shevek method, as described above for Example 1 (with the same default parameters) was applied to a sequence alignment of 53 similar protease (protein) sequences obtained from the PFAM sequence database (Bateman et al.; http //www.sanger.ac.uk/Software/Pfam/) (PFAM keyword: RVP). These sequences were then aligned using the CLUSTAL X™ software. The Shevek method resulted in two predictions given this data set; these predictions illustrate the great diversity and applicability of Shevek in an additional two distinct ways. First, it is a critical demonstration of the ability of the Shevek method to analyze a protein biopolymer. Second, it illustrates the ability of Shevek to detect protein-protein interactions.

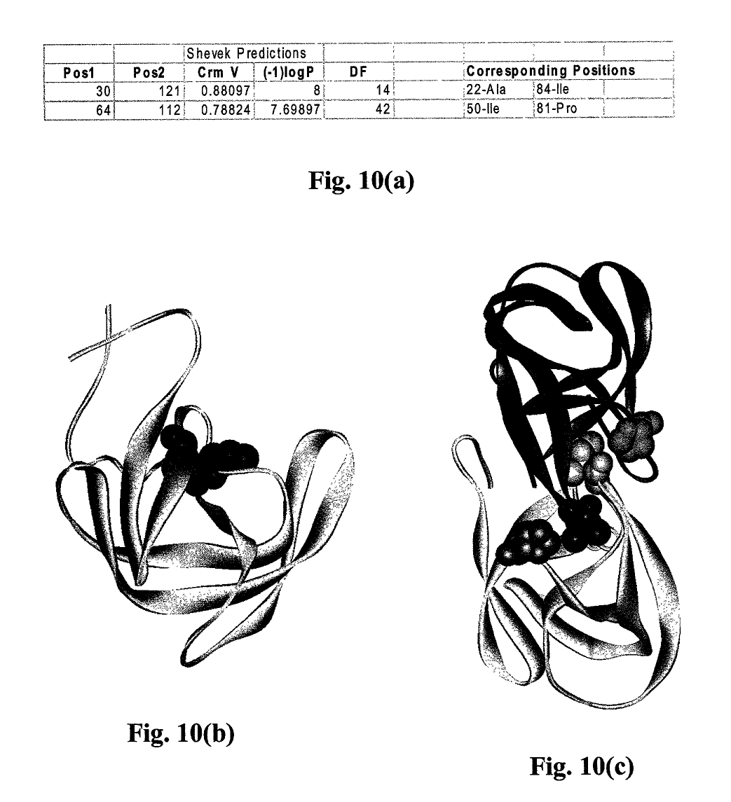

Again, it will be obvious to the skilled artisan that the position numbers (which identify positions in the alignment) correspond to specific units in the biopolymer of interest. In this case, the sequence of interest was chosen to be the HIV protease, because its crystal structure has already been solved and thus provides for a ready check of the Shevek method. As shown in FIG. 10(a), the amino acids to which the interacting positions correspond are listed next to the predictions.

Referring to FIG. 10(a), Shevek predicts an interaction between 22Ala and 84Ile, shown in red. This prediction, from the point of view of structure analysis, suggests that these two amino acids play a critical energetic role in the folding of this protein. From the point of view of structure prediction, (if the structure were not known) it suggests a close spatial proximity between 22Ala and 84Ile (4-5 Å). This prediction brings the two ends of the protein together (which is about ˜100 amino acids in total length), thus vastly reducing the possible structure space for this molecule. This makes prediction much easier as well as providing a check of any hypothetical structures.

Referring to FIG. 10(b), Shevek makes a second prediction between 50Ile and 81Pro (3-4 Å). This prediction illustrates the usefulness of the Shevek method in analyzing protein-protein interactions. The HIV protease acts as a dimer; disruption of this dimer would therefore be of great therapeutic value. The results of the Shevek method suggest that the interaction of 5Ile of one monomer and the 81Pro of the other monomer play a critical energetic role in the stability of this homodimer (shown in purple and green); this interaction is therefore a prime target for drug-based intervention. Because this interaction has been selected for (by definition, since Shevek would not have otherwise detected it), it follows that there are limited ways in which this interaction can be formed; thus, a drug that interrupts this interaction would be resistant to drug-resistance. From a structure prediction point of view, however, such homodimer intermolecular interactions would be difficult to sort from intramolecular interactions. For this reason, hetero-intermolecular interactions will be of even greater value.

Referring to FIGS. 10(b) and 10(c), Shevek predictions have been highlighted in colored pairs in the HIV protease crystal structure (PDB ID: 1DAZ) by Mahalingam et al., obtained from http://www.ncbi.nlm.nih.gov/Structure/). Again, although Shevek makes only 2 predictions (100% accuracy), each prediction is of great value. These results can be compared to the method by Olmea et al. 1999, which is limited to only protein prediction. For a protein of similar size (100 amino acids), ˜20 predictions (L/5) would be made, with an accuracy of ˜13% (using a definition of closer than 8 Å); such high inaccuracy makes it difficult to utilize their predictions for either structure prediction or structure analysis. Note, however, that we do not advocate the interpretation of Shevek accuracy using such simple Å cutoff values (e.g. 8 Å). Shevek detects associations, which may be due to spatial and/or energetic connectivity.

### Example 4

### Prediction of Structural/Energetic Contacts of the Alpha Subunit of Hemoglobin Using Shevek

Hemoglobin (Hb) is a critical protein responsible for oxygen transport/binding. The Shevek method, as described above for Example 1 (with the same default parameters) was applied to a sequence alignment of 251 similar Hb alpha sequences obtained from the PFAM sequence database (Bateman et al.; http://www.sanger.ac.uk/Software/Pfam/) (PFAM keyword: GLOBIN). These sequences were then aligned using the CLUSTAL X™ software. The Shevek method resulted in two predictions for this data set; these predictions are a second example of the ability of Shevek to act regardless of biopolymer type.

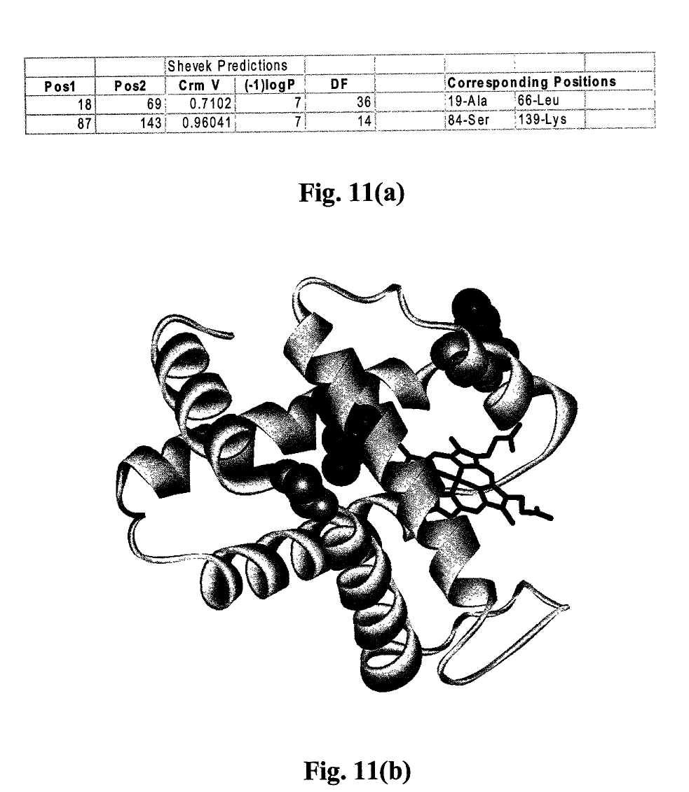

In this case, the sequence of interest was chosen to be human Hb, because its crystal structure has already been solved and thus provides for a ready check of the Shevek method. The amino acids to which the interacting positions correspond are listed next to the predictions in the Table of FIG. 11(a).

Referring to FIG. 11(b), the alpha subunit of Hemoglobin consists of a six alpha helices. Critical to the proper folding (and prediction) of this protein structure is orienting these helices with respect to one another. Shevek predicts an interaction between 19-Ala and 66-Leu (10-12 Å) shown in red in FIG. 11(b). This interaction brings the linker region between helix 1 and helix 2 together with the center of helix 3. Shevek also predicts the interaction between 84-Ser and 139-Lys (3-4 Å), shown in purple in FIG. 11(b). This interaction brings the end of helix 6 together with the beginning of helix 4.

In FIG. 10(b), Shevek predictions have been highlighted in colored pairs in the crystal structure of human Hb (PDB ID: 1RVW) by Puius et al., obtained from http://www.ncbi.nlm.nih.,ov/Structure/. Although the distance between the first predicted pair is somewhat large, because this interaction property orients helices 1, 2, and 3 with respect to one another, it is believed that an energetic coupling exists between these positions.

1. A computational method for predicting intramolecular and intermolecular biopolymer interactions comprising a screening process which comprises:
(i) a standardization process;
(ii) a threshold determining process; and
(iii) a chain elimination process, wherein said screening process results in a set of association predictions for intramolecular and/or intermolecular interactions.

2. The method of claim 1 wherein the standardization process categorizes expected frequency tables and converts nonuniformly scaled scores into uniformly scaled scores.

3. The method of claim 1 wherein the threshold determining process determines thresholds based upon distribution of uniformly scaled scores.

4. The method of claim 3 wherein the thresholds are determined based upon a measure of location and a measure of dispersion.

5. The method of claim 4 wherein the measure of location is a median distribution and the measure of dispersion is an interquartile range of the median distribution.

6. The method of claim 5 wherein the threshold is equal to a multiple of the interquartile range past a third quartile range of the interquartile range.

7. The method of claim 6 wherein the uniformly scaled score is a −log P score having a −log P threshold determined by:
−log P−Threshold=3QV(p)+IQR(p)*P-MULT,
where 3QV(p) denotes the third quartile range for the −log P score; IQR(p) denotes the interquartile range for the −log P score; and P-MULT represents a constant.

8. The method of claim 7 wherein P-MULT has a default value of 2.

9. The method of claim 6 wherein the uniformly scaled score is a V threshold determined by:
V-Threshold=3QV(v)+IQR(v)*V-MULT,
where 3QV(v) denotes the third quartile range for the V score; IQR(v) denotes the interquartile range for the V score; and V-MULT represents a constant.

10. The method of claim 9 wherein V-MULT has a default value of 1.

11. The method of claim 1 wherein the chain elimination process groups scores greater than thresholds determined in the threshold determining process based upon shared, common positions, and then determines a pinnacle association for each group of scores.

12. The method of claim 2, wherein the standardization process converts nonuniformly scaled scores into uniformly scaled P scores.

13. The method of claim 12, wherein the P scores are calculated using equations
DF=(I−1)(J−1) and
$${P}_{DF} = f ( Q ) = \frac{{Q}^{\frac{DF}{2} - 1} {ⅇ}^{\frac{- Q}{2}}}{{2}^{\frac{DF}{2}} Γ ( \frac{DF}{2} )} ,$$
where I and J represent dimensions of an actual frequency table; P represents a probability density for degrees of freedom, DF, as a function of Q, where Q=χ², and χ² is Pearson's χ² statistic.

14. The method of claim 12, wherein the P scores are calculated using Exact Statistical Methods.

15. The method of claim 12, wherein the P scores are calculated using estimated-exact statistical methods.

16. The method of claim 15 wherein the estimated-exact statistical method is based on a monte carlo simulation of a distribution.

17. The method of claim 13, wherein the expected frequency table is Normal.

18. The method of claim 14, 15, or 16 wherein the expected frequency table is Sparse.

19. The method of claim 1, wherein the threshold determining process is performed on −log of P scores.

20. The method of claim 1, wherein the threshold determining process is performed on V scores.

21. The method of claim 11, wherein the pinnacle association for each group of scores is chosen first according to highest P, then lowest DF, and then highest V.

22. A computational method for predicting intramolecular and intermolecular interactions comprising:
(a) obtaining genomic/biopolymer sequence data;
(b) subjecting the genomic/biopolymer sequence data to an alignment process, wherein said alignment process produces a set of sequence alignment data;
(c) subjecting the set of sequence alignment data to a combinatorial matching process, wherein said combinatorial matching process produces data indicating possible associations;
(d) preparing a set of actual frequency tables using the data indicating possible associations and the set of sequence alignment data;
(e) subjecting the set of actual frequency tables to a scoring process to obtain a set of scores; and
(f) subjecting the set of scores to a screening process to produce a set of association information, wherein said association information predicts intramolecular and/or intermolecular biopolymer interactions.

23. The method of claim 22 wherein the scoring process further comprises:
(i) generating a set of expected frequency tables from the set of actual frequency tables; and
(ii) comparing the expected frequency tables and actual frequency tables to generate a score.

24. The method of claim 23 wherein cells of the set of expected frequency tables have values determined by:
$${u}_{ij} \approx {\hat{u}}_{ij} = \frac{{n}_{i +} {n}_{+ j}}{n} ,$$
where ûᵢⱼ (which is an approximation of uᵢⱼ) is an expected frequency of cells in row i and column j of the expected frequency table; n=sum of all counts; nᵢ₊=total of cells in row i; n₊ⱼ=total of cells in column j.

25. The method of claim 23 wherein the comparing step is performed using a Pearson's A² statistic.

26. The method of claim 25 wherein the Pearson's A² statistic is represented by:
$${χ}^{2} = {\sum }_{i , j} \frac{{( {n}_{ij} - {u}_{ij} )}^{2}}{{u}_{ij}} ,$$
where nᵢⱼ=a value of a cell in row i and column j and uᵢⱼ is an expected frequency of a cell in row i and column j of the expected frequency table.

27. The method of claim 22 wherein the scoring process comprises subjecting the frequency tables to more than one scoring method.

28. The method of claim 27 wherein the scoring process further comprises obtaining a V score using a Cramer's V statistic.

29. The method of claim 28 wherein the Cramer's V statistic is represented by:
$$V = \sqrt{\frac{{χ}^{2} / n}{min ( I - 1 , J - 1 )}} ,$$
where A² is Pearson's A² statistic; n=the sum of all cell counts; I=number of rows; J=number of columns; and min(I−1, J−1) is a function which returns a lower of two values being compared, wherein A² is given by:
$${χ}^{2} = {\sum }_{i , j} \frac{{( {n}_{ij} - {u}_{ij} )}^{2}}{{u}_{ij}} ,$$
where nᵢⱼ=the value of a the cell in row i and column j and uᵢⱼ is an expected frequency of a cell in row i and column j of the expected frequency table.

30. The method of claim 22 wherein the screening process comprises:
(i) a standardization process;
(ii) a threshold determining process; and
(iii) a chain elimination process, wherein said screening process results in a set of association predictions for intramolecular and/or intermolecular interactions.

31. The method of claim 30 wherein the standardization process categorizes expected frequency tables and converts nonuniformly scaled scores into uniformly scaled scores.

32. The method of claim 30 wherein the threshold determining process determines thresholds based upon distribution of uniformly scaled scores.

33. The method of claim 32 wherein the thresholds are determined based upon a measure of location and a measure of dispersion.

34. The method of claim 33 wherein the measure of location is a median distribution and the measure of dispersion is an interquartile range of the median distribution.

35. The method of claim 34 wherein the threshold is equal to a multiple of the interquartile range past a third quartile range of the interquartile range.

36. The method of claim 35 wherein the uniformly scaled score is a −log P score having a −log P threshold determined by:
−log P−Threshold=3QV(p)+IQR(p)*P-MULT,
where 3QV(p) denotes the third quartile range for the −log P score; IQR(p) denotes the interquartile range for the −log P score; and P-MULT represents a constant.

37. The method of claim 36 wherein P-MULT has a default value of 2.

38. The method of claim 35 wherein the uniformly scaled score is a V threshold determined by:
V-Threshold=3QV(v)+IQR(v)*V-MULT,
where 3QV(v) denotes the third quartile range for the V score; IQR(v) denotes the interquartile range for the V score; and V-MULT represents a constant.

39. The method of claim 38 wherein V-MULT has a default value of 1.

40. The method of claim 30 wherein the chain elimination process groups scores greater than thresholds determined in the threshold determining process based upon shared, common positions, and then determines a pinnacle for each group of scores.

41. The method of claim 31, wherein the standardization process converts nonuniformly scaled scores into uniformly scaled P scores.

42. The method of claim 41, wherein the P scores are calculated using equations
DF=(I−1)(J−1) and
$${P}_{DF} = f ( Q ) = \frac{{Q}^{\frac{DF}{2} - 1} {ⅇ}^{\frac{- Q}{2}}}{{2}^{\frac{DF}{2}} Γ ( \frac{DF}{2} )} ,$$
where I and J represent dimensions of an actual frequency table; where P represents a probability density for degrees of freedom, DF, as a function of Q, where Q=χ².

43. The method of claim 41, wherein the P scores are calculated using Exact Statistical Methods.

44. The method of claim 43, wherein the P scores are calculated using estimated-exact statistical methods.

45. The method of claim 44 wherein the estimated-exact statistical method is based on a monte carlo simulation of a distribution.

46. The method of claim 43, the expected frequency table is Normal.

47. The method of claim 43, 44 or 45 wherein the expected frequency table is Sparse.

48. The method of claim 30, wherein the threshold determining process is performed on −log of P scores.

49. The method of claim 30, wherein the threshold determining process is performed on V scores.

50. The method of claim 40, wherein the pinnacle association for each group of scores is chosen first according to highest P, then lowest DF, and then highest V.

51. A computational method for predicting intramolecular and intermolecular interactions comprising:
(a) obtaining genomic/biopolymer sequence data;
(b) subjecting the genomic/biopolymer sequence data to a first alignment process wherein said first alignment process produces a first set of sequence alignment data;
(c) subjecting the first set of sequence alignment data to a combinatorial matching process wherein said combinatorial matching process produces data indicating possible associations;
(d) preparing a set of actual frequency tables using the data indicating possible associations and the set of sequence alignment data;
(e) subjecting the set of actual frequency tables to a scoring process to obtain set of scores;
(f) subjecting the set of scores to a screening process to produce a first set of association information, wherein said association information predicts intramolecular and/or intermolecular biopolymer interactions;
(g) subjecting the actual frequency tables corresponding to the first set of association information, to a misalignment process wherein said misalignment process produces misaligned sequence information;
(h) using the misaligned sequence information to realign sequences to produce a second set of sequence alignment data superseding the first set of sequence alignment data; and
(i) repeating steps (c) through (f) in combination substituting the second set of sequence alignment data for the first set of sequence alignment data to produce a second set of association information, wherein said second set of association information predicts intramolecular and intermolecular biopolymer interactions.

52. The method of claim 51 wherein steps (g) through (i) are repeated at least one additional time.

53. The method of claim 51, wherein the misalignment process further comprises:
(i) generating an AR table for each actual frequency table;
(ii) categorizing cells in each AR table in a MISALIGNED category or a GOOD category wherein a cell of an AR table having an absolute value of less than or equal to a threshold value ARTHRESH is categorized in the MISALIGNED category and wherein a cell of an AR table having an absolute value of greater than a threshold value of ARTHRESH is categorized in the GOOD category;
(iii) using the cells in the MISALIGNED category to identify corresponding misaligned sequences, (iv) using the cells in the GOOD category to identify suggested alternative alignments for the misaligned sequences, and
(v) utilizing the suggested alternative alignments to produce the second sequence alignment.

54. The method of claim 53, wherein each element ARᵢⱼ in row i and column j of an AR table is generated using the equation:
$${AR}_{ij} = \frac{{n}_{ij} - {u}_{ij}}{\sqrt{{u}_{ij} ( 1 - {p}_{i +} ) ( 1 - {p}_{+ j} )}} ,$$
where Pᵢ₊=nᵢ₊/n; p₊ⱼ=n₊ⱼ/n; n=sum of all cell counts; nᵢ₊=total of cells in row i; n₊ⱼ=total of cells in column j; nᵢⱼ=value of the cell in row i and column j; and
$${u}_{ij} \approx {\hat{u}}_{ij} = \frac{{n}_{i} + {n}_{+ j}}{n} .$$

55. The method of claim 53, wherein ARTHRESH has a default value of 1.0

56. The method of claim 53, wherein three cells having highest AR values in each AR table are categorized in the GOOD category and predict molecular interactions that exist in nature at positions corresponding to the cells.

57. The method of claim 53, wherein a sequence is identified as misaligned if it contributes at least a specified number, REPEAT, cells to the MISALIGNED category.

58. The method of claim 57, where a default value for REPEAT is 2.

59. A computational method for predicting intramolecular and intermolecular biopolymer interactions comprising a misalignment process which comprises:
(i) generating an AR table for actual frequency tables of a first sequence alignment;
(ii) categorizing cells in each AR table in a MISALIGNED category or a GOOD category wherein a cell of an AR table having an absolute value of less than or equal to a threshold value ARTHRESH is categorized in the MISALIGNED category and wherein a cell of an AR table having an absolute value of greater than a threshold value of ARTHRESH is categorized in the GOOD category;
(iii) using the cells in the MISALIGNED category to identify corresponding misaligned sequences,
(iv) using the cells in the GOOD category to identify suggested alternative alignments for the misaligned sequences, and
(v) utilizing the suggested alternative alignments to produce a second sequence alignment.

60. A sequence alignment method comprising a misalignment process which comprises:
(i) generating an AR table for actual frequency tables of a first sequence alignment;
(ii) categorizing the cells in each AR table in a MISALIGNED category or a GOOD category wherein a cell of an AR table having an absolute value of less than or equal to a threshold value ARTHRESH is categorized in the MISALIGNED category and wherein a cell of an AR table having an absolute value of greater than a threshold value of ARTHRESH is categorized in the GOOD category;
(iii) using the cells in the MISALIGNED category to identify corresponding misaligned sequences;
(iv) using the cells in the GOOD category to identify suggested alternative alignments for the misaligned sequences; and
(v) utilizing the suggested alternative alignments to produce a second sequence alignment.

61. A sequence alignment method for aligning biopolymer sequences comprising:
(a) obtaining genomic/biopolymer sequence data;
(b) subjecting the genomic/biopolymer data to a first alignment process wherein said first alignment process produces a first set of sequence alignment data;
(c) subjecting the first set of sequence alignment data to a combinatorial matching process wherein said combinatorial matching process produces a first list of combinations of positions in biopolymer sequence data;
(d) preparing an actual frequency table for each of the combinations of positions in the first list of combinations of positions;
(e) subjecting each actual frequency table to a scoring process to obtain a set of scores;
(f) subjecting the set of scores to a screening process to produce a second list of combinations of positions, wherein the second list of combinations of positions consists combinations of positions that are highly ordered.
(g) subjecting each actual frequency table prepared for each of the combinations of positions in the second list of combinations positions to a misalignment process wherein said misalignment process produces a list of misaligned sequence information, and wherein said list of misalignment information is an indicator of alignment quality; and
(h) using the misaligned sequence information to realign sequences to produce a refined sequence alignment.

62. The method of claim 61 wherein steps (c) through (g) are repeated in combination at least once.


SEQUENCE LISTING (128 sequences)

SEQ ID NO: 1 - DNA, 35 bp, Saccharomyces cerevisiae
  Sequence corresponding to domain 5 of ai5gamma.
gagccgtatgcgatgaaagtcgcacgtacggttct

SEQ ID NO: 2 - DNA, 35 bp, Unknown
  Sequence identified through homology search using domain 5 of ai5gamma and parameters set forth in Figure 1 and the specification.
gagccacatgcagggaaacttgcacgtgtggttct

SEQ ID NO: 3 - DNA, 35 bp, Unknown
  Sequence identified through homology search using domain 5 of ai5gamma and parameters set forth in Figure 1 and the specification.
gagctttttgcggggaaacttgcaagtcaagtttg

SEQ ID NO: 4 - DNA, 35 bp, Unknown
  Sequence identified through homology search using domain 5 of ai5gamma and parameters set forth in Figure 1 and the specification.
gagctttttgcggggaaacttgcaagtacagtttg

SEQ ID NO: 5 - DNA, 35 bp, Unknown; identical to SEQ ID NO: 3
  Sequence identified through homology search using domain 5 of ai5gamma and parameters set forth in Figure 1 and the specification.

SEQ ID NO: 6 - DNA, 35 bp, Unknown; identical to SEQ ID NO: 4
  Sequence identified through homology search using domain 5 of ai5gamma and parameters set forth in Figure 1 and the specification.

SEQ ID NO: 7 - DNA, 35 bp, Unknown
  Sequence identified through homology search using domain 5 of ai5gamma and parameters set forth in Figure 1 and the specification.
gagctttttgcggggaaacttgcaagtaaagtttg

SEQ ID NO: 8 - DNA, 35 bp, Unknown; identical to SEQ ID NO: 4
  Sequence identified through homology search using domain 5 of ai5gamma and parameters set forth in Figure 1 and the specification.

SEQ ID NO: 9 - DNA, 35 bp, Unknown
  Sequence identified through homology search using domain 5 of ai5gamma and parameters set forth in Figure 1 and the specification.
gagccgtgtgatgggaaaccttcccgcacggttcg

SEQ ID NO: 10 - DNA, 35 bp, Unknown; identical to SEQ ID NO: 9
  Sequence identified through homology search using domain 5 of ai5gamma and parameters set forth in Figure 1 and the specification.

SEQ ID NO: 11 - DNA, 35 bp, Unknown; identical to SEQ ID NO: 9
  Sequence identified through homology search using domain 5 of ai5gamma and parameters set forth in Figure 1 and the specification.

SEQ ID NO: 12 - DNA, 35 bp, Unknown
  Sequence identified through homology search using domain 5 of ai5gamma and parameters set forth in Figure 1 and the specification.
gagccgtatgcgaggaaacttgcacgtgcggttct

SEQ ID NO: 13 - DNA, 35 bp, Unknown; identical to SEQ ID NO: 12
  Sequence identified through homology search using domain 5 of ai5gamma and parameters set forth in Figure 1 and the specification.

SEQ ID NO: 14 - DNA, 35 bp, Unknown; identical to SEQ ID NO: 12
  Sequence identified through homology search using domain 5 of ai5gamma and parameters set forth in Figure 1 and the specification.

SEQ ID NO: 15 - DNA, 35 bp, Unknown; identical to SEQ ID NO: 12
  Sequence identified through homology search using domain 5 of ai5gamma and parameters set forth in Figure 1 and the specification.

SEQ ID NO: 16 - DNA, 35 bp, Unknown
  Sequence identified through homology search using domain 5 of ai5gamma and parameters set forth in Figure 1 and the specification.
gagccgtatgcggggaaacttgcacgtgcggttct

SEQ ID NO: 17 - DNA, 36 bp, Unknown
  Sequence identified through homology search using domain 5 of ai5gamma and parameters set forth in Figure 1 and the specification.
gagccgtatgcgaaggaaacttgcacgtgcggttct

SEQ ID NO: 18 - DNA, 35 bp, Unknown; identical to SEQ ID NO: 12
  Sequence identified through homology search using domain 5 of ai5gamma and parameters set forth in Figure 1 and the specification.

SEQ ID NO: 19 - DNA, 35 bp, Unknown; identical to SEQ ID NO: 12
  Sequence identified through homology search using domain 5 of ai5gamma and parameters set forth in Figure 1 and the specification.

SEQ ID NO: 20 - DNA, 35 bp, Unknown; identical to SEQ ID NO: 12
  Sequence identified through homology search using domain 5 of ai5gamma and parameters set forth in Figure 1 and the specification.

SEQ ID NO: 21 - DNA, 35 bp, Unknown
  Sequence identified through homology search using domain 5 of ai5gamma and parameters set forth in Figure 1 and the specification.
gagccgtgtgatgggaaacctccccgcacggttcg

SEQ ID NO: 22 - DNA, 35 bp, Unknown; identical to SEQ ID NO: 21
  Sequence identified through homology search using domain 5 of ai5gamma and parameters set forth in Figure 1 and the specification.

SEQ ID NO: 23 - DNA, 35 bp, Unknown; identical to SEQ ID NO: 21
  Sequence identified through homology search using domain 5 of ai5gamma and parameters set forth in Figure 1 and the specification.

SEQ ID NO: 24 - DNA, 35 bp, Unknown; identical to SEQ ID NO: 21
  Sequence identified through homology search using domain 5 of ai5gamma and parameters set forth in Figure 1 and the specification.

SEQ ID NO: 25 - DNA, 35 bp, Unknown
  Sequence identified through homology search using domain 5 of ai5gamma and parameters set forth in Figure 1 and the specification.
gagccgtatgatgggaaactatcacgtacggttcg

SEQ ID NO: 26 - DNA, 35 bp, Unknown
  Sequence identified through homology search using domain 5 of ai5gamma and parameters set forth in Figure 1 and the specification.
tgagcgcatgcggggagacccgcacgtacggtttt

SEQ ID NO: 27 - DNA, 35 bp, Unknown
  Sequence identified through homology search using domain 5 of ai5gamma and parameters set forth in Figure 1 and the specification.
gagccgtatgaagggaaactctcacgtacagtttg

SEQ ID NO: 28 - DNA, 35 bp, Unknown
  Sequence identified through homology search using domain 5 of ai5gamma and parameters set forth in Figure 1 and the specification.
gagccgtgtaatgggcaactatttcgcacggttcg

SEQ ID NO: 29 - DNA, 35 bp, Unknown
  Sequence identified through homology search using domain 5 of ai5gamma and parameters set forth in Figure 1 and the specification.
gagcctagtgataggagactatctagcttggttcg

SEQ ID NO: 30 - DNA, 35 bp, Unknown
  Sequence identified through homology search using domain 5 of ai5gamma and parameters set forth in Figure 1 and the specification.
gagccgtatgcgaggagacttgcacgtacggttcg

SEQ ID NO: 31 - DNA, 35 bp, Unknown
  Sequence identified through homology search using domain 5 of ai5gamma and parameters set forth in Figure 1 and the specification.
aagccgtatgatgggaaactatcacgtacggtttg

SEQ ID NO: 32 - DNA, 35 bp, Unknown
  Sequence identified through homology search using domain 5 of ai5gamma and parameters set forth in Figure 1 and the specification.
gagccgtatgcggtgaaagtcgcacgtacggttcg

SEQ ID NO: 33 - DNA, 35 bp, Unknown; identical to SEQ ID NO: 32
  Sequence identified through homology search using domain 5 of ai5gamma and parameters set forth in Figure 1 and the specification.

SEQ ID NO: 34 - DNA, 35 bp, Unknown
  Sequence identified through homology search using domain 5 of ai5gamma and parameters set forth in Figure 1 and the specification.
gagccgtatgcattgaaagatgcacgtacggttct

SEQ ID NO: 35 - DNA, 35 bp, Unknown
  Sequence identified through homology search using domain 5 of ai5gamma and parameters set forth in Figure 1 and the specification.
gagccgtatgatatgaaagtatcacgtacggttcg

SEQ ID NO: 36 - DNA, 35 bp, Unknown; identical to SEQ ID NO: 35
  Sequence identified through homology search using domain 5 of ai5gamma and parameters set forth in Figure 1 and the specification.

SEQ ID NO: 37 - DNA, 35 bp, Unknown
  Sequence identified through homology search using domain 5 of ai5gamma and parameters set forth in Figure 1 and the specification.
gagccgtatgcagggaaacttgcacgtacggttcg

SEQ ID NO: 38 - DNA, 35 bp, Unknown
  Sequence identified through homology search using domain 5 of ai5gamma and parameters set forth in Figure 1 and the specification.
gagccgtatgcggtgaaagttgcacgtacggttcg

SEQ ID NO: 39 - DNA, 36 bp, Unknown
  Sequence identified through homology search using domain 5 of ai5gamma and parameters set forth in Figure 1 and the specification.
gagccgtataattacgaaagtatcccgtacggttcg

SEQ ID NO: 40 - DNA, 35 bp, Unknown
  Sequence identified through homology search using domain 5 of ai5gamma and parameters set forth in Figure 1 and the specification.
aagccgtattcgatgaaagtcgtatgtacggcttg

SEQ ID NO: 41 - DNA, 35 bp, Unknown; identical to SEQ ID NO: 40
  Sequence identified through homology search using domain 5 of ai5gamma and parameters set forth in Figure 1 and the specification.

SEQ ID NO: 42 - DNA, 35 bp, Unknown; identical to SEQ ID NO: 40
  Sequence identified through homology search using domain 5 of ai5gamma and parameters set forth in Figure 1 and the specification.

SEQ ID NO: 43 - DNA, 35 bp, Unknown
  Sequence identified through homology search using domain 5 of ai5gamma and parameters set forth in Figure 1 and the specification.
aagccgtattcgttgaaaatcggatgtacggtttg

SEQ ID NO: 44 - DNA, 35 bp, Unknown; identical to SEQ ID NO: 3
  Sequence identified through homology search using domain 5 of ai5gamma and parameters set forth in Figure 1 and the specification.

SEQ ID NO: 45 - DNA, 35 bp, Unknown
  Sequence identified through homology search using domain 5 of ai5gamma and parameters set forth in Figure 1 and the specification.
gagccgtgtgatgggtgactatccagcacggttcg

SEQ ID NO: 46 - DNA, 36 bp, Unknown
  Sequence identified through homology search using domain 5 of ai5gamma and parameters set forth in Figure 1 and the specification.
gagcgcagtacaacggagagttgtatgctgcgttcg

SEQ ID NO: 47 - DNA, 36 bp, Unknown
  Sequence identified through homology search using domain 5 of ai5gamma and parameters set forth in Figure 1 and the specification.
gagcgcagtacaacggggagttgtatgctgcgttcg

SEQ ID NO: 48 - DNA, 36 bp, Unknown
  Sequence identified through homology search using domain 5 of ai5gamma and parameters set forth in Figure 1 and the specification.
gagcgcagtacaacggaaagttgtatgctgcgttcg

SEQ ID NO: 49 - DNA, 36 bp, Unknown; identical to SEQ ID NO: 47
  Sequence identified through homology search using domain 5 of ai5gamma and parameters set forth in Figure 1 and the specification.

SEQ ID NO: 50 - DNA, 35 bp, Unknown
  Sequence identified through homology search using domain 5 of ai5gamma and parameters set forth in Figure 1 and the specification.
gagcacagtacgatgaaagttgtaagctgtgttcg

SEQ ID NO: 51 - DNA, 35 bp, Unknown; identical to SEQ ID NO: 50
  Sequence identified through homology search using domain 5 of ai5gamma and parameters set forth in Figure 1 and the specification.

SEQ ID NO: 52 - DNA, 35 bp, Unknown
  Sequence identified through homology search using domain 5 of ai5gamma and parameters set forth in Figure 1 and the specification.
gagcacagtacgatgaaagttgtaagctgtgtttg

SEQ ID NO: 53 - DNA, 35 bp, Unknown; identical to SEQ ID NO: 4
  Sequence identified through homology search using domain 5 of ai5gamma and parameters set forth in Figure 1 and the specification.

SEQ ID NO: 54 - DNA, 35 bp, Unknown
  Sequence identified through homology search using domain 5 of ai5gamma and parameters set forth in Figure 1 and the specification.
aagccgtgtgcaatgaaaaatgcaagcacggcttg

SEQ ID NO: 55 - DNA, 35 bp, Unknown
  Sequence identified through homology search using domain 5 of ai5gamma and parameters set forth in Figure 1 and the specification.
aagctgtgtgcaatgaaaaatgcaagcacggtttg

SEQ ID NO: 56 - DNA, 35 bp, Unknown
  Sequence identified through homology search using domain 5 of ai5gamma and parameters set forth in Figure 1 and the specification.
aagccgtatgcagtaaaaattgcaagtacggtttg

SEQ ID NO: 57 - DNA, 35 bp, Unknown
  Sequence identified through homology search using domain 5 of ai5gamma and parameters set forth in Figure 1 and the specification.
gagccaaatgaatcgaaagattcatgtttggttcg

SEQ ID NO: 58 - DNA, 35 bp, Unknown
  Sequence identified through homology search using domain 5 of ai5gamma and parameters set forth in Figure 1 and the specification.
gagccaaatgaattgaaagattcatgtttggttcg

SEQ ID NO: 59 - DNA, 35 bp, Unknown
  Sequence identified through homology search using domain 5 of ai5gamma and parameters set forth in Figure 1 and the specification.
gagccaaatgaattgaaaaattcacgtttggttcg

SEQ ID NO: 60 - DNA, 35 bp, Unknown; identical to SEQ ID NO: 57
  Sequence identified through homology search using domain 5 of ai5gamma and parameters set forth in Figure 1 and the specification.

SEQ ID NO: 61 - DNA, 35 bp, Unknown
  Sequence identified through homology search using domain 5 of ai5gamma and parameters set forth in Figure 1 and the specification.
aagccgaatgaattgaaaagttcatgttcggtttg

SEQ ID NO: 62 - DNA, 35 bp, Unknown; identical to SEQ ID NO: 57
  Sequence identified through homology search using domain 5 of ai5gamma and parameters set forth in Figure 1 and the specification.

SEQ ID NO: 63 - DNA, 35 bp, Unknown
  Sequence identified through homology search using domain 5 of ai5gamma and parameters set forth in Figure 1 and the specification.
aagaagtatgctttggaagaagcttgtacagtttg

SEQ ID NO: 64 - DNA, 34 bp, Unknown
  Sequence identified through homology search using domain 5 of ai5gamma and parameters set forth in Figure 1 and the specification.
aagctgtatgcttgaaaaaagcttgtacagtttg

SEQ ID NO: 65 - DNA, 31 bp, Unknown
  Sequence identified through homology search using domain 5 of ai5gamma and parameters set forth in Figure 1 and the specification.
gagccgtacgaggcagctcacgtacggttcg

SEQ ID NO: 66 - DNA, 35 bp, Unknown
  Sequence identified through homology search using domain 5 of ai5gamma and parameters set forth in Figure 1 and the specification.
gagctgtatactatgaaagtagtacgtacagttct

SEQ ID NO: 67 - DNA, 35 bp, Unknown
  Sequence identified through homology search using domain 5 of ai5gamma and parameters set forth in Figure 1 and the specification.
gagccgtacgaggagaaagcttcctatacgtttct

SEQ ID NO: 68 - DNA, 35 bp, Unknown
  Sequence identified through homology search using domain 5 of ai5gamma and parameters set forth in Figure 1 and the specification.
gagccggatgaaaggaaactttcacgtccgatttt

SEQ ID NO: 69 - DNA, 35 bp, Unknown
  Sequence identified through homology search using domain 5 of ai5gamma and parameters set forth in Figure 1 and the specification.
gagccgggcgaggggaaactttcacgtccggcttt

SEQ ID NO: 70 - DNA, 35 bp, Unknown
  Sequence identified through homology search using domain 5 of ai5gamma and parameters set forth in Figure 1 and the specification.
gagccggatgacggaaaactttcatgtccgattct

SEQ ID NO: 71 - DNA, 36 bp, Unknown
  Sequence identified through homology search using domain 5 of ai5gamma and parameters set forth in Figure 1 and the specification.
aagccatacagagttgaaaatatcatatatggtttt

SEQ ID NO: 72 - DNA, 35 bp, Unknown
  Sequence identified through homology search using domain 5 of ai5gamma and parameters set forth in Figure 1 and the specification.
gagctgtacgagatgaaagtctcatatacggttct

SEQ ID NO: 73 - DNA, 35 bp, Unknown
  Sequence identified through homology search using domain 5 of ai5gamma and parameters set forth in Figure 1 and the specification.
gagctgtacgagatgaaagtctcatatacagttct

SEQ ID NO: 74 - DNA, 34 bp, Unknown
  Sequence identified through homology search using domain 5 of ai5gamma and parameters set forth in Figure 1 and the specification.
gagccgtacgagatgaaattttcatatacggttc

SEQ ID NO: 75 - DNA, 35 bp, Unknown
  Sequence identified through homology search using domain 5 of ai5gamma and parameters set forth in Figure 1 and the specification.
aagctgtaagattataaataatcatttacggtttt

SEQ ID NO: 76 - DNA, 35 bp, Unknown
  Sequence identified through homology search using domain 5 of ai5gamma and parameters set forth in Figure 1 and the specification.
gagctggatgattaaaaattatcatgtccagttcc

SEQ ID NO: 77 - DNA, 35 bp, Unknown
  Sequence identified through homology search using domain 5 of ai5gamma and parameters set forth in Figure 1 and the specification.
gagccggatgatgaaaaattatcatgtccggttct

SEQ ID NO: 78 - DNA, 35 bp, Unknown
  Sequence identified through homology search using domain 5 of ai5gamma and parameters set forth in Figure 1 and the specification.
gagccggatgatgaaaaattctcatgtccggttcc

SEQ ID NO: 79 - DNA, 35 bp, Unknown
  Sequence identified through homology search using domain 5 of ai5gamma and parameters set forth in Figure 1 and the specification.
gagccggatgatattaaattatcatgtccgattct

SEQ ID NO: 80 - DNA, 35 bp, Unknown
  Sequence identified through homology search using domain 5 of ai5gamma and parameters set forth in Figure 1 and the specification.
gaaccgtatgcatcaaaaggcgcatgtacggttcc

SEQ ID NO: 81 - DNA, 36 bp, Unknown
  Sequence identified through homology search using domain 5 of ai5gamma and parameters set forth in Figure 1 and the specification.
aagctgtatgcgcttaaaaagtgcttgtacagtttt

SEQ ID NO: 82 - DNA, 37 bp, Unknown
  Sequence identified through homology search using domain 5 of ai5gamma and parameters set forth in Figure 1 and the specification.
gagccgtatgaggtaagaaattctcaagtacggttct

SEQ ID NO: 83 - DNA, 35 bp, Unknown
  Sequence identified through homology search using domain 5 of ai5gamma and parameters set forth in Figure 1 and the specification.
gagctggatgagaagaaactctcacgtccggttct

SEQ ID NO: 84 - DNA, 35 bp, Unknown
  Sequence identified through homology search using domain 5 of ai5gamma and parameters set forth in Figure 1 and the specification.
gagctggatgagaagaaactctcatgtccagtttt

SEQ ID NO: 85 - DNA, 35 bp, Unknown
  Sequence identified through homology search using domain 5 of ai5gamma and parameters set forth in Figure 1 and the specification.
gagccggatgagaagaaactctcatgtccggttct

SEQ ID NO: 86 - DNA, 34 bp, Unknown
  Sequence identified through homology search using domain 5 of ai5gamma and parameters set forth in Figure 1 and the specification.
gagccggatgaatcaaaatttcatgtccggtttt

SEQ ID NO: 87 - DNA, 35 bp, Unknown
  Sequence identified through homology search using domain 5 of ai5gamma and parameters set forth in Figure 1 and the specification.
gagccgtatgagatgaaaatctcacgtacggttct

SEQ ID NO: 88 - DNA, 35 bp, Unknown
  Sequence identified through homology search using domain 5 of ai5gamma and parameters set forth in Figure 1 and the specification.
gagccgtatgaaatgaaaatttcatgtacggtttt

SEQ ID NO: 89 - DNA, 35 bp, Unknown
  Sequence identified through homology search using domain 5 of ai5gamma and parameters set forth in Figure 1 and the specification.
gagccgtgtgagatgaaagtctcatgcacggtttt

SEQ ID NO: 90 - DNA, 35 bp, Unknown
  Sequence identified through homology search using domain 5 of ai5gamma and parameters set forth in Figure 1 and the specification.
gagccgtgtgaattgaaaatctcatgcacggtttt

SEQ ID NO: 91 - DNA, 35 bp, Unknown
  Sequence identified through homology search using domain 5 of ai5gamma and parameters set forth in Figure 1 and the specification.
gagccgtatgatgggcaactatctcctgcggttcg

SEQ ID NO: 92 - DNA, 35 bp, Unknown
  Sequence identified through homology search using domain 5 of ai5gamma and parameters set forth in Figure 1 and the specification.
gagccgtatgaggtgaaaatctcacgtacggttct

SEQ ID NO: 93 - DNA, 35 bp, Unknown
  Sequence identified through homology search using domain 5 of ai5gamma and parameters set forth in Figure 1 and the specification.
gagccgtatgaagtttaaacttcatgtacggtttt

SEQ ID NO: 94 - DNA, 35 bp, Unknown
  Sequence identified through homology search using domain 5 of ai5gamma and parameters set forth in Figure 1 and the specification.
gagccgaatgaaaccaaagtttcatgttcggtttt

SEQ ID NO: 95 - DNA, 35 bp, Unknown
  Sequence identified through homology search using domain 5 of ai5gamma and parameters set forth in Figure 1 and the specification.
gagccgaatgaaatcaaaatttcatgttcggtttt

SEQ ID NO: 96 - DNA, 35 bp, Unknown
  Sequence identified through homology search using domain 5 of ai5gamma and parameters set forth in Figure 1 and the specification.
gagccgaatgaaagaaaactttcacgttcggtttt

SEQ ID NO: 97 - DNA, 37 bp, Unknown
  Sequence identified through homology search using domain 5 of ai5gamma and parameters set forth in Figure 1 and the specification.
gagccggatgagggagaaatttctcacgtccggatct

SEQ ID NO: 98 - DNA, 35 bp, Unknown
  Sequence identified through homology search using domain 5 of ai5gamma and parameters set forth in Figure 1 and the specification.
gagccgtatgaggtgaaaatctcatgtacggttct

SEQ ID NO: 99 - DNA, 35 bp, Unknown
  Sequence identified through homology search using domain 5 of ai5gamma and parameters set forth in Figure 1 and the specification.
aagccgtatgaaatgaaaatatcaagtacggtttt

SEQ ID NO: 100 - DNA, 35 bp, Unknown; identical to SEQ ID NO: 98
  Sequence identified through homology search using domain 5 of ai5gamma and parameters set forth in Figure 1 and the specification.

SEQ ID NO: 101 - DNA, 35 bp, Unknown
  Sequence identified through homology search using domain 5 of ai5gamma and parameters set forth in Figure 1 and the specification.
gagccgtatgcgatgaaagttgcacgtacggttct

SEQ ID NO: 102 - DNA, 35 bp, Unknown; identical to SEQ ID NO: 1
  Sequence identified through homology search using domain 5 of ai5gamma and parameters set forth in Figure 1 and the specification.

SEQ ID NO: 103 - DNA, 35 bp, Unknown; identical to SEQ ID NO: 101
  Sequence identified through homology search using domain 5 of ai5gamma and parameters set forth in Figure 1 and the specification.

SEQ ID NO: 104 - DNA, 35 bp, Unknown
  Sequence identified through homology search using domain 5 of ai5gamma and parameters set forth in Figure 1 and the specification.
gagctgtatgcgatgaaagtcgcacgtacagttct

SEQ ID NO: 105 - DNA, 35 bp, Unknown
  Sequence identified through homology search using domain 5 of ai5gamma and parameters set forth in Figure 1 and the specification.
gagccgtatgccatgaaagtggcacgtacggttct

SEQ ID NO: 106 - DNA, 35 bp, Unknown
  Sequence identified through homology search using domain 5 of ai5gamma and parameters set forth in Figure 1 and the specification.
cagccgtgtgcggtgaaagtcgcacgcacggttgt

SEQ ID NO: 107 - DNA, 35 bp, Unknown
  Sequence identified through homology search using domain 5 of ai5gamma and parameters set forth in Figure 1 and the specification.
gagccgtgtgcgatgaaagtcgcaagcacggttct

SEQ ID NO: 108 - DNA, 35 bp, Unknown
  Sequence identified through homology search using domain 5 of ai5gamma and parameters set forth in Figure 1 and the specification.
gagccgtgtgcgttgaaagatgcatgcacggttct

SEQ ID NO: 109 - DNA, 35 bp, Unknown
  Sequence identified through homology search using domain 5 of ai5gamma and parameters set forth in Figure 1 and the specification.
gagccgtatgaatggagacattcacgtacggtttt

SEQ ID NO: 110 - DNA, 35 bp, Unknown
  Sequence identified through homology search using domain 5 of ai5gamma and parameters set forth in Figure 1 and the specification.
gagccgtgtgcggtgaaagtcgcatgcacggttct

SEQ ID NO: 111 - DNA, 35 bp, Unknown
  Sequence identified through homology search using domain 5 of ai5gamma and parameters set forth in Figure 1 and the specification.
gagccgtatgcgggaaaactcgcacgtacggttct

SEQ ID NO: 112 - DNA, 35 bp, Unknown
  Sequence identified through homology search using domain 5 of ai5gamma and parameters set forth in Figure 1 and the specification.
gagccgtatgcggggaaactcgcacgtacggttct

SEQ ID NO: 113 - DNA, 34 bp, Unknown
  Sequence identified through homology search using domain 5 of ai5gamma and parameters set forth in Figure 1 and the specification.
gagccgtatgtgctgaaaggtacaagtacggttc

SEQ ID NO: 114 - DNA, 35 bp, Unknown
  Sequence identified through homology search using domain 5 of ai5gamma and parameters set forth in Figure 1 and the specification.
gagccgtatgccgggaaactggcacgtacggttct

SEQ ID NO: 115 - DNA, 35 bp, Unknown
  Sequence identified through homology search using domain 5 of ai5gamma and parameters set forth in Figure 1 and the specification.
gagccggatgaggggcgactctcatgtccggttct

SEQ ID NO: 116 - DNA, 35 bp, Unknown
  Sequence identified through homology search using domain 5 of ai5gamma and parameters set forth in Figure 1 and the specification.
gagcggtatgagccgagaggttcacgtaccgttct

SEQ ID NO: 117 - DNA, 35 bp, Unknown
  Sequence identified through homology search using domain 5 of ai5gamma and parameters set forth in Figure 1 and the specification.
gagcggtgtgaatcgagaggttcacgcaccgttct

SEQ ID NO: 118 - DNA, 35 bp, Unknown
  Sequence identified through homology search using domain 5 of ai5gamma and parameters set forth in Figure 1 and the specification.
gagccgtgtgcagcgaaagttgcacgcacggatct

SEQ ID NO: 119 - DNA, 35 bp, Unknown
  Sequence identified through homology search using domain 5 of ai5gamma and parameters set forth in Figure 1 and the specification.
gagccgtatgaggtgaaagtctcaagtacggtttt

SEQ ID NO: 120 - DNA, 35 bp, Unknown
  Sequence identified through homology search using domain 5 of ai5gamma and parameters set forth in Figure 1 and the specification.
gagccgtatactccgagaggggtacgtacggttcc

SEQ ID NO: 121 - DNA, 31 bp, Unknown
  Sequence identified through homology search using domain 5 of ai5gamma and parameters set forth in Figure 1 and the specification.
ccgccgtgtacggaaccgtacgcacggtggt

SEQ ID NO: 122 - DNA, 35 bp, Unknown
  Sequence identified through homology search using domain 5 of ai5gamma and parameters set forth in Figure 1 and the specification.
acgccgtgtgaggggaaactctcatgcacggtgtg

SEQ ID NO: 123 - DNA, 34 bp, Unknown
  Sequence identified through homology search using domain 5 of ai5gamma and parameters set forth in Figure 1 and the specification.
acgccgtatgctggaaactcgcctgtacggtgtg

SEQ ID NO: 124 - DNA, 35 bp, Unknown
  Sequence identified through homology search using domain 5 of ai5gamma and parameters set forth in Figure 1 and the specification.
aagccgtatgaggggaaactttcacgtacggtttg

SEQ ID NO: 125 - DNA, 35 bp, Unknown
  Sequence identified through homology search using domain 5 of ai5gamma and parameters set forth in Figure 1 and the specification.
gagccgtatgatgggaaactatcacgtacggttct

SEQ ID NO: 126 - DNA, 35 bp, Unknown
  Sequence identified through homology search using domain 5 of ai5gamma and parameters set forth in Figure 1 and the specification.
gagcccggtgcggtgaaagtcgcacgccgggttcg

SEQ ID NO: 127 - DNA, 35 bp, Unknown
  Sequence identified through homology search using domain 5 of ai5gamma and parameters set forth in Figure 1 and the specification.
gagccggatgcgctgaaaggtgcacgtccggttcg

SEQ ID NO: 128 - RNA, 34 nt, Saccharomyces cerevisiae
  Sequence corresponding to structure of Group II catalytic RNA of ai53.
gagccguaugcgaugaaagucgcacguacgguuc